(19) United States
(12) Patent Application Publication
(10) Pub. No.: US 2022/0049954 A1
(43) Pub. Date: Feb. 17, 2022

(54) CALIBRATION SYSTEM AND CALIBRATION BRACKET THEREOF

(71) Applicant: AUTEL INTELLIGENT TECHNOLOGY CORP., LTD., Shenzhen (CN)

(72) Inventor: Biwang LAI, Shenzhen (CN)

(21) Appl. No.: 16/991,730

(22) Filed: Aug. 12, 2020

(51) Int. Cl. G01B 11/27

(52) U.S. Cl. CPC G01B 11/272

(57) ABSTRACT

The present invention relates to the field of vehicle calibration and discloses a calibration system and a calibration bracket. The calibration bracket includes a base, a stand assembly and a beam assembly. The stand assembly includes a first upright rod and a second upright rod. One end of the first upright rod is detachably mounted on the base. The second upright rod is connected to the first upright rod. The first upright rod is nested or folded with the second upright rod to reduce the length of the stand assembly. The beam assembly is supported by the stand assembly. In the calibration bracket of the present invention, the first upright rod is detachably mounted to the base so that the base detaches from the first upright rod, thereby facilitating loading and handling of the calibration bracket. In addition, the first upright rod is adapted to be nested or folded with the second upright rod, which can reduce the length of the stand assembly and further facilitate the loading and handling of the calibration bracket.

### BACKGROUND

### Technical Field

The present application relates to the field of vehicle maintenance and device calibration technologies, and in particular, to a calibration system and a calibration bracket thereof.

### Related Art

An advanced driver assistant system, referred to as “ADAS” for short, is an active safety technology that uses a variety of sensors mounted on a vehicle to collect environment data inside and outside the vehicle as soon as possible to perform technical processing such as identification, detection and tracking of static and dynamic objects, so as to enable a driver to detect possible dangers in the shortest time to attract attention and improve safety. The sensors used in the ADAS mainly include a camera, a radar, a laser and ultrasonic waves, can detect light, heat, pressure or other variables to monitor a state of the vehicle, and are generally located on front and rear bumpers, on a side mirror, inside a stick, or on a windshield of the vehicle. During use of the vehicle, vibration, collision, environmental temperature, humidity, and the like may all change physical mounting states of the sensors. Therefore, the sensors need to be irregularly adjusted or calibrated.

When the sensors are being adjusted or calibrated, a calibration element is generally mounted on a calibration bracket to adjust or calibrate the sensors on the vehicle. However, at present, most calibration brackets are large in size, large in area, complex in assembly, and difficult to move.

### SUMMARY

Embodiments of the present invention are directed to a calibration system and a calibration bracket thereof, which can resolve the technical problem of difficult relocation of a calibration element in the prior art.

The embodiments of the present invention adopt the following technical solutions to resolve the technical problem thereof.

A calibration bracket is provided, including:

a base;

a stand assembly, comprising a first upright rod and a second upright rod, one end of the first upright rod being detachably mounted on the base, the second upright rod being connected to the first upright rod and the first upright rod being nested or folded with the second upright rod to reduce the length of the stand assembly; and

a beam assembly, supported by the stand assembly.

Optionally, the calibration bracket includes a base fixing member, the base fixing member being mounted on one of the base and the first upright rod and fastened to the other so that the first upright rod is fixed to the base, and the base fixing member also detaching from the other so that the first upright rod is removed from the base.

Optionally, one of the first upright rod and the base is provided with a first limiting structure and the other is provided with a second limiting structure, the first limiting structure being fitted to the second limiting structure to limit movement of the first upright rod relative to the base.

Optionally, the first limiting structure is a limiting slot and the second limiting structure is a limiting rod clamped to the limiting slot and abutting against at least a part of an edge of the limiting slot.

Optionally, the limiting slot is a through hole in which a large hole site is in radial communication with a small hole site and the limiting rod passes through the large hole site and then is clamped to the small hole site.

Optionally, the base fixing member includes a pull handle and a buckle;

the pull handle is pivotally connected to the base and is rotatable about a pivot point;

one end of the buckle is connected to the pull handle and is rotatable with the pull handle; and

the other end of the buckle is fastened to or detaches from the first upright rod by rotating the pull handle.

Optionally, the first upright rod is provided with a barb portion and the buckle is fastened to the barb portion, so that the base is fixedly connected to the first upright rod.

Optionally, the second upright rod is disposed inside or sleeved outside the first upright rod, and the second upright rod is movable in a length direction of the first upright rod relative to the first upright rod; and

the beam assembly is supported by the second upright rod.

Optionally, cross sections of the first upright rod and the second upright rod are non-circular.

Optionally, one of the first upright rod and the second upright rod includes a guide rail, and the other is guided by the guide rail to be movable only in the length direction of the first upright rod.

Optionally, the stand assembly includes a driving mechanism which is mounted to the first upright rod, and configured to drive the second upright rod to move in the length direction of the first upright rod relative to the first upright rod.

Optionally, one end of the first upright rod away from the base is pivotally connected to one end of the second upright rod, so that the second upright rod is foldable relative to the first upright rod.

Optionally, one end of the first upright rod away from the base is provided with a first buckle, and one end of the second upright rod is provided with a second buckle, the first buckle and the second buckle being mutually buckled to fasten the second upright rod to the first upright rod.

Optionally, the stand assembly includes a third upright rod, the third upright rod being connected to the second upright rod, and the third upright rod being adapted to be nested or folded with the second upright rod to reduce the length of the stand assembly.

Optionally, the beam assembly includes a beam detachably mounted to the stand assembly.

Optionally, the beam assembly includes a mounting base, the mounting base being supported by the stand assembly, and the beam being detachably mounted in the mounting base and being supported by the stand assembly through the mounting base.

Optionally, the mounting base is disposed on a top surface of the stand assembly.

Optionally, the mounting base forms, in an enclosing manner, a mounting channel which is not closed and has a notch, and the beam is mounted in the mounting channel, the notch being used to facilitate the mounting of the beam in the mounting channel through the notch and to facilitate the removal of the beam from the mounting channel through the notch.

Optionally, the mounting base includes a first limiting structure, the connecting portion includes a second limiting structure adapted to the first limiting structure, and

the first limiting structure is fitted to the second limiting structure to limit the beam into the mounting base.

Optionally, the mounting base is provided with a fixing mechanism which presses the beam on the mounting base so that the beam is pressed on a bottom surface and a side surface of the mounting base.

Optionally, the beam includes a left beam portion, a right beam portion and a connecting portion, the connecting portion being detachably mounted to the stand assembly, one end of the connecting portion being pivotally connected to the left beam portion and the other end of the connecting portion being pivotally connected to the right beam portion.

In the embodiments of the present invention, the following technical solution is further adopted to solve the technical problem thereof.

A calibration system is provided, including a calibration element and the calibration bracket as described above, the calibration element is adapted to be mounted on the calibration bracket.

Compared with the prior art, in the calibration bracket of this embodiment, the first upright rod is detachably mounted to the base so that the base detaches from the first upright rod, thereby facilitating the loading and handling of the calibration bracket. In addition, the first upright rod is adapted to be nested or folded with the second upright rod, which can reduce the length of the stand assembly and further facilitate the loading and handling of the calibration bracket.

The embodiments of the present invention further provide the following technical solution.

A calibration bracket is provided, including a base; a stand assembly including at least two rod bodies, two adjacent ones of the at least two rod bodies being foldably connected; and a support assembly mounted on one of the at least two rod bodies, the support assembly being configured to support a calibration element which is configured to calibrate a device in a driver assistant system of a vehicle.

In some embodiments, the two adjacent ones of the at least two rod bodies are connected by a hinge, a joint or a rotating shaft.

In some embodiments, the stand assembly further includes a connection fixing member which is configured to fix a connection between the at least two rod bodies in an unfolded state.

In some embodiments, the connection fixing member includes a first buckle and a second buckle; the first buckle is rotatably connected to one of the at least two rod bodies and the second buckle is disposed in another of the at least two rod bodies adjacent to the one; and the first buckle and the second buckle are mutually buckled.

In some embodiments, when the at least two rod bodies are in an unfolded state, the support assembly is mounted to one of the at least two rod bodies farthest from the base.

In some embodiments, the at least two rod bodies include a first rod body; and the stand assembly further includes a sliding structure and the support assembly is connected to the first rod body through the sliding structure, the sliding structure being movable in a length direction of the first rod body relative to the first rod body.

In some embodiments, the sliding structure is fixed to at least one position on the first rod body.

In some embodiments, the first rod body is provided with an inner cavity, and the sliding structure includes a first sliding member and a second sliding member, the second sliding member being received in the inner cavity, the first sliding member being disposed outside the first rod body and the support assembly being connected to the second sliding member through the first sliding member; and the second sliding member is movable in the length direction of the first rod body relative to the first rod body.

In some embodiments, one side of the second sliding member facing a cavity wall of the inner cavity is provided with a pulley, and the second sliding member abuts against the cavity wall of the inner cavity through the pulley and moves on the cavity wall of the inner cavity through the pulley.

In some embodiments, a surface of the first rod body is provided with an avoidance slot, an opening of the avoidance slot being disposed in the length direction of the first rod body, the avoidance slot having at least one end and the avoidance slot being in communication with the inner cavity; and the first sliding member and the second sliding member are connected through a limiting portion disposed in the avoidance slot.

In some embodiments, the at least two rod bodies include a first rod body, the support assembly is mounted to the first rod body, and the stand assembly further includes a driving mechanism which is configured to drive the support assembly to move in a length direction of the first rod body relative to the first rod body.

In some embodiments, the driving mechanism includes a driving wheel, a driven wheel and a synchronizing belt, the driving wheel and the driven wheel being both rotatably mounted in one of the at least two rod bodies, and the synchronizing belt being sleeved on the driving wheel and the driven wheel; and the synchronizing belt is connected to the support assembly, so that the synchronizing belt drives the support assembly to move in the length direction of the first rod body relative to the first rod body.

In some embodiments, the driving mechanism further includes a worm and a turbine, the turbine being mounted on the driving wheel and the worm being rotatably mounted on the rod body; and the turbine is engaged with the worm.

In some embodiments, the driving mechanism further includes a hand wheel, the hand wheel being fixedly mounted to the worm, and a rotation axis of the hand wheel coinciding with a rotation axis of the worm.

In some embodiments, the at least two rod bodies include a first rod body and a second rod body, the first rod body being adjacent to the second rod body, one end of the first rod body is sleeved in the second rod body, the first rod body is movable in the length direction of the first rod body relative to the second rod body, and the first rod body is fixed to a preset position.

In some embodiments, the support assembly is fixedly mounted on the first rod body.

In some embodiments, the support assembly is detachably connected to the stand assembly and/or the stand assembly is detachably connected to the base.

Compared with the prior art, in the calibration bracket of the embodiments of the present invention, two adjacent ones of at least two rod bodies are foldably connected so that the stand assembly can be folded and the calibration bracket is easy to carry.

The embodiments of the present invention further provide the following technical solution.

A calibration bracket is provided, including:

a base;

a stand assembly, including a first upright rod and a second upright rod, one end of the first upright rod being mounted to the base, the second upright rod being connected to the first upright rod and the first upright rod being nested or folded with the second upright rod to reduce the length of the stand assembly; and

a beam assembly, supported by the stand assembly.

The embodiments of the present invention further provide the following technical solution.

A calibration bracket is provided, including:

a base;

a stand assembly, including a first rod body and a second rod body, the first rod body being mounted to the base and the second rod body being pivotally folded with the first rod body; and

a support assembly, mounted to the stand assembly.

### BRIEF DESCRIPTION OF THE DRAWINGS

One or more embodiments are described by way of example with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a three-dimensional view of a calibration bracket according to an embodiment of the present invention, in which a multiline laser is mounted to the calibration bracket;

FIG. 2 is a three-dimensional view of the calibration bracket shown in FIG. 1 from another angle;

FIG. 3 is a three-dimensional view of the calibration bracket shown in FIG. 1, in which a beam assembly of the calibration bracket is in a folded state;

FIG. 4 is a partial three-dimensional view of the calibration bracket shown in FIG. 1;

FIG. 5 is a schematic diagram of aligning a calibration system with a vehicle by using the multiline laser mounted to the calibration bracket shown in FIG. 1;

FIG. 6 is a schematic assembly diagram of a base fixing member and an upright rod according to some embodiments, in which upper parts of a base and the upright rod are omitted;

FIG. 7 is a structural exploded view of the base fixing member in FIG. 6;

FIG. 8 is a schematic assembly diagram of a base fixing member and an upright rod according to some other embodiments, in which a base and the upright rod are omitted;

FIG. 9 is a schematic assembly diagram of a base fixing member and an upright rod according to still other embodiments, in which a base and the upright rod are omitted;

FIG. 10 is a schematic structural diagram of the support base and the limiting rod shown in FIG. 9;

FIG. 11 is a schematic assembly diagram of a base fixing member and an upright rod according to yet other embodiments, in which a base and the upright rod are omitted;'

FIG. 12 is a schematic structural diagram of the support base and the limiting rod shown in FIG. 11;

FIG. 13 is a structural exploded view of the base fixing member shown in FIG. 11;

FIG. 14 is a schematic assembly diagram of a base fixing member and an upright rod according to still yet other embodiments, in which a base and the upright rod are omitted;

FIG. 15 is a schematic assembly diagram of a base fixing member and an upright rod according to still yet other embodiments, in which a base and the upright rod are omitted;

FIG. 16 is an exploded view of the base fixing member shown in FIG. 15;

FIG. 17 is a three-dimensional view of a stand assembly of the calibration bracket shown in FIG. 1;

FIG. 18 is a three-dimensional view of the stand assembly shown in FIG. 6, in which some elements are omitted;

FIG. 19 is a three-dimensional view of a stand assembly according to some embodiments, in which some elements are omitted;

FIG. 20 is a three-dimensional view of a stand assembly according to some other embodiments, in which some elements are omitted;

FIG. 21 is an exploded view of a driving mechanism of the stand assembly shown in FIG. 20;

FIG. 22 is a perspective view of the driving mechanism shown in FIG. 20 in a first state;

FIG. 23 is a perspective view of the driving mechanism shown in FIG. 20 in a second state;

FIG. 24 is a perspective view of the driving mechanism shown in FIG. 20 in a third state;

FIG. 25 is a three-dimensional view of a stand assembly according to still other embodiments;

FIG. 26 is an exploded view of the stand assembly shown in FIG. 25;

FIG. 27 is a three-dimensional view of a stand assembly according to yet other embodiments;

FIG. 28 is an exploded view of the stand assembly shown in FIG. 27;

FIG. 29 is a partial sectional view of the stand assembly shown in FIG. 27;

FIG. 30 is a partial schematic diagram of a stand assembly according to some embodiments;

FIG. 31 is a partial schematic diagram of a stand assembly according to some other embodiments;

FIG. 32 is a three-dimensional view after extension of the stand assembly shown in FIG. 31;

FIG. 33 is a local sectional view of the stand assembly shown in FIG. 31;

FIG. 34 is a local sectional view of the stand assembly shown in FIG. 32;

FIG. 35 is a local sectional view of the stand assembly shown in FIG. 32 from another angle;

FIG. 36 is a local sectional view of the stand assembly shown in FIG. 31 from another angle;

FIG. 37 is a three-dimensional view of a beam assembly of the calibration bracket shown in FIG. 1;

FIG. 38 is a sectional view of the beam assembly shown in FIG. 37;

FIG. 39 is an exploded view of the beam assembly shown in FIG. 37;

FIG. 40 is a partial enlarged view of part A in FIG. 37;

FIG. 41 is an exploded view of an adjusting mechanism of the beam assembly shown in FIG. 37;

FIG. 42 is an exploded view of the adjusting mechanism shown in FIG. 37 from another angle;

FIG. 43 is an assembly view of a mounting base and a beam according to some embodiments;

FIG. 44 is a three-dimensional view of a cam handle of the mounting base shown in FIG. 43;

FIG. 45 is an assembly view of a mounting base and an adjusting mechanism according to some embodiments;

FIG. 46 is an assembly view of the mounting base and the regulating mechanism shown in FIG. 45, in which some components are omitted;

FIG. 47 is a three-dimensional view of a joint mechanism of the beam assembly shown in FIG. 37;

FIG. 48 is a three-dimensional view of the joint mechanism shown in FIG. 37 from another angle;

FIG. 49 is a sectional view of the joint mechanism shown in FIG. 48;

FIG. 50 is a three-dimensional view of a joint mechanism according to some embodiments;

FIG. 51 is a sectional view of the joint mechanism shown in FIG. 50;

FIG. 52 is a schematic diagram of mutual buckling between a first buckle and a second buckle according to some embodiments;

FIG. 53 is a three-dimensional view of a joint mechanism according to some other embodiments;

FIG. 54 is a three-dimensional view of a locked cam handle of the joint mechanism shown in FIG. 53;

FIG. 55 is a three-dimensional view of a calibration system according to another embodiment, in which the calibration system includes a calibration bracket and a calibration element, the calibration element being a reflector and mounted to the calibration bracket;

FIG. 56 is a three-dimensional view of the calibration system shown in FIG. 55, in which the reflector is replaced by a pattern plate mounted to the calibration bracket;

FIG. 57 is an assembly view of a beam assembly and a stand assembly according to some embodiments, in which a first fixing member and a second fixing member are mounted to the beam assembly and configured to mount a small calibration element;

FIG. 58 is an assembly view of the beam assembly and the stand assembly shown in FIG. 57 from another angle;

FIG. 59 is an assembly view of the beam assembly and the stand assembly shown in FIG. 57 from still another angle, in which state the calibration bracket is configured to mount a large calibration element, such as a pattern plate;

FIG. 60 is a cross-sectional view of a target mount and a beam according to some embodiments;

FIG. 61 is a three-dimensional view of a calibration bracket according to another embodiment of the present invention;

FIG. 62 is an exploded view of the calibration bracket shown in FIG. 61;

FIG. 63 is a three-dimensional view of a stand assembly of the calibration bracket shown in FIG. 61, in which the stand assembly is in an unfolded state;

FIG. 64 is a three-dimensional view of a stand assembly of the calibration bracket shown in FIG. 61, in which the stand assembly is in a folded state;

FIG. 65 is a partial enlarged view of the stand assembly shown in FIG. 63;

FIG. 66 is a sectional view of the stand assembly shown in FIG. 63;

FIG. 67 is a perspective view of the stand assembly shown in FIG. 63, in which a first upright rod of the stand assembly is blurred;

FIG. 68 is a three-dimensional view of the calibration bracket shown in FIG. 61 according to another implementation;

FIG. 69 is a local enlarged view of a first supporting rod of the calibration bracket shown in FIG. 62;

FIG. 70 is a local enlarged view of a second supporting rod of the calibration bracket shown in FIG. 62; and

FIG. 71 is a three-dimensional view of a calibration system according to still another embodiment of the present invention.

### DETAILED DESCRIPTION

To facilitate the understanding of the present invention, the present invention is described in further detail below with reference to the accompanying drawings and specific embodiments. It should be noted that when an element is expressed as “fixed to” another element, it may be directly on another element or one or more intermediate elements may exist between the two elements. When an element is expressed as “connecting” another element, it may be directly connected to another element, or one or more intermediate elements may exist between the two elements. Orientation or position relationships indicated by the terms used in this specification such as “upper”, “lower”, “inner”, “outer”, “vertical” and “horizontal” are based on orientation or position relationships shown in the accompanying drawings, and are used only for ease of describing the present invention and simplifying the description, rather than indicating or implying that the mentioned apparatus or element needs to have a particular orientation or needs to be constructed and operated in a particular orientation. Therefore, such terms should not be construed as a limitation on the present invention. In addition, the terms such as “first” and “second” are used only for descriptive purposes, and should not be understood as indicating or implying relative importance.

Unless otherwise defined, all technical and scientific terms used in this specification have the same meanings as those generally understood by a person skilled in the art. The terms used in the specification of the present invention are intended only to describe the specific embodiments and are not intended to limit the present invention. The terms “and/or” used in this specification include any and all combinations of one or more related items listed.

In addition, the technical features involved in different embodiments of the present invention described below may be combined with each other provided that they do not constitute a conflict with each other.

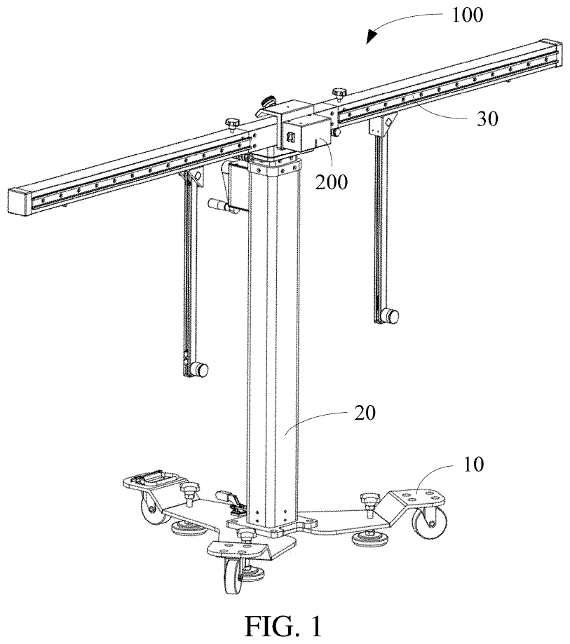

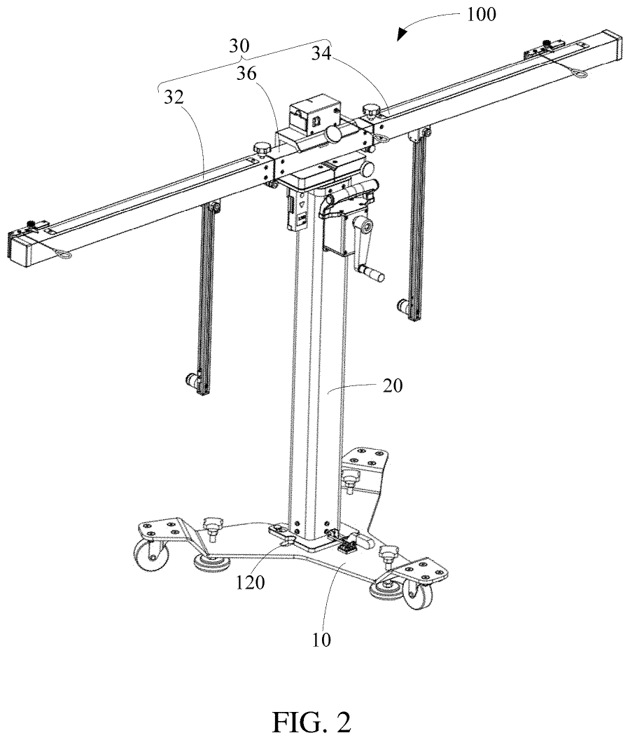

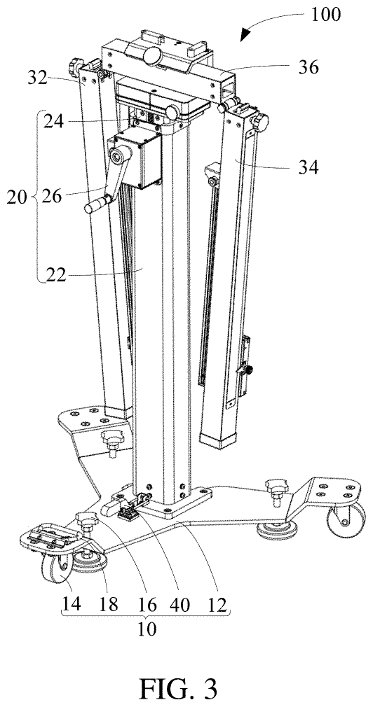

Referring to FIG. 1, FIG. 2 and FIG. 3 together, a calibration bracket 100 according to an embodiment of the present invention includes a base 10, a stand assembly 20 and a beam assembly 30. The stand assembly 20 includes a first upright rod 22 and a second upright rod 24. The first upright rod 22 is detachably mounted to the base 10 and the first upright rod 22 may be nested or folded with the second upright rod 24 to reduce the length of the stand assembly 20.

As the base 10 is generally bulky, the first upright rod 22 is detachably mounted to the base 10, so that the base 10 detaches from the first upright rod 22 to facilitate loading and handling of the calibration bracket 100. In addition, the first upright rod 22 and the second upright rod 24 may be nested or folded with each other to reduce the length of the stand assembly 20, thereby further facilitating the loading and handling of the calibration bracket 100. Moreover, when the first upright rod 22 can be folded with the second upright rod 24, the base 10 may first detach from the first upright rod 22. In this way, it is more convenient to fold the first upright rod 22 with the second upright rod 24.

The beam assembly 30 includes a beam. The beam is detachably mounted to the stand assembly 20, so that the beam detaches from the stand assembly 20, thereby further facilitating the loading and handling of the calibration bracket 100.

The beam includes a first beam portion 32, a second beam portion 34 and a connecting portion 36. The connecting portion 36 is mounted to the stand assembly 20. One end of the connecting portion 36 is hinged to the first beam portion 32 and the other end of the connecting portion 36 is hinged to the second beam portion 34. The first beam portion 32 and the second beam portion 34 may rotate towards each other relative to the connecting portion 36 respectively, to fold the beam assembly 30. The first beam portion 32 and the second beam portion 34 may also rotate away from each other relative to the connecting portion 36 respectively, to unfold the beam assembly 30. When being moved, the beam is folded to reduce the volume of the calibration bracket 100 to facilitate the loading and handling.

In this embodiment, the first beam portion 32 is a left beam portion and the second beam portion 34 is a right beam portion.

In the embodiment of the present invention, the “mounting” includes fixing or restricting an element or apparatus to a particular position or place in a manner such as welding, screwing, clamping or bonding. The element or apparatus may keep still at the particular position or place or move in a limited range and the element or apparatus may or may not be disassembled after it is fixed or restricted to the particular position or place, which is not limited in the embodiment of the present invention. As shown in the figures, the connecting portion 36 is mounted on the stand assembly 20, but the connecting portion 36 may be supported by the stand assembly 20 in other manners. For example, the connecting portion 36 may be mounted to a suitable side surface of the stand assembly 20.

In the embodiment of the present invention, the “supporting” means bearing the weight of an element or apparatus so as not to move downward due to its own weight.

The beam assembly 30 may be configured to mount a calibration element, for example, a multiline laser 200, a calibration target, and a radar reflection or absorption apparatus, to calibrate a vehicle-mounted driver assistant system.

Optionally, the first beam portion 32 and the second beam portion 34 may rotate toward each other relative to the connecting portion 36. For example, they may be folded downward together or folded upward, forward and backward together. Optionally, when the first beam portion 32 and the second beam portion 34 are folded downward, the length of the connecting portion 36 may be relatively short and the first beam portion 32 and the second beam portion 34 are sagging. In this way, the beam assembly 30 does not need to be removed from the stand assembly 20 and space occupied by the calibration bracket 100 may also be significantly reduced, which can be easily carried by a vehicle. When the first beam portion 32 and the second beam portion 34 are folded upward, forward and backward, an apparatus for rotating the beam may be provided, so that the final folding direction of the left beam portion 32 and the second beam portion 34 is downward or the two can be sagging. Alternatively, the length of the connecting portion 36 may be relatively long and the left beam portion 32 and the second beam portion 34 after being folded can be placed next to the connecting portion 36 and fixed to the connecting portion 36 by a detachable fixing apparatus. In the latter case, in order to further reduce the space occupied by the calibration bracket 100, the beam assembly 30 can be removed from the stand assembly 20, carried to a position where it is needed, and then mounted on the stand assembly 20.

A person skilled in the art may understand that the beam assembly 30 is folded in the above manner, but it is not limited thereto. For example, the beam may be folded into two ends, in which case there is no connecting portion 36. The beam may also be folded into four or more sections. However, three sections are preferred, because this makes the middle section of the beam free from fracture. Therefore, the beam can be stably fixed in balance on the upright rod by using only one fastening component in the middle section.

The base 10 includes a base body 12, rollers 14, height adjusting members 16 and a pull ring 18.

The base body 12 is in the shape of a triangular claw, including three claws which extend in three different directions respectively. The base body 12 may be made of a metal material.

The rollers 14 are mounted to a bottom surface of the base body 12. The number of the rollers 14 may be three. Each of the rollers 14 is mounted to a tail end of a corresponding one of the claws and is configured to facilitate movement of the base body 12. In this embodiment, the rollers 14 are universal moving rollers, so that the base body 12 can arbitrarily move forward, backward, leftward or rightward.

The height adjusting members 16 are mounted to the base body 12 and configured to adjust the height of the base body 12. In this embodiment, the height adjusting members 16 are adjusting knobs, the number of which is three. A lower part of the knob includes at least one screw rod, which matches with a thread of a through hole at the base body 12 to achieve height adjustment. Each of the height adjusting members 16 is mounted to a corresponding one of the claws and is close to a corresponding one of the rollers 14. The three height adjusting members 16 are distributed in a regular triangle.

The pull ring 18 may be mounted to an upper surface of one of the claws and is configured to facilitate pulling of the calibration bracket 100.

It may be understood that in some other embodiments, the shape of the base body 12 may change according to actual requirements, but is not limited to the triangular claw. For example, the base body 12 may be rectangular or circular. The number of the rollers 14 and the number of the height adjusting members 16 may be increased or decreased according to actual requirements respectively. For example, for the base body 12 in the shape of the triangular claw, there may be two height adjusting members, which are fitted to a fixed-height leg to adjust the angle of the base body 12.

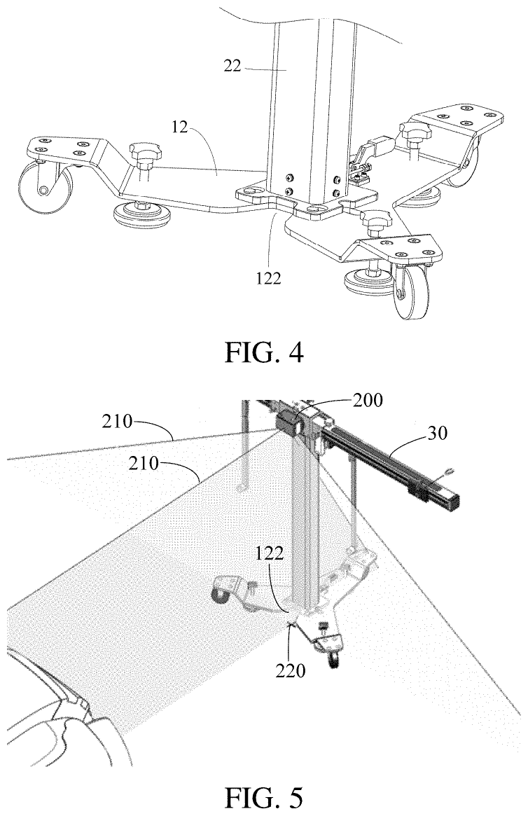

In some embodiments, referring to FIG. 4, the base body 12 is further provided with a recess 122. Two of the claws are located on two opposite sides of the recess 122 respectively and are symmetric with respect to the recess 122. Referring to FIG. 5, when the calibration bracket 100 is aligned with a vehicle, the multiline laser 200 is mounted to the beam assembly 30 and the multiline laser 200 emits two sector rays 210 which are perpendicular to the ground and mutually perpendicular and intersecting. The two sector rays 210 pass through the recess 122 to align with a cross hair 220 disposed on the ground. The base body 12 is provided with the recess 122, which has a simple structure and may further facilitate the operation of aligning the calibration bracket 100 with the vehicle. It may be understood that the recess 122 is used to position the calibration bracket 100 by using an intersection point formed by two laser lines intersecting with and perpendicular to each other. When the base body 12 is in another shape, a recess or hole may be similarly disposed at the corresponding position of the base body 12 so that the laser line intersection point used to position the calibration bracket 100 can be hit on the ground.

Referring to FIG. 3 again, the base 10 further includes a base fixing member 40. The base fixing member 40 may be mounted to one of the base 10 and the first upright rod 22, and the base fixing member 40 may apply a constraining force to the other to restrict movement of the first upright rod 22 relative to the base 10, that is, the first upright rod 22 is fixed to the base 10. The constraining force may be a pulling force or a pushing force. The direction of the constraining force may be set according to actual requirements. For example, the constraining force may be provided in parallel with the base body 11 or at an inclined angle with the base body 11.

It may be understood that the number of the base fixing members 40 may be selected according to actual requirements, provided that respective constraining forces applied by all the base fixing members 40 to the first upright rod 22 can make the first upright rod 22 force-balanced and fastened to the base body 11. That is, the respective constraining forces act together to limit the movement of the first upright rod 22 relative to the base body 11, thereby fixedly mounting the first upright rod 22 to the base 10.

It may be understood that, even if a certain amount of external force is applied to the first upright rod 22, the first upright rod 22 may still be fastened to the base 10 under the connection of the base fixing members 40. For example, when a calibration element is mounted on the first upright rod 22, the center of gravity of the calibration element does not coincide with the center of geometric contour of the first upright rod 22 standing on a support surface of the base 10, which may cause the first upright rod 22 to tip in a direction relative to the base 10. In this case, relative positions of the corresponding base fixing members 40 to the base 10 and the first upright rod 22 are fixed, so that the base fixing members 40 can increase its constraining force applied to the first upright rod 22 in an opposite direction to balance the force on the first upright rod 22, and make the first upright rod 22 firmly stand on the base 10.

The first upright rod 22 may be removed from the base 10 by removing the respective constraining forces applied to the first upright rod 22, that is, by detaching the base fixing members 40 from the first upright rod 22 or the base 10, namely, by removing a connection between the first upright rod 22 and the base 10.

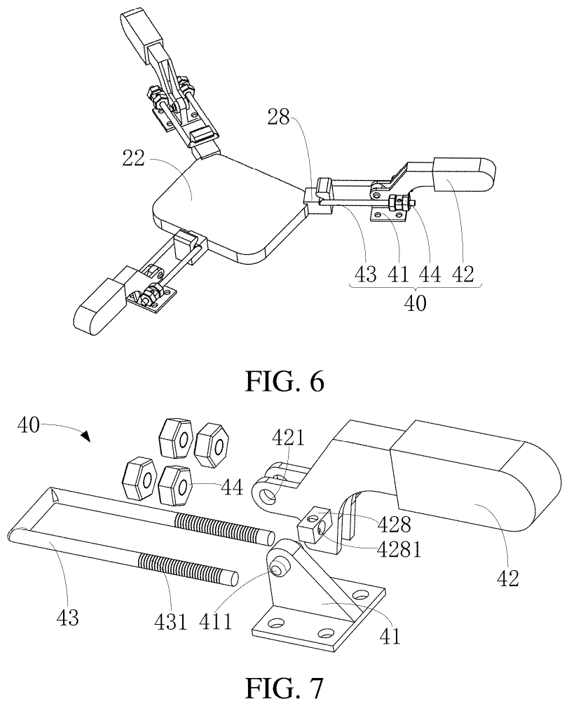

Referring to FIG. 6 and FIG. 7 together, in some embodiments, the base fixing members 40 are connected to the first upright rod 22 and the base 10 by buckling. The number of the base fixing members 40 is three. The three base fixing members 40 are regularly distributed with the first upright rod 22 as the center. As the first upright rod 22 is a square tube, two of the base fixing members 40 are preferably disposed at two adjacent corners at the bottom of the first upright rod 22 respectively and located on two diagonal extension lines at the bottom of the first upright rod 22 respectively. Another of the base fixing members 40 is disposed on a side opposite to the two adjacent corners and is perpendicular to the edge line and at a midpoint position of the edge line. The three base fixing members 40 are distributed in an isosceles triangle.

Each of the base fixing members 40 is fixedly mounted to the base body 12 and may be fastened to the first upright rod 22. Moreover, the position of each of the base fixing members 40 is fixed relative to the first upright rod 22 and the base 10. Each of the base fixing members 40 applies a pulling force to the first upright rod 22. The three pulling forces make the first upright rod 22 force-balanced and fastened to the base body 12. In this embodiment, the three pulling forces are all disposed in parallel with the base body 12, so that the first upright rod 22 is force-balanced in a direction parallel to the base body 12. When the first upright rod 22 is subjected to an external force and tends to move in a direction relative to the base body 12, corresponding one or two of the base fixing members 40 may increase the pulling force opposite to the direction to balance the external force applied to the first upright rod 22, so that the first upright rod 22 keeps static relative to the base body 12.

Certainly, it may be understood that the pulling force may also be provided at an inclined angle with the base body 12. The base fixing member 40 applies an oblique downward pulling force to the first upright rod 22. A component of the pulling force parallel to the base body 12 is used to balance the force applied to the first upright rod 22 parallel to the base body 12 and a component of the pulling force perpendicular to the base body 12 is used to press the bottom of the first upright rod 22 on the base body 12.

The first upright rod 22 is provided with three barb portions 28, each of which is fixedly connected to the bottom of the first upright rod 22. One of the three barb portions 28 corresponds to one of the base fixing members 40.

The barb portion 28 is hook-shaped and the base fixing member 40 may be fastened to the barb portion 28 to apply a pulling force to the first upright rod 22, so that the base 10 is fixedly connected to the first upright rod 22. Preferably, a bending part of the barb portion 28 is disposed upward away from the base body 12 to facilitate the buckling to the barb portion 28 by the base fixing member 40. The bottom of the barb portion 28 abuts against the base body 12, so that the first upright rod 22 does not tip relative to the base body 12 easily.

The base fixing member 40 includes a pivot seat 41, a pull handle 42, a buckle 43 and fasteners 44.

The pivot seat 41 is fixedly mounted to the base body 12 and is disposed opposite to a corresponding one of the barb portions 28. The pivot seat 41 is provided with a pivot shaft 411.

The pull handle 42 is provided with a pivot hole 421. The pivot hole 421 of the pull handle 42 is pivotally connected to the pivot shaft 411. The pull handle is rotatable about the pivot shaft 411 relative to the pivot seat 41. Two sides of the pull handle 42 are provided with adjusting blocks 428 respectively, the adjusting blocks 428 being fixedly connected to the pull handle 42. The adjusting block 428 is provided with an adjusting hole. The adjusting hole may change its position relative to the pivot hole 421 with rotation of the pull handle 42.

The buckle 43 is of a C-shaped structure. An open-ring end thereof is mounted to the pull handle 42 and is rotatable with the pull handle 42. A closed-ring end thereof is used to fasten the barb portion 28 so that the base fixing member 40 is fastened to the first upright rod 22 and the base 10. Two sides of the open-ring end of the buckle 43 are provided with threaded portions 431 respectively. The two threaded portions 431 pass through the adjusting holes on the two sides of the pull handle 42 respectively and are movable along the adjusting holes relative to the adjusting blocks 428, to adjust an extended length of the buckle 43 relative to the barb portion 28.

Each of the threaded portions 431 is provided with two fasteners 44. The two fasteners 44 are located on two sides of one of the adjusting holes respectively and are in screw-thread fit with the threaded portion 431. Each of the fasteners 44 may rotate and abut against one side of the adjusting hole, so that the buckle 43 is fastened to the adjusting block 428. The extended length of the buckle 43 relative to the barb portion 28 can be adjusted by loosening the corresponding fastener 44, to change a tensioning force of the buckle 43 when it is fastened to the barb portion 28.

Certainly, it may be understood that the buckle 43 is not limited to the C-shaped structure. The buckle 43 may also be of other structures that may be fastened to the barb portion 28, for example, an L-shaped structure, a T-shaped structure, and a U-shaped structure. The fastener 44 may also be omitted. The buckle 43 is a structure in which a frame is fixedly connected to a screw. The frame is configured to be fastened to the barb portion 28 and the screw is directly connected to the adjusting block 428 by thread, to adjust the extended length of the buckle 43 relative to the barb portion 28.

The buckle 43 may rotate relative to the pivot seat 41 with the pull handle 42, to change the position of the buckle 43 relative to the barb portion 28. The pull handle 42 is rotated to make the closed-ring end of the buckle 43 fastened to or detach from the barb portion 28. Specifically, after the first upright rod 22 is placed to a predetermined position, one of the buckles 43 corresponds to one of the barb portions 28. Each of the pull handles 42 is rotated about a corresponding one of the pivot shafts 411 toward a direction away from the first upright rod 22, so that each of the buckles 43 is fastened to a corresponding one of the barb portions 28. The three buckles 43 apply pulling forces in different directions to the three barb portions 28 respectively to restrict movement of the first upright rod 22 relative to the base 10. Moreover, under the gravity of the first upright rod 22, a bottom surface thereof naturally abuts against the base body 12, so that the first upright rod 22 is fixed to the base body 12. In this case, the bottom of the pull handle 42 is held against the pivot seat 41 so that the pivot seat 41 cannot continue to rotate about the pivot hole 421 toward a direction away from the first upright rod 22. Meanwhile, a vertical distance between the adjusting hole and the base body 12 is less than a vertical distance between the pivot hole 421 and the base body 12, so that the buckles 43 are locked with the barb portions 28. Even if the barb portions 28 apply counterforces to the closed-ring ends of the buckles 43, the open-ring ends of the buckles 43 cannot rotate about the pivot shaft 411 to make the buckles 43 detach from the barb portions 28.

The pull handle 42 may be rotated about the pivot shaft 411 toward the direction of the first upright rod 22, so that the buckles 43 rotate with the pull handle 42 to change position relative to the barb portions 28. That is, the buckles 43 detach from the barb portions 28 to remove the first upright rod 22 from the base 10.

In this embodiment, the buckles 43 of the three base fixing members 40 need to be fastened to the three barb portions 28 respectively, to fixedly mount the first upright rod 22 to the base 10. The first upright rod 22 can be removed from the base 10 by detaching the buckles 43 of the three base fixing members 40 from the three barb portions 28 respectively.

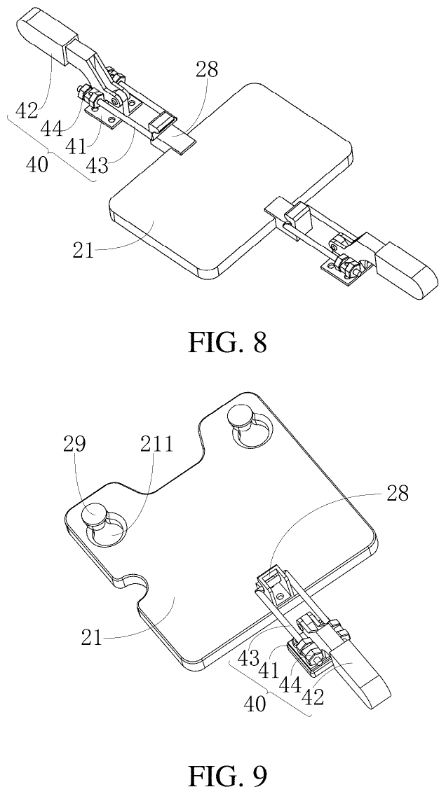

Referring to FIG. 8, in some other embodiments, the number of the base fixing member 40 is two. The two base fixing members 40 are symmetrically disposed on two sides of the first upright rod 22, and the two first upright rods 22 are on the same straight line. Each of the base fixing members 40 is fixedly mounted to the base body 12 and may be fastened to the first upright rod 22. Moreover, the position of each of the base fixing members 40 is fixed relative to the first upright rod 22 and the base 10. Each of the base fixing members 40 applies a symmetric pulling force to the first upright rod 22, so that the first upright rod 22 is force-balanced and fastened to the base 10.

The first upright rod 22 is provided with two barb portions 28, each of which is fixedly connected to the bottom of the first upright rod 22. One of the barb portions 28 corresponds to one of the base fixing members 40. Bending parts of the barb portions 28 are disposed upward away from the base body 12 and the bottoms of the barb portions 28 abut against the base body 12.

Preferably, to enable the first upright rod 22 to firmly stand on the base 10 and prevent the first upright rod 22 from bearing an unbalanced force on two sides without the base fixing member 40, a support base 21 may be disposed on a bottom surface of the first upright rod 22. The support base 21 is a rectangular plate, which is fixedly connected to the bottom surface of the first upright rod 22. Two ends of the support base 21 extend toward two sides of the first upright rod 22 under no pulling force, to increase a contact area between the first upright rod 22 and the base body 12, so that the first upright rod 22 can firmly stand on the base 10 and does not easily tip toward the two sides under no force relative to the base 10.

In this embodiment, the buckles 43 of the two base fixing members 40 need to be fastened to the two barb portions 28 respectively, to fixedly mount the first upright rod 22 to the base 10. The first upright rod 22 can be removed from the base 10 by detaching the buckles 43 of the two base fixing members 40 from the two barb portions 28 respectively.

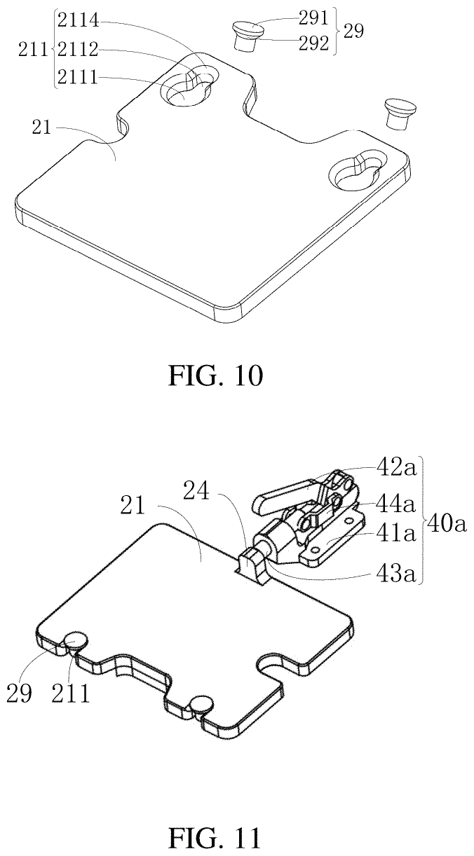

Referring to FIG. 9 and FIG. 10 together, in some embodiments, the number of the base fixing member 40 is one. The base fixing member 40 is disposed on one side of the first upright rod 22. The base fixing member 40 is fixedly mounted to the base body 12 and may be fastened to the first upright rod 22. Moreover, the position of the base fixing member 40 is fixed relative to the first upright rod 22 and the base 10. The base fixing member 40 applies a pulling force to the first upright rod 22.

The bottom of the first upright rod 22 is provided with a support base 21. The support base 21 is substantially a rectangular plate and is fixedly connected to a bottom surface of the first upright rod 22. The support base 21 extends toward around the first upright rod 22 to increase a contact area between the first upright rod 22 and the base body 12, so that the first upright rod 22 can firmly stand on the base body 12 to avoid easy tipping when the calibration element is mounted to the first upright rod 22.

The first upright rod 22 is provided with a barb portion 28. The barb portion 28 is fixedly connected to the support base 21. The barb portion 28 is disposed opposite to the base fixing member 40. The barb portion 28 is configured to be fastened to the buckle 43 of the base fixing member 40. A bending part of the barb portion 28 is disposed upward away from the support base 21.

A limiting structure is disposed between the first upright rod 22 and the base 10. Specifically, one of the first upright rod 22 and the base 10 is provided with a first limiting structure and the other is provided with a second limiting structure. The first limiting structure and the second limiting structure are fitted to each other to restrict movement of the first upright rod 22 relative to the base 10, so that the first upright rod 22 firmly stands on the base 10 when the buckle 43 of the base fixing member 40 is fastened to the barb portion 28. By disposing the first limiting structure and the second limiting structure fitted to each other, the number of the base fixing member 40 required to fix the first upright rod 22 can be correspondingly reduced. Thus, positioning between the first upright rod 22 and the base 10 can be facilitated, and mounting and disassembly of the first upright rod 22 can be more quickly achieved.

Further, the first limiting structure is a limiting hole 211 and the second limiting structure is a limiting rod 29. The limiting hole 211 is disposed on the support base 21 and the limiting rod 29 is fixedly connected to the base 10. In this embodiment, two limiting holes 211 are disposed on one side of the support base 21, two limiting rods 29 are disposed on the base body 12 corresponding to the two limiting holes 211 respectively and one barb portion 28 is disposed on an opposite side of the two limiting holes 211 and located at the top of the support base 21. The two limiting holes 211 and the barb portion 28 are distributed in an isosceles triangle.

The limiting rod 29 may pass through the limiting hole 211 and then be clamped to the limiting hole 211. When the buckle 43 of the base fixing member 40 is fastened to the barb portion 28, a pulling force applied by the base fixing member 40 to the first upright rod 22 causes the limiting rod 29 to abut against an inner side wall of the limiting hole 211. That is, movement of the first upright rod 22 relative to the base 10 is restricted by mutually fitting the base fixing member 40 with the limiting hole 211 and the limiting rod 29, so that the first upright rod 22 is fastened to the base 10.

Further, the limiting rod 29 is provided with a pressing cap 291. The pressing cap 291 is fixedly connected to a tail end of the limiting rod 29. The pressing cap 141 is configured to abut against an edge of the limiting hole 211. That is, the pressing cap 291 abuts against an upper surface of the support base 21 to press the first upright rod 22 on the base 10, to restrict movement of the first upright rod 22 in a direction perpendicular to the base body 12 relative to the base 10. When the buckle 43 of the base fixing member 40 is fastened to the barb portion 28, the limiting rod 29 simultaneously abuts against the inner side wall of the limiting hole 211 and the upper surface of the support base 21, so that the first upright rod 22 is fixed to the base 10.

Further, the pressing cap 291 is provided with a first abutting surface 292 and the edge of the limiting hole 211 is provided with a second abutting surface 2114. The first abutting surface 292 is adapted to the second abutting surface 2114. The first abutting surface 292 may abut against the second abutting surface 2114, so that the limiting hole 211 may closely contact the limiting rod 29 to prevent a gap between the pressing cap 291 of the limiting rod 29 and the edge of the limiting hole 211 when the base fixing member 40 is fastened to the barb portion 28. In this embodiment, the first abutting surface 292 and the second abutting surface 2114 are both inverted cone surfaces. The pressing cap 291 may closely contact the edge of the limiting hole 211, so that the limiting rod 29 may apply an inclined-surface pressure to the first upright rod 22, so as to balance the force on the first upright rod 22 from the angle of an inclined surface.

In this embodiment, the limiting hole 211 is a through hole in which a large hole site 2111 is in radial communication with a small hole site 2112. The small hole site 2112 is disposed away from the barb portion 28 relative to the large hole site 2111. The aperture of the large hole site 2111 is greater than that of the small hole site 2112. The pressing cap 291 is a circular pressing cap 291. The diameter of the pressing cap 291 is less than or equal to the aperture of the large hole site 2111 and greater than the aperture of the small hole site 2112. The rod diameter of the limiting rod 29 is adapted to the aperture of the small hole site 2112. The limiting rod 29 may pass through the large hole site 2111 and then be clamped to the small hole site 2112. The first abutting surface 292 of the pressing cap 291 abuts against the second abutting surface 2114 of the small hole site 2112.

In this embodiment, two limiting rods 29 pass through two large hole sites 2111 respectively and are clamped to the small hole site 2112, and then the buckle 43 of the base fixing member 40 is fastened to the barb portion 28, to fixedly mount the first upright rod 22 to the base 10. The buckle 43 of the base fixing member 40 may detach from the buckling portion and then the two limiting rods 29 respectively detach from the two limiting roles 211, to remove the first upright rod 22 from the base 10.

Certainly, it may be understood that in some other embodiments, the base fixing members 40 are fixedly mounted to the first upright rod 22, and the barb portions 28 are fixedly connected to the base body 12. One of the base fixing members 40 corresponds to one of the barb portions 28. Each of the base fixing members 40 may be fastened to a corresponding one of the barb portions 28, so that the first upright rod 22 is fixed to the base body 12. Each of the base fixing members 40 may also detach from a corresponding one of the barb portions 28, so that the first upright rod 22 can be removed from the base body 12.

It may be understood that in some other embodiments, the support base 21 may be omitted, the limiting hole 211 is directly disposed at the bottom of the first upright rod 22 and the limiting rod 29 is directly disposed on the base 10. Alternatively, the limiting hole 211 is directly disposed on the base 10 and the limiting rod 29 is directly disposed at the bottom of the first upright rod 22. It may be understood that the number of the limiting structures may also be selected according to actual requirements, provided that all the first limiting structures can be fitted to the corresponding second limiting structures to fasten the first upright rod 22 to the base 10 when the base fixing member 40 is fastened to the barb portion 28. For example, the bottom of the first upright rod 22 is provided with three limiting rods 29 and one barb portion 28 and the base 10 is provided with the limiting holes 211 one-to-one corresponding to the three limiting rods 29. The three limiting holes 211 and the barb portion 28 are distributed in a parallelogram.

The base fixing member 40 may be mounted to one of the base 10 and the first upright rod 22. Moreover, the base fixing member 40 may apply a constraining force to the other to restrict movement of the first upright rod 22 relative to the base 10. That is, the first upright rod 22 is fixed to the base 10. The constraining force may be a pulling force or a pushing force. The direction of the constraining force may be set according to actual requirements. For example, the constraining force may be provided in parallel with the base body 12 or at an inclined angle with the base body 12.

It may be understood that the number of the base fixing member 40 may be selected according to actual requirements, provided that respective constraining forces applied by all the base fixing members 40 to the first upright rod 22 can make the first upright rod 22 force-balanced and fastened to the base body 12. That is, the respective constraining forces act together to limit the movement of the first upright rod 22 relative to the base body 12, thereby fixedly mounting the first upright rod 22 to the base 10.

It may be understood that, even if a certain amount of external force is applied to the first upright rod 22, the first upright rod 22 may still be fastened to the base 10 under the connection of the base fixing members 40. For example, when a calibration element is mounted on the first upright rod 22, the center of gravity of the calibration element does not coincide with the center of geometric contour of the first upright rod 22 standing on a support surface of the base 10, which may cause the first upright rod 22 to tip in a direction relative to the base 10. In this case, relative positions of the corresponding base fixing members 40 to the base 10 and the first upright rod 22 are fixed, so that the base fixing members 40 can increase its constraining force applied to the first upright rod 22 in an opposite direction to balance the force on the first upright rod 22, and make the first upright rod 22 firmly stand on the base 10.

The base fixing member 40 can detach from the first upright rod 22 or the base 10 by removing the respective constraining forces applied to the first upright rod 22. That is, the first upright rod 22 is removed from the base 10 by removing the connection between the first upright rod 22 and the base 10.

Referring to FIG. 11, in some other embodiments, the base fixing member 40a is a push-pull structure. The base fixing member 40a is connected, by abutment, to the first upright rod 22 and the base 10.

The number of the base fixing member 40a is one. The base fixing member 40a is disposed on one side of the first upright rod 22. The base fixing member 40a is fixedly mounted to the base body 12 and may abut the first upright rod 22. Moreover, the relative positions of the base fixing member 40a to the first upright rod 22 and the base 10 are fixed. The base fixing member 40a applies a pushing force to the first upright rod 22.

The bottom of the first upright rod 22 is provided with the support base 21. The base 10 is fixedly connected to a bottom surface of the first upright rod 22.

The support base 21 is provided with an abutting structure 24. The abutting structure 24 is fixedly connected to the top of the support base 21 and is disposed opposite to the base fixing member 40a.

The support base 21 is provided with two limiting holes 211. The base body 12 is correspondingly provided with two limiting rods 29. One of the limiting holes 211 corresponds to one of the limiting rods 29. The two limiting holes 211 are located on an opposite side of the abutting structure 24. The two limiting holes 211 and the abutting structure 24 are distributed in an isosceles triangle.

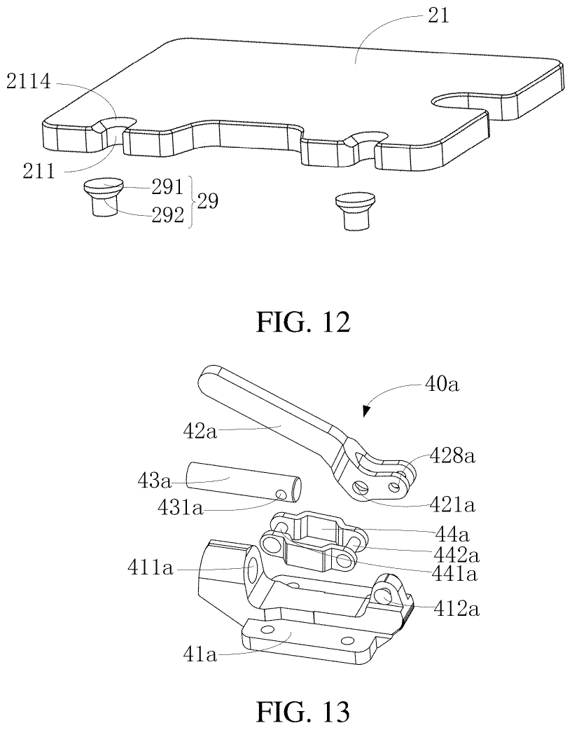

Referring to FIG. 12, the limiting hole 211 is a U-shaped through slot. The slotting position of the limiting hole 211 is disposed away from the abutting structure 24. The limiting rod 29 is provided with a pressing cap 291. The pressing cap 291 is provided with a first abutting surface 292. An edge of the limiting hole 211 is provided with a second abutting surface 2114. The first abutting surface 292 is adapted to the second abutting surface 2114. The first abutting surface 292 may abut against the second abutting surface 2114, so that the limiting hole 211 can closely contact the limiting rod 29. The first abutting surface 292 and the second abutting surface 2114 are both inverted cone surfaces. The pressing cap 291 may closely contact the edge of the limiting hole 211, so that the limiting rod 29 may apply an inclined-surface pressure to the first upright rod 22, so as to balance the force on the first upright rod 22 from the angle of an inclined surface.

Referring to FIG. 13 to FIG. 15 together, the base fixing member 40a includes a pivot seat 41a, a pull handle 42a, a push shaft 43a and a connecting rod 44a.

The pivot seat 41a is fixedly connected to the base body 12. A front end of the pivot seat 41a is provided with a guide hole 411a. The guide hole 411a is disposed opposite to the abutting structure 24. A rear end of the pivot seat 41a is provided with a pivot shaft 412a.

The pull handle 42a is provided with a first pivot hole 421a and a second pivot hole 428a which are disposed in a front-back manner. The second pivot hole 428a of the pull handle 42a is pivotally connected to the pivot shaft 412a and is rotatable about the pivot shaft 412a relative to the pivot seat 41a.

The push shaft 43a is mounted in the guide hole 411a in a sliding manner and is slidable along the guide hole 411a relative to the pivot seat 41a. One end of the push shaft 43a is provided with a third pivot hole 431a, which is disposed away from the abutting structure 24.

Front and rear ends of the connecting rod 44a are respectively provided with a first rotating shaft 441a and a second rotating shaft 442a. The first rotating shaft 441a and a second rotating shaft 442a are respectively pivotally connected to the third pivot hole 431a of the push shaft 43a and the first pivot hole 421a of the pull handle 42a. The pull handle 42a is rotated so that the push shaft 43a slides along the guide hole 411a in a certain stroke.

In this embodiment, after the two limiting rods 29 are clamped to the limiting holes 211, the pull handle 42a is rotated about the pivot shaft 412a toward the direction of the first upright rod 22, so that the push shaft 43a slides along the guide hole 411a toward the abutting structure 24. Accordingly, one end of the push shaft 43a is held against the abutting structure 24 to fasten the first upright rod 22 to the base 10. Meanwhile, a vertical distance from a pivot point between the second rotating shaft 442a of the connecting rod 44a and the first pivoting hole 421a of the pull handle 42a to the base body 12 is less than a vertical distance from a pivot point between the first rotating shaft 441a of the connecting rod 44a and the third pivoting hole 431a of the push shaft 43a to the base body 12, so that the push shaft 43a is locked with the abutting structure 24. The push shaft 43a cannot detach from the abutting structure 24 even if the abutting structure 24 applies a reverse pushing force to the push shaft 43a.

The pull handle may be rotated about the pivot shaft 412a toward a direction away from the first upright rod 22, so that the push shaft 43a detaches from the abutting structure 24 along the guide hole 411a, so as to remove the first upright rod 22 from the base 10.

It may be understood that in some other embodiments, the support base 21 may be omitted, one of the limiting hole 211 and the limiting rod 29 is directly disposed at the bottom of the first upright rod 22, and the other is directly disposed on the base 10. The abutting structure 24 may also be omitted and the push shaft 43a of the base fixing member 40a is directly held against one side of the first upright rod 22. Certainly, the number of the base fixing member 40a may also be selected according to actual requirements. For example, four base fixing members 40a are regularly disposed around the first upright rod 22 with the first upright rod 22 being the center. To ensure close fit between the push shaft 43a of the base fixing member 40a and the first upright rod 22, the first upright rod 22 may be provided with insertion holes one-to-one corresponding to four push shafts 43a. The insertion holes are blind holes, so that when the push shafts 43a are held against the first upright rod 22, the push shafts 43a are at least partially received in the blind holes and the first upright rod 22 is fastened to the base 10. In this case, the limiting hole 211 and the limiting rod 29 may also be correspondingly omitted.

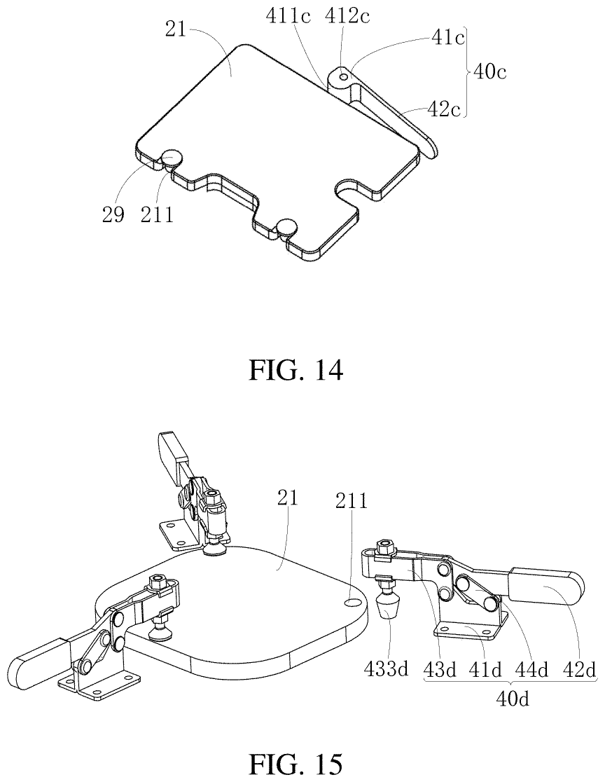

Referring to FIG. 14, in some other embodiments, the base fixing member 40c is an eccentric wrench to replace the base fixing member 40b in the embodiment of the push-pull structure, which is also connected to the first upright rod 22 and the base 10 by means of holding. Correspondingly, the abutting structure 24 disposed on the support base 21 may be omitted. Other technical contents are basically the same as the contents of the embodiment of the push-pull structure.

The base fixing member 40c is disposed on an opposite side of two limiting holes 211. The base fixing member 40c includes a holding portion 41c and a pull handle 42c. The holding portion 41c includes a holding curved surface 411c. The holding portion 41c is provided with an eccentric hole 412c. The eccentric hole 412c deviates from the center of the geometric contour of the holding curved surface 411c. The pull handle 42c is fixedly connected to the holding portion 41c. The eccentric hole 412c of the holding portion 41c is pivotally connected to the base body 12 and the holding curved surface 411c is disposed opposite to a side surface of the support base 21. The holding portion 41c may rotate about the eccentric hole 412c relative to the base body 12, to change a relative position of the holding curved surface 411c to the support base 21.

In this embodiment, after the two limiting rods 29 are clamped to the limiting holes 211, the pull handle 42c is rotated about the eccentric hole 412c toward the direction of the first upright rod 22, so that the holding curved surface 411c is held against a side surface of the support base 21 to fasten the first upright rod 22 to the base 10.

The pull handle may be rotated about the eccentric hole 412c toward a direction away from the first upright rod 22, so that the holding curved surface 411c detaches from the support base 21, so as to remove the first upright rod 22 from the base 10.

Referring to FIG. 15, in some other embodiments, the base fixing member 40d is of a horizontal structure. A bottom surface of the first upright rod 22 is provided with a support base 21.

The number of the base fixing member 40d is three. The three base fixing members 40d are regularly disposed around the first upright rod 22 with the first upright rod 22 as the center. The three base fixing members 40d are distributed in an isosceles triangle. The support base 21 is provided with three fixed holes 211 one-to-one corresponding to the three base fixing members 40d. The fixed holes 211 are used to connect to the base fixing members 40d, so that the base fixing members 40d are fixedly connected to the first upright rod 22 and the support base 21.

It may be understood that in some other embodiments, the number of the base fixing members 40d is not limited to three. For example, four base fixing members 40d are disposed on four sides of the first upright rod 22 respectively and the four base fixing members 40d are distributed in a parallelogram.

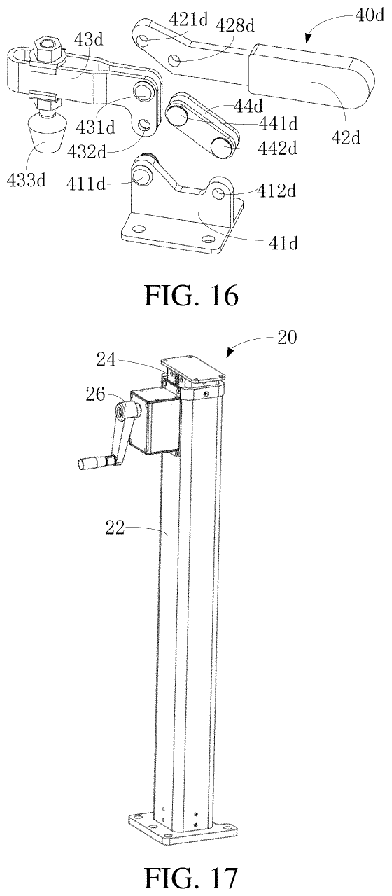

Referring to FIG. 16, the base fixing member 40d includes a pivot seat 41d, a pull handle 42d, a side link 43d and a connecting member 43d.

The pivot seat 41d is fixedly mounted to the base body 12. A front end of the pivot seat 41d is provided with a first pivot shaft 411d and a rear end of the pivot seat 41d is provided with a first pivot hole 412d.

Front and rear ends of the side link 44d are provided with a first rotating shaft 441d and a second rotating shaft 442d. The second rotating shaft 442d is pivotally connected to the first pivot hole 412d. Moreover, the side link 44d may rotate about the first pivot hole 412d relative to the pivot seat 41d.

One end of the connecting member 43d is vertically provided with a second pivot shaft 431d and a second pivot hole 432d. The second pivot hole 432d is pivotally connected to the first pivot shaft 411d of the pivot seat 41d. Moreover, the connecting member 43d may rotate about the first pivot shaft 411d relative to the pivot seat 41d. The other end of the connecting member 43d is provided with a fixed head 433d. The fixed head 433d is fixedly connected to the connecting member 43d. The fixed head 433d is configured to be fastened to the fixed hole 211, so that the first upright rod 22 is fastened to the base 10. The fixed head 433d and the fixed hole 211 are both disposed as inverted cone surfaces. One fixed head 433d corresponds to one fixed hole 211.

The pull handle 42d is provided with a third pivot hole 421d and a fourth pivot hole 428d. The third pivot hole 421d and the fourth pivot hole 428d are disposed in a front-back manner. The third pivot hole 421d is pivotally connected to the second pivot shaft 431d and the fourth pivot hole 428d is pivotally connected to the first rotating shaft 441d of the connecting rod. The pull handle 42d is rotated so that the fixed head 433d moves up and down relative to the fixed hole 211.

The pivot seat 41d, the connecting rod 44d, the connecting member 43d and the pull handle 42d form a double-rocker mechanism.

In this embodiment, after the first upright rod 22 is placed to a predetermined position, one fixed head 433d corresponds to one fixed hole 211. Each of the pull handles 42d is pulled toward a direction away from the first upright rod 22, so that each of the connecting members 43d rotates about the first pivot shaft 411d of a corresponding one of the pivot seats 41d, so that a corresponding one of the fixed heads 433d is fastened from top to bottom to a corresponding one of the fixed holes 211. Three fixed heads 433d apply constraining forces in different directions to three fixed holes 211 respectively, to restrict movement of the first upright rod 22 relative to the base. Moreover, under the gravity of the first upright rod 22, a bottom surface thereof naturally abuts against the base body 12, so that the first upright rod 22 is fastened to the base body 12. In this case, the third pivot hole 421d and the fourth pivot hole 428d of the pull handle 42d and the first pivot hole 412d of the pivot seat 41d are on the same straight line. The mechanism is at a dead center position. The fixed head 433d cannot detach from the fixed hole 211 no matter how much a counterforce is applied by the support base 21 to the fixed head 433d.

The pull handle 42d is pulled toward the direction of the first upright rod 22, so that the fixed head 433d detaches from bottom to top from the fixed hole 211, to remove the first upright rod 22 from the base.

It may be understood that when the first limiting structure and the second limiting structure fitted to each other are not disposed between the first upright rod 22 and the base 10, a positioning structure may be disposed between the first upright rod 22 and the base. For example, the first upright rod 22 is provided with a recess, a concave surface, a positioning hole or the like, and the base 10 is provided with a matching convex rail, convex surface, positioning post or the like, so that the first upright rod 22 may be quickly placed at an accurate position through the positioning structure. Meanwhile, the positioning structure may also limit the first upright rod 22 to some extent.

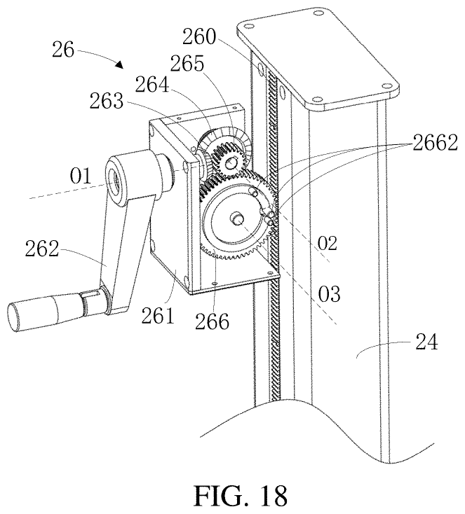

Referring to FIG. 17 and FIG. 18 together, the stand assembly 20 may further include a driving mechanism 26. In this embodiment, the first upright rod 22 is a fixed upright rod and the second upright rod 24 is a movable upright rod. The movable upright rod 24 may move in a length direction of the fixed upright rod 22 relative to the fixed upright rod 22. The driving mechanism 26 is mounted to the fixed upright rod 22 and is configured to drive the movable upright rod 24 to move in the length direction of the fixed upright rod 22 relative to the fixed upright rod 22. The beam assembly 30 is mounted to a top surface of the movable upright rod 24, so that the center of gravity of the beam assembly 30 is closer to the center of gravity of the stand assembly 20 compared with a conventional calibration frame. Stability of the calibration frame can be increased and the base body 12 with a smaller area can be used. By sleeving the movable upright rod 24 with the fixed upright rod 22, the height of the stand assembly 20 can be reduced to nearly half of the original. With the folding of the beam assembly 30, the stand assembly 20 can be very suitable for being carried in a rear box of a vehicle such as an automobile.

Optionally, the fixed upright rod 22 and the movable upright rod 24 are square tubes respectively. The movable upright rod 24 is tightly sleeved in the fixed upright rod 22, which enables the movable upright rod 24 to move only in a length direction of the fixed upright rod 22 relative to the fixed upright rod 22 and can prevent the movable upright rod 24 from moving in other directions relative to the fixed upright rod 22. Such construction is very important for the folding of the calibration bracket 100, because a fixed relative position relationship between components of the calibration bracket 100 are usually required during calibration. For example, a laser may be fixed to an outer surface of the fixed upright rod 22. A central axis of the vehicle is positioned by using the laser, so as to determine a relative position between a target carried on the beam assembly 30 and the vehicle. Therefore, if a relative position between the components slightly changes, calibration accuracy may be affected or an additional fine-tuning mechanism needs to be added to make up for it. If a relative position between the components greatly changes, the additional fine-tuning mechanism may fail. Therefore, in the nesting manner, relative motion between the movable upright rod 24 and the fixed upright rod 22 not in the length direction, for example, relative rotation, needs to be excluded. A simple method is to make the movable upright rod 24 and the fixed upright rod 22 both square tubes, which can ensure that only relative motion in the length direction occurs between the two.

It may be understood that in some other embodiments, the fixed upright rod 22 and the movable upright rod 24 may also be pipes in other shapes, for example, polygonal pipes with mutually matching cross sections, which enables the movable upright rod 24 to move only in the length direction of the fixed upright rod 22 relative to the fixed upright rod 22 and can prevent the movable upright rod 24 from moving in other directions relative to the fixed upright rod 22. The “mutually matching” does not necessarily require the cross sections of the fixed upright rod 22 and the movable upright rod 24 to be the same. For example, the cross section of the fixed upright rod 22 disposed outside may be a hexagon, while the cross section of the movable upright rod 24 disposed inside may be a quadrilateral connected to the hexagon, which can also achieve the effect of enabling the movable upright rod 24 to move only in the length direction of the fixed upright rod 22 relative to the fixed upright rod 22. The cross sections of the fixed upright rod 22 and the movable upright rod 24 may also be mutually matching oval cylindrical pipes. The oval cross sections may also limit the relative rotation between the two to a certain extent. When the cross sections of the fixed upright rod and the movable upright rod are non-circular, a pipe wall of the entire fixed upright rod is used as a guide rail to guide a moving direction of the movable upright rod.

The fixed upright rod 22 and the movable upright rod 24 may also be cylindrical pipes with circular cross sections. In this case, the fixed upright rod 22 can be prevented, through a guiding mechanism, from rotating relative to the movable upright rod 24. The guiding mechanism is configured to guide the movable upright rod 24 to stably move relative to the fixed upright rod 22. Alternatively, a mechanism for detecting and adjusting motion of the fixed upright rod 22 not in the length direction relative to the movable upright rod 24 is added at other components of the calibration bracket 100. A simple guiding mechanism is a slider apparatus matching a guide rail. On a surface where the fixed upright rod 22 and the movable upright rod 24 contact with each other, one is provided with the guide rail, and the other is provided with the slider apparatus such as a bump, a plastic strip, a roller, a ball or a gear. In this case, the slider apparatus is restricted to move on the guide rail, which can also ensure that only relative motion in the length direction occurs between the two upright rods. The guide rail may be a recess, a linear projection, a rack or the like additionally disposed on a pipe wall of the upright rod or a recess or a linear projection formed by the pipe wall of the upright rod itself, a recess formed between two linear projections or the like. That is, a profiled pipe wall is used for the upright rod and the pipe wall itself is shaped with a recess, a linear projection or other parts that can be used as a guide rail. Similarly, the slider apparatus may be an additional component disposed on the pipe wall of the upright rod or a raised structure formed by the pipe wall of the upright rod itself, without the need to dispose an additional component at the pipe wall of the upright rod. In addition, the rack or the like is a mechanism that achieves transmission by engagement, which also has a guiding function and is also included in the category of guide rails in this specification. A gear-and-rack transmission mechanism as described in the following embodiment can also achieve a guiding effect. Optionally, the rack may be disposed in a recess guide rail.

It may be understood that positions where the guide rail and the slider apparatus are disposed are interchangeable. The guide rail may be disposed on the movable upright rod and the slider apparatus may be disposed on the fixed upright rod, which may also be changed.

It may be understood that the guiding mechanism is not limited to the fixed upright rod 22 and the movable upright rod 24 with circular cross sections. The fixed upright rod 22 and the movable upright rod 24 with cross sections in other shapes may also enhance the guiding function by using the guiding mechanism and achieve more stable or less frictional relative motion. For non-circular cross section shapes, the more stable or less frictional relative motion may also be achieved by only using a linear motion apparatus instead of using the guide rail. In this case, the non-circular outside upright rod itself plays a guiding function.

The driving mechanism 26 includes a rack 260, a housing 261, a handle 262 and a gear reduction assembly. The gear reduction assembly includes a first helical gear 263, a second helical gear 264, a first transmission gear 265 and a second transmission gear 266.

The rack 260 is fixedly mounted to the movable upright rod 24 and the rack 260 is disposed in the length direction of the movable upright rod 24. When the base 10 is placed on a horizontal plane, the fixed upright rod 22, the movable upright rod 24 and the rack 260 are all disposed vertically.

The housing 261 is fixedly mounted to the fixed upright rod 22.

The handle 262 is mounted to the housing 261 and the handle 262 is rotatable about a first rotation axis O1.

The gear reduction assembly may make position movement of the movable upright rod more accurate and labor-saving, which is conducive to accurately determining the height of the calibration target. In the gear reduction assembly, the first helical gear 263 is located in the housing 261 and is fixedly mounted to the handle 262. A rotation axis of the first helical gear 263 coincides with that of the handle 262. The first helical gear 263 and the handle 262 may rotate together about the first rotation axis O1.

The second helical gear 264 is mounted to an inner wall of the housing 261 and is rotatable about a second rotation axis O2. The first helical gear 263 is engaged with the second helical gear 264. The diameter of the first helical gear 263 is less than that of the second helical gear 264.

The first transmission gear 265 is fixedly mounted to the second helical gear 264. A rotation axis of the first transmission gear 265 coincides with that of the second helical gear 264. The first transmission gear 265 and the second helical gear 264 may rotate together about the second rotation axis O2.

The second transmission gear 266 is mounted to an inner wall of the housing 261 and is rotatable about a third rotation axis O3. The second transmission gear 266 is engaged with the first transmission gear 265 and the rack 260 respectively. The second transmission gear 266 is provided with a convex post 2662 to mesh with a ratchet (not shown) so that the second transmission gear 266 stops at a preset position. The first transmission gear 265 and the second transmission gear 266 are both spur gears. The diameter of the first transmission gear 265 is less than that of the second transmission gear 266.

The first rotation axis O1 is perpendicular to the second rotation axis O2 and the third rotation axis O3, and the first rotation axis O1 is perpendicular to the rack 260. The second rotation axis O2 and the third rotation axis O3 are disposed in parallel, and the second rotation axis O2 and the third rotation axis O3 are perpendicular to the rack 260.

When the handle 262 rotates about the first rotation axis O1, it drives the first helical gear 263 to rotate about the first rotation axis O1, the second helical gear 264 and the first transmission gear 265 to rotate about the second rotation axis O2, and the second transmission gear 266 to rotate about the third rotation axis O3. When the second transmission gear 266 rotates about the third rotation axis O3, it drives the rack 260 to ascend or descend in the length direction of the movable upright rod 24, so that the movable upright rod 24 ascends or descends relative to the fixed upright rod 22.

In this embodiment, the first helical gear 263 and the second helical gear 264 are engaged with each other, the first transmission gear 265 and the second helical gear 264 may rotate together about the second rotation axis O2, and the second transmission gear 266 is engaged with the first transmission gear 265 and the rack 260 respectively, which may drive the movable upright rod 24 to stably move relative to the fixed upright rod 22. In addition, the diameter of the first helical gear 263 is less than that of the second helical gear 264, and the diameter of the first transmission gear 265 is less than that of the second transmission gear 266, so that the movable upright rod 24 may be driven by a small force to move relative to the fixed upright rod 22.

It may be understood that in some other embodiments, the first helical gear 263 and the second helical gear 264 may be omitted, the first transmission gear 265 is fixedly mounted to the handle 262 and the handle 262 is rotatable about the second rotation axis O2, so as to drive the first transmission gear 265 to rotate about the second rotation axis O2.

It may be understood that in some other embodiments, the first helical gear 263, the second helical gear 264 and the first transmission gear 265 may be omitted, the second transmission gear 266 is fixedly mounted to the handle 262, and the handle 262 is rotatable about the third rotation axis O3, so as to drive the second transmission gear 266 to rotate about the third rotation axis O3.

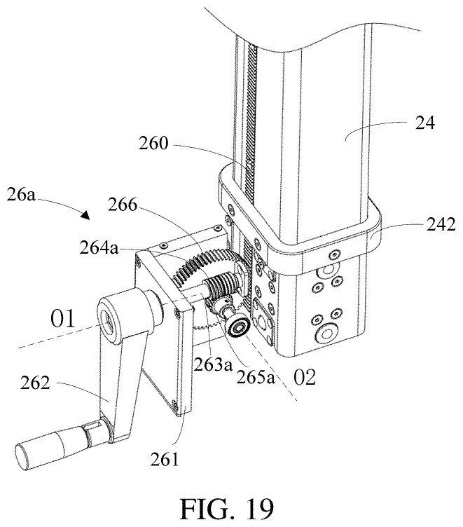

Referring to FIG. 19, in some embodiments, the first helical gear 263, the second helical gear 264 and the first transmission gear 265 may be replaced with a worm mechanism. The worm mechanism includes a worm 263a and a worm wheel 265a.

One end of the worm 263a is fixedly mounted to the handle 262, and a rotation axis of the worm 263a coincides with that of the handle 262. The worm 263a and the handle 262 may rotate together about the first rotation axis O1.

The worm 263a is cylindrical, with a tooth portion 264a on an outer surface thereof. The tooth portion 264a is engaged with the worm wheel 265a.

The worm wheel 265a is fixedly mounted to the second transmission gear 266. A rotation axis of the worm wheel 265a coincides with that of the second transmission gear 266. The worm wheel 265a and the second transmission gear 266 may rotate together about the second rotation axis O2. The diameter of the worm wheel 265a is less than that of the second transmission gear 266, so that the movable upright rod 24 can be driven by a small force to move relative to the fixed upright rod 22. The first rotation axis O1 is perpendicular to the second rotation axis O2. The second rotation axis O2 is perpendicular to the rack 260.

When the movable upright rod 24 moves relative to the fixed upright rod 22 to a required position, the movable upright rod 24 can be fixed to the required position by means of a self-locking function of the worm mechanism.

It may be understood that in some other embodiments, the handle 262 may be replaced with a motor.

It may be understood that in some other embodiments, in addition to a gearbox, the driving mechanism 26 may be another driving mechanism, such as a lead screw drive or a synchronizing belt, provided that the movable upright rod 24 can be driven to move relative to the fixed upright rod 22.

In some embodiments, the movable upright rod 24 is provided with a limiting member 242. The limiting member 242 is located in the fixed upright rod 22. An inner wall of the fixed upright rod 22 is provided with a flange, which is close to a top end of the fixed upright rod 22. When the movable upright rod 24 moves relative to the fixed upright rod 22 to the limiting member 242 to contact the flange, the movable upright rod 24 stops moving, which may prevent the movable upright rod 24 from detaching from the fixed upright rod 22. In this embodiment, the limiting member 242 is a sleeve ring, which is sleeved on an outer wall of the movable upright rod 24.

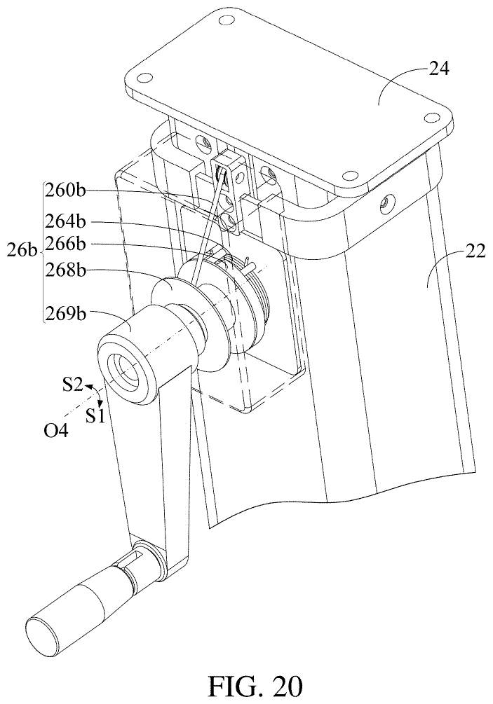

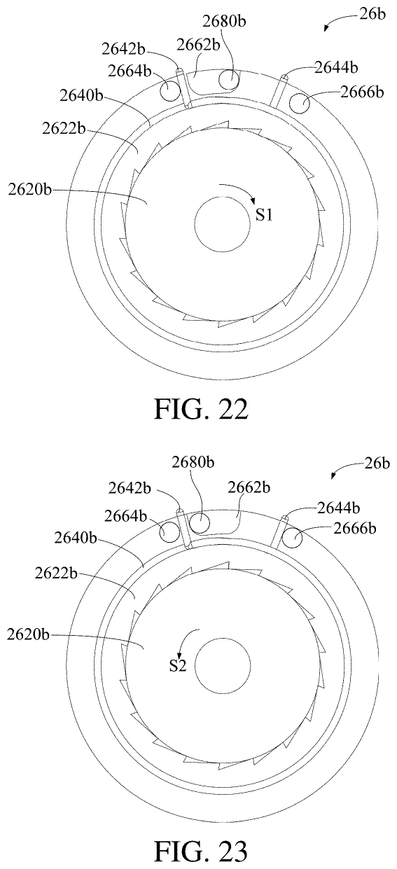

Referring to FIG. 20 to FIG. 24 together, in some embodiments, the driving mechanism 26c includes a transmission assembly 260b, a one-way rotating assembly 262b, a spring 264b, a first rotary body 266b, a second rotary body 268b and a hand wheel 269b. The one-way rotating assembly 262b includes a fixed support 2620b and a rotating member 2622b.

The fixed support 2620b is fixedly mounted to the fixed upright rod 22 and the rotating member 2622b is mounted to the fixed support 2620b. The rotating member 2622b may rotate only about the preset axis O4 and toward a first rotation direction S1 relative to the fixed support 2620b.

The spring 264b sleeves and tightly holds the rotating member 2622b.

The first rotary body 266b is mounted to the fixed support 2620b. The first rotary body 266b may rotate about the preset axis O4 relative to the fixed support 2620b. The first rotary body 266b is configured to press the spring 264b. As shown in FIG. 7, when the first rotary body 266b presses the spring 264b toward the first rotation direction S1, the spring 264b drives the rotating member 2622b to rotate. As shown in FIG. 8, when the first rotary body 266b presses the spring 264b toward a second rotation direction S2, the spring 264b releases the rotating member 2622b and rotates relative to the rotating member 2622b. The second rotation direction S2 is opposite to the first rotation direction S1.

The second rotary body 268b is mounted to the first rotary body 266b. The second rotary body 268b may rotate between a first position and a second position about the preset axis O4 relative to the first rotary body 266b. The second position is on one side of the first position facing the first rotation direction S1. The second rotary body 268b is configured to drive the first rotary body 266b to rotate. When the second rotary body 268b rotates to the first position, the second rotary body 268b may drive the first rotary body 266b toward the first rotation direction S1. When the second rotary body 268b rotates to the second position, the second rotary body 268b may drive the first rotary body 266b toward the second rotation direction S2. As shown in FIG. 9, when the second rotary body 268b rotates between the first position and the second position and the second rotary body 268b rotates toward the second rotation direction S2, the spring 264b abuts the second rotary body 268b.

The transmission assembly 260b is connected to the second rotary body 268b and the movable upright rod 24. When the second rotary body 268b rotates toward the first rotation direction S1, the second rotary body 268b drives the movable upright rod 24 to ascend through the transmission assembly 260b. When the first rotary body 266b rotates toward the second rotation direction S2, the second rotary body 268b drives the movable upright rod 24 to descend through the transmission assembly 260b.

The hand wheel 269b is fixedly mounted to the second rotary body 268b. The hand wheel 269b and the second rotary body 268b may rotate together about the preset axis O4 relative to the first rotary body 266b.

It is worth noting that, in a first aspect, the second rotary body 268b at the first position rotates toward the first rotation direction S1, the second rotary body 268b drives the first rotary body 266b to rotate, the first rotary body 266b presses the spring 264b, and the spring 264b tightly holds the rotating member 2622b, so that the second rotary body 268b, the first rotary body 266b, the spring 264b and the rotating member 2622b rotate together relative to the fixed support 2620b, and the second rotary body 268b rotates toward the first rotation direction S1 and may drive the movable upright rod 24 to ascend through the transmission assembly 260b. In a second aspect, the second rotary body 268b at the second position rotates toward the second rotation direction S2, the second rotary body 268b drives the first rotary body 266b to rotate, the first rotary body 266b presses the spring 264b, and the spring 264b releases the rotating member 2622b, so that the second rotary body 268b, the first rotary body 266b, and the spring 264b rotate together relative to the rotating member 2622b, and the second rotary body 268b rotates toward the second rotation direction S2 and may drive the movable upright rod 24 to descend through the transmission assembly 260b. In the final aspect, when the movable upright rod 24 tends to descend, the movable upright rod 24 pulls the second rotary body 268b through the transmission assembly 260b to make the second rotary body 268b tend to rotate toward the second rotation direction S2. The spring 264b abuts the second rotary body 268b to prevent the movable upright rod 24 from falling. Based on the above, the driving mechanism 26c may prevent the movable upright rod 24 from falling while driving the movable upright rod 24 to ascend or descend. The hand wheel 269b may be replaced with a motor according to an actual situation. The spring 264b abuts the second rotary body 268b to avoid easy falling of the beam configured to mount the calibration element.

The transmission assembly 260b includes a traction rope 2600b. The traction rope 2600b may be a steel wire. One end of the traction rope 2600b is wound around the second rotary body 268 and the other end of the traction rope 2600b is fixedly mounted to the movable upright rod 24. The second rotary body 268b rotates toward the first rotation direction S1 to wind one end of the traction rope 2600b on the second rotary body 268b, so as to pull the movable upright rod 24 to ascend relative to the fixed upright rod 22. Otherwise, the second rotary body 268b rotates toward the second rotation direction S2 to unwind one end of the traction rope 2600b on the second rotary body 268b, so that the movable upright rod 24 descends relative to the fixed upright rod 22 due to its own weight.

It may be understood that the transmission assembly 260b is not merely limited to the form of the traction rope 2600b according to an actual situation. In some other embodiments, the transmission assembly 260b includes a gear and a rack. The gear is fixedly mounted to the second rotary body 268b. The rack is fixed to the movable upright rod 24. The gear is engaged with the rack. The gear may rotate together with the second rotary body 268b to drive the rack to ascend or descend. In some other embodiments, the transmission assembly 260b may also be a lead screw component, a chain wheel component, a wheel component or the like, provided that rotation of the second rotary body 268b can drive, through the transmission assembly 260b, the movable upright rod 24 to ascend or descend.

In this embodiment, the transmission assembly 260b may further include a pulley 2602b. The pulley 2602b is mounted to the top of the fixed upright rod 22. The pulley 2602b may rotate about its own rotation axis relative to the fixed upright rod 22. The other end of the traction rope 2600b is fixedly mounted to the movable upright rod 24 through the pulley 2602b. The pulley 2602b and the traction rope 2600b form a fixed pulley mechanism. By disposing the pulley 2602b, abrasion of the traction rope 2600b can be avoided and friction between the traction rope 2600b and the fixed upright rod 22 can also be reduced, thereby making it easy for the second rotary body 268b to rotate.

The one-way rotating assembly 262b is a ratchet assembly. The rotating member 2622b is a ratchet and is described by taking an internal meshing ratchet being the ratchet as an example. The ratchet assembly further includes a pawl (not shown in the figure) and an elastic member (not shown in the figure). The ratchet is wholly annular. A ratchet tooth is disposed on one side of an inner ring of the ratchet. The ratchet is sleeved on the fixed support 2620b. One end of the pawl is mounted to the fixed support 2620b. The pawl may swing relative to the fixed support 2620b. The other end of the pawl is held against the ratchet tooth of the ratchet. The elastic member is disposed between the pawl and the fixed support 2620b. The elastic member is configured to provide an elastic force for making the pawl abut against the ratchet tooth.

It may be understood that, the one-way rotating assembly 262b is not limited to the ratchet assembly according to an actual situation. In some other embodiments, the one-way rotating assembly 262b may also be a toothed disc assembly. The fixed support 2620b is a first end toothed disc. The rotating member 2622b is a second end toothed disc. The toothed disc assembly includes the first end toothed disc, the second end toothed disc and a compressed spring. The second toothed disc is engaged with the first end toothed disc through the ratchet tooth. The compressed spring presses the first end toothed disc to the second end toothed disc, so that the first end toothed disc keeps engaging with the second end toothed disc, and the second end toothed disc can only rotate in one rotation direction relative to the first end toothed disc. In some other embodiments, the one-way rotating assembly 262b may further be a roller brake, provided that the one-way rotating assembly 262b can only rotate in one rotation direction.

The spring 264b includes a helix portion 2640b and an abutting portion. The helix portion 2640b is elastic. The helix portion 2640b spirals around the preset axis O4. The helix portion 2640b is sleeved on and tightly holding the rotating member 2622b.

The abutting portion connects to and protrudes from the helix portion 2640b. The first rotary body 266b is configured to press the abutting portion. When the first rotary body 266b presses the abutting portion toward the first rotation direction S1, the helix portion 2640b drives the rotating member 2622b to rotate. When the first rotary body 266b presses the abutting portion toward the second rotation direction S2, the helix portion 2640b releases the rotating member 2622b and rotates relative to the rotating member 2622b. When the second rotary body 268b rotates between the first position and the second position, and the second rotary body 268b rotates toward the second rotation direction S2, the abutting portion abuts the second rotary body 268b. A force can be easily applied to the spring 264b in a manner in which the first and second rotary bodies 266 and 268 press the abutting portion. For example, the spring 264b and the rotating member 2622b are pushed. For another example, the spring 264b is loosened and the spring 264b releases the rotating member 2622b. For another example, the second rotary body 268b is held.

It may be understood that the manner in which the first and second rotary bodies 266b and 268b are connected to the spring 264b is not merely limited to the form of pressing the abutting portion. According to an actual situation, the first and second rotary bodies 266b and 268b may also drag the abutting portion. Therefore, the abutting portion is not limited to protruding from the screw portion 2640b. Alternatively, the first and second rotary bodies 266b and 268b can directly press the screw portion 2640b, and then the abutting portion may also be correspondingly omitted, provided that the first and second rotary bodies 266b and 268b press the spring 264b and deform the screw portion 2640b and can release the rotating member 2622b.

Specifically, the abutting portion includes a first abutting portion 2642b and a second abutting portion 2644b. The first abutting portion 2642b and the second abutting portion 2644b both connect to and protrude from the screw portion 2640b. The first rotary body 266b is configured to press the first abutting portion 2642b or the second abutting portion 2644b. When the first rotary body 266b presses the first abutting portion 2642b toward the first rotation direction S1, the screw portion 2640b drives the rotating member 2622b to rotate. When the first rotary body 266b presses the second abutting portion 2644b toward the second rotation direction S2, the screw portion 2640b releases the rotating member 2622b and rotates relative to the rotating member 2622b. When the second rotary body 268b rotates between the first position and the second position, and the second rotary body 268b rotates toward the second rotation direction S2, the first abutting portion 2642b abuts the second rotary body 268b.

It needs to be noted that the first and second abutting portions 2642b and 2644b are two lead-out ends of the screw portion 2640b. Since the screw portion 2640b spirals toward one rotation direction, the first rotary body 266b presses the first abutting portion 2642b toward the first rotation direction S1 or presses the second abutting portion 2644b toward the second rotation direction S2, both of which may deform the screw portion 2640b and make the screw portion 2640b release the rotating member 2622b or tend to release the rotating member 2622b. That the screw portion 2640b releases the rotating member 2622b or tends to release the rotating member 2622b depends on a pressure difference between two support points of the spring 264b. One of the support points is the first and second abutting portions 2642b and 2644b and the other is the rotating member 2622b. However, as the resistance between the rotating member 2622b and the fixed support 2620b is small and the pressure required to deform the screw portion 2640b to release the rotating member 2622b is much greater than the resistance, the screw portion 2640b and the rotating member 2622b may be pushed together toward the first rotation direction S1 to rotate relative to the fixed support 2620b, and the screw portion 2640b does not easily slip relative to the rotating member 2622b. The first abutting portion 2642b abuts the second rotary body 268b, that is, the second rotary body 268b presses the first abutting portion 2642b toward the second rotation direction S2, and the screw portion 2640b deforms to further tightly hold the rotating member 2622b.

In this embodiment, the second abutting portion 2644b is located on one side of the first abutting portion 2642b toward the first rotation direction S1.

The first rotary body 266b includes a first rotary main body 2660b and a stopping portion. The first rotary main body 2660b is mounted to the fixed support. The first rotary main body 2660b may rotate about the preset axis O4 relative to the fixed support 2620b. The first rotary main body 2660b is provided with a curved notch 2662b which has a first end and a second end. The curved notch 2662b is configured for the passage of the second rotary body 268b.

The stopping portion is disposed on one side of the first rotary main body 2660b facing the spring 264b. When the stopping portion presses the first abutting portion 2642b toward the first rotation direction S1, the screw portion 2640b drives the rotating member 2622b to rotate. When the stopping portion presses the second abutting portion 2644b toward the second rotating direction S2, the screw portion 2640b releases the rotating member 2622b and rotates relative to the rotating member 2622b.

Specifically, the stopping portion includes a first stopping portion 2664b and a second stopping portion 2666b. The first stopping portion 2664b and the second stopping portion 2666b are both disposed on one side of the first rotary main body 2660b facing the spring 264b. The first stopping portion 2664b is configured to press the first abutting portion 2642b. The second stopping portion 2666b is configured to press the second abutting portion 2644b. When the first stopping portion 2664b presses the first abutting portion 2642b toward the first rotation direction S1, the screw portion 2640b drives the rotating member 2622b to rotate. When the second stopping portion 2666b presses the second abutting portion 2644b toward the second rotating direction S2, the screw portion 2640b releases the rotating member 2622b and rotates relative to the rotating member 2622b.

In this embodiment, the first abutting portion 2642b and the second abutting portion 2644b are both located between the first stopping portion 2664b and the second stopping portion 2666b in the first rotation direction S1. Moreover, the first abutting portion 2642b is closer to the first stopping portion 2664b, and the second abutting portion 2644b is closer to the second stopping portion 2666b.

In this embodiment, the curved notch 2662b is located between the first stopping portion 2664b and the second stopping portion 2666b in the first rotation direction S1, and the curved notch 2662b is closer to the first stopping portion 2664b. The first end is closer to the first stopping portion 2664b, and the second end is closer to the second stopping portion 2666b.

The second rotary body 268b includes a second rotary main body and a limiting rod 2680b. The second rotary main body is mounted to the first rotary body 266b. The second rotary main body may rotate about the preset axis O4 relative to the first rotary body 266b.

The limiting rod 2680b is disposed on one side of the second rotary main body facing the first rotary body 266b. The limiting rod 2680b passes through the curved notch 2662b. The limiting rod 2680b is located between the first abutting portion 2642b and the second abutting portion 2644b in the first rotation direction S1. The limiting rod 2680b is configured to push the first rotary body 266b to rotate. When the second rotary main body rotates to the first position, the limiting rod 2680b is located at the first end, and the limiting rod 2680b may push the first rotary body 266b toward the first rotation direction S1. When the second rotary main body rotates to the second position, the limiting rod 2680b is located at the second end, and the limiting rod 2680b may push the first rotary body 266b toward the second rotation direction S2. When the second rotary main body rotates between the first position and the second position, and the second rotary main body rotates toward the second rotation direction S2, the limiting rod 2680b is located between the first end and the second end, and the first abutting portion 2642b abuts the limiting rod 2680b.

It may be understood that, according to an actual situation, in some embodiments, the limiting rod 2680b may include a first limiting rod and a second limiting rod. The first limiting rod is located in the curved notch 2662b. The second limiting rod crosses the first rotary body 2660b and is located between the first abutting portion 2642b and the second abutting portion 2644b in the first rotation direction S1. When the second rotary main body rotates to the first position, the first limiting rod is located at the first end. When the second rotary main body rotates to the second position, the first limiting rod is located at the second end. When the second rotary main body rotates between the first position and the second position, the first limiting rod is located between the first end and the second end, and the first abutting portion 2642b abuts the second limiting rod.

The second rotary main body includes a rope axis body 2682b and a baffle. The rope axis body is mounted to the first rotary body 266b. The rope axis body may rotate about the preset axis O4 relative to the first rotary body 266b. One end of the traction rope 2600b is wound around the rope axis body 2682b.

The baffle is disposed at a tail end of the rope axis body 2682b. A cross-section size of the baffle is larger than a horizontal-axis-plane size of the rope axis body 2682b. One end of the traction rope 2600b is limited onto the rope axis body 2682b through the baffle to prevent the traction rope 2600b from detaching from the rope axis body 2682b.

Specifically, the baffle includes a first baffle 2684b and a second baffle 2686b. The first baffle 2684b is disposed at one end of the rope axis body 2682b close to the first rotary body 266b. The second baffle 2686b is disposed on the other end of the rope axis body 2682b away from the first rotary body 266b. A cross-section size of the first baffle 2684b and a cross-section size of the second baffle 2686b are both larger than a cross-section size of the rope axis body 2682b.

The hand wheel 269b is fixedly mounted to the second rotary body 268b, so that the hand wheel 269b and the second rotary body 268b may rotate together about the preset axis O4. The second rotary body 268b can be easily rotated through the hand wheel 269b.

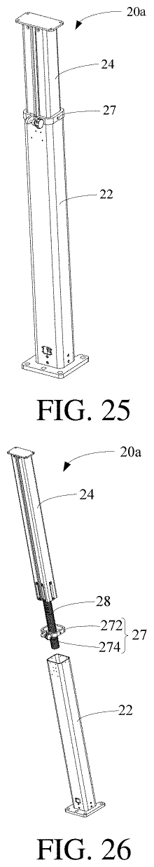

Referring to FIG. 25 and FIG. 26 together, in some embodiments, the driving mechanism 26 is omitted. The stand assembly 20a further includes a fastening mechanism 27 and an elastic body 28.

The fastening mechanism 27 may be mounted to one end of the fixed upright rod 22 and is configured to fix the movable upright rod 24 to the fixed upright rod 22. The fastening mechanism 27 includes a fastening ring 272 and a bolt 274. The fastening ring 272 is sleeved on the fixed upright rod 22. The fastening ring 272 may be formed by bending a metal strip. The bolt 274 is mounted to two ends of the fastening ring 272.

The elastic body 28 is located in the fixed upright rod 22 and the movable upright rod 24. The elastic body 28 is compressed between the bottom of the fixed upright rod 22 and the movable upright rod 24. According to a requirement, the elastic body 28 may be connected to the movable upright rod 24 at the bottom, top or middle of the movable upright rod 24. When the movable upright rod moves to a position closest to the bottom of the fixed upright rod, the elastic body is in a compressed state. In this embodiment, the elastic body 28 is a compressed spring. It may be understood that in some other embodiments, the elastic body 28 may be other elastic elements, for example, an elastic piece, a pneumatic rod, or a hydraulic rod.

When the movable upright rod 24 needs to ascend relative to the fixed upright rod 22, the bolt 274 is rotated so that the fastening ring 272 releases the fixed upright rod 22. An upward force is applied to the movable upright rod 24 to make the movable upright rod 24 ascend in the length direction of the fixed upright rod 22. An external force applied to the movable upright rod 24, for example, an external force applied by an operator, can be reduced by means of an elastic force of the elastic body 28. When a required position is reached, the bolt 274 is rotated to fasten the fixed upright rod 22 so that the movable upright rod 24 is fixed to the required position. When the movable upright rod 24 needs to descend relative to the fixed upright rod 22, the bolt 274 is rotated so that the fastening ring 272 releases the fixed upright rod 22. Under the gravity of the movable upright rod 24 and the beam assembly 30, the movable upright rod 24 may descend in the length direction of the fixed upright rod 22. A descending speed of the movable upright rod 24 may be reduced by means of the elastic force of the elastic body 28 to prevent the movable upright rod 24 from descending too fast and causing damage by colliding with the fixed upright rod 24.

It may be understood that in some other embodiments, the fastening mechanism 27 may also be of other structures, provided that the movable upright rod 24 can be fixed to a required position. For example, the fastening mechanism 27 may be a screw, which passes through the fixed upright rod 22 and is in thread fit with the fixed upright rod 22. When the movable upright rod 24 moves to the required position relative to the fixed upright rod 22, the screw is rotated to abut against the movable upright rod 24, to fix the movable upright rod 24 to the required position. The screw is rotated to detach from the movable upright rod 24. The movable upright rod 24 may move in the length direction of the fixed upright rod 22 relative to the fixed upright rod 22.

It may be understood that the fixed upright rod may also be taken as an inner rod and the movable upright rod as an outer rod as required. A driving mechanism is mounted to the fixed upright rod, and is configured to drive the movable upright rod to move in the length direction of the fixed upright rod relative to the fixed upright rod.

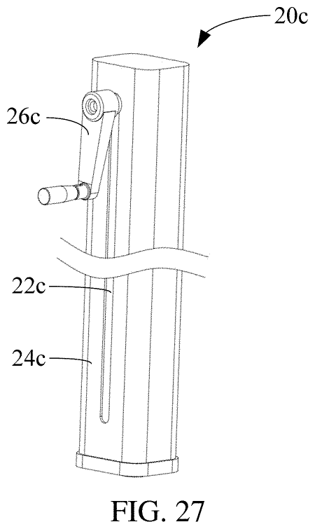

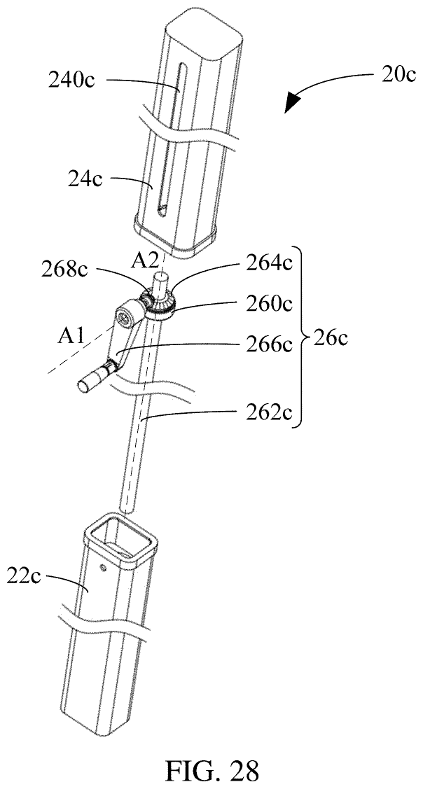

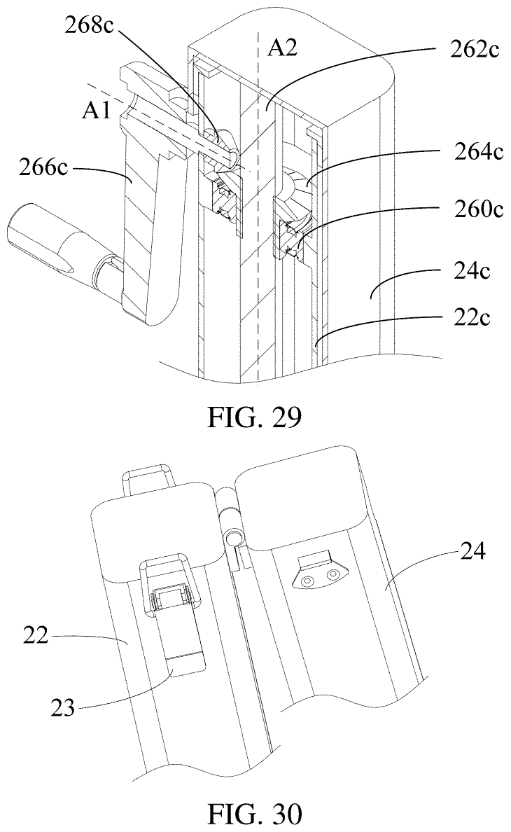

Referring to FIG. 27 to FIG. 29, in some embodiments, the stand assembly 20c includes a fixed upright rod 22c, a movable upright rod 24c and a driving mechanism 26c. One end of the fixed upright rod 22c is mounted to the base body 12. The movable upright rod 24c is sleeved from the other end of the fixed upright rod 22c onto the fixed upright rod 22c. The driving mechanism 26c passes through the movable upright rod 24c and is mounted to the fixed upright rod 22c. The driving mechanism 26c is configured to drive the movable upright rod 24c to move in a length direction of the fixed upright rod 22c relative to the fixed upright rod 22c. The beam assembly 30 is mounted to a top surface of the movable upright rod 24c. The movable upright rod 24c is provided with a guide slot 240c which is disposed along a length direction of the movable upright rod 24c.

The driving mechanism 26c includes a gear bearing 260c, a lead screw 262c, a driving gear 264c and a handle 266c. The handle 266c passes through the guide slot 240c and is slidable along the guide slot 240c. One end of the handle 266c is provided with a helical gear 268c which is engaged with the driving gear 264c. The helical gear 268c may rotate about a first rotation axis Al to drive the driving gear 264c to rotate. The driving gear 264c is sleeved on the lead screw 262c. The driving gear 264c is in thread fit with the lead screw 262c. The driving gear 264c may rotate about a second rotation axis A2 to drive the lead screw 262c to move along the second rotation axis A2. The second rotation axis Al coincides with a central axis of the lead screw 262c. The first rotation axis Al and the second rotation axis A2 are perpendicular to each other and intersect with each other. A top end of the lead screw 262c is fixed to the top of the movable upright rod 24c, configured to drive the movable upright rod 24c to move in the length direction of the fixed upright rod 22c relative to the fixed upright rod 22c. The gear bearing 260c is sleeved on the driving gear 264c and the gear bearing 260c is fixed to an inner wall of the fixed upright rod 22c. The driving gear 264c may rotate only about the second rotation axis A2 relative to the gear bearing 260c. The driving gear 264c cannot move along the second rotation axis A2 relative to the gear bearing 260c. The helical gear 268c, the gear bearing 260c, the driving gear 264c, and the lead screw 262c are all located in the fixed upright rod 22c.

The handle 266c is rotated to make the helical gear 268c rotate about the first rotation axis Al, to drive the driving gear 268b to rotate about the second rotation axis A2 relative to the gear bearing 260c. The driving gear 264c is in thread fit with the lead screw 262c. When the driving gear 264c rotates about the second rotation axis A2, it may drive the lead screw 262c to move along the second rotation axis A2, so as to drive the movable upright rod 24c to move in the length direction of the fixed upright rod 22c relative to the fixed upright rod 22c.

It may be understood that the driving mechanism may be further provided with a gear stop mechanism, such as a pawl stop apparatus, so that the movable upright rod can be stopped at a required position.

Referring to FIG. 30, in some embodiments, one end of the first upright rod 22 is detachably mounted to the base 10, and the other end is connected to one end of the second upright rod 24 through a hinged structure or the like, so that the second upright rod 24 can be folded relative to the first upright rod 22.

The stand assembly 20 further includes a buckling structure 23. The buckling structure 23 includes first buckles 232 and second buckles 234. One end of the first upright rod 22 is hinged to one of the first buckles 232, and one end of the second upright rod 24 is provided with one of the second buckles 234. The first buckles 232 and the second buckles 234 may be mutually buckled. When the second upright rod 24 is unfolded relative to the first upright rod 22, the second upright rod 24 is fastened to the first upright rod 22.

It may be understood that positions of the third buckle 52 and the fourth buckle 54 are interchangeable. That is, one end of the first upright rod 22 is provided with one of the second buckles 234, and one end of the second upright rod 24 is hinged to one of the first buckles 232, provided that one end of one of first upright rod 22 and the second upright rod 24 is hinged to one of the first buckles 232, and one end of the other is provided with one of the second buckles 234. It may be understood that according to an actual requirement, the buckling structure 23 may also be replaced with other locking structures, for example, a snap, or a screw.

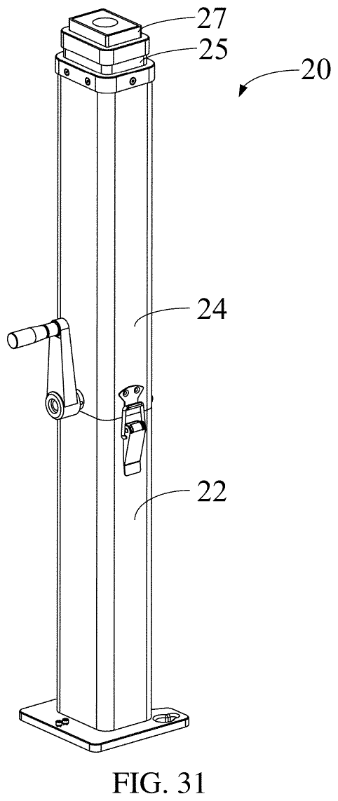

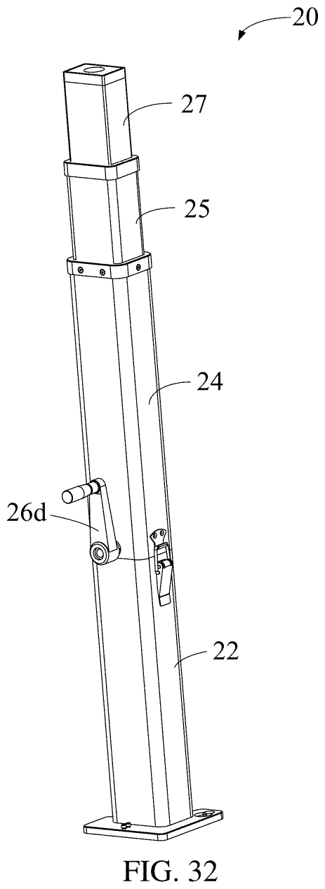

Referring to FIG. 31 and FIG. 32 together, in some embodiments, the number of the upright rods may be increased according to an actual requirement, for example, a third upright rod 25 and a fourth upright rod 27 are added. The third upright rod 25 may be nested or folded with the second upright rod 24. When the third upright rod 25 is nested with the second upright rod 24, various driving manners shown in FIG. 18 to FIG. 19 may be adopted for the driving between the third upright rod 25 and the second upright rod 24, to enable the third upright rod 25 to move in a length direction of the second upright rod 24 relative to the second upright rod 24. Similarly, the fourth upright rod 27 may be nested or folded with the third upright rod 25. When the fourth upright rod 27 is nested with the third upright rod 25, various driving manners shown in FIG. 18 to FIG. 19 may be adopted for the driving between the fourth upright rod 27 and the third upright rod 25, to enable the fourth upright rod 27 to move in a length direction of the third upright rod 25 relative to the third upright rod 25.

Referring to FIG. 32, how to drive the third upright rod 25 and the fourth upright rod 27 is described below in a case where the third upright rod 25 is nested with the second upright rod 24 and the fourth upright rod 27 is nested with the third upright rod 25. However, it should be noted that the following description is only illustrative.

The driving mechanism 26d is mounted to one end of the second upright rod 24 close to the first upright rod 22.

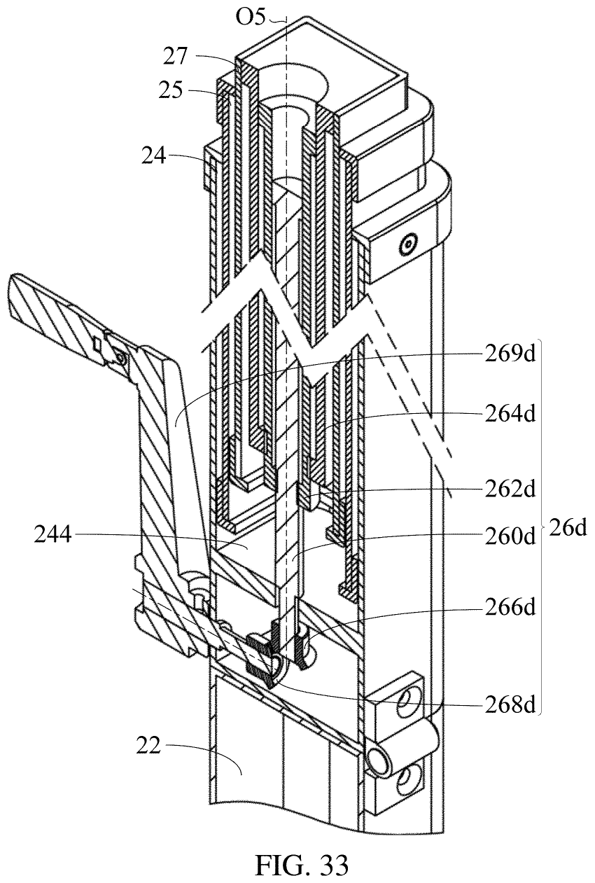

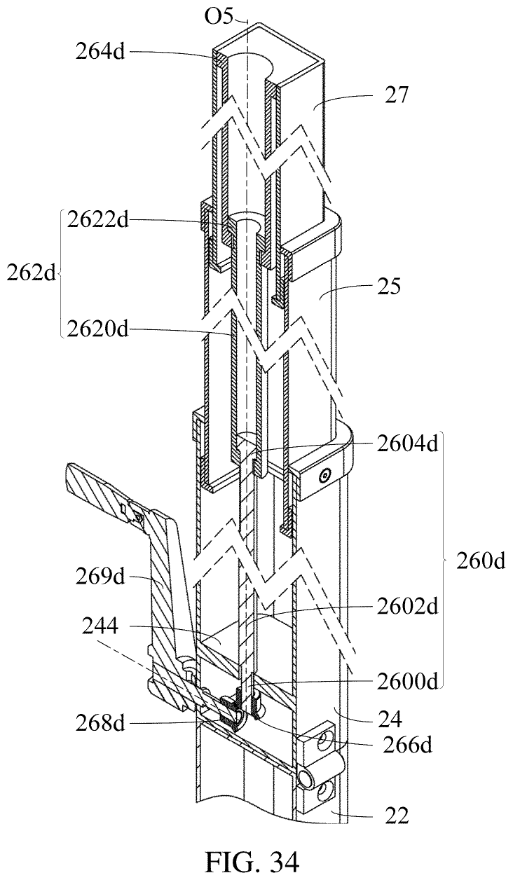

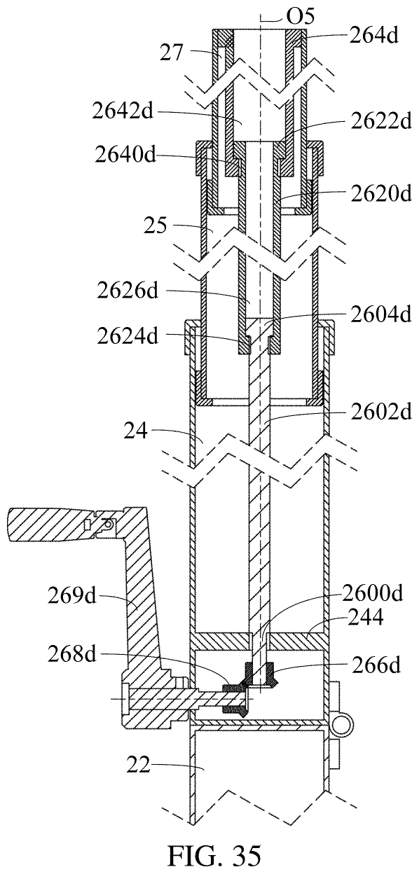

Referring to FIG. 33 to FIG. 36 together, the second upright rod 24 is provided with a first sliding slot 240 and a first snapping opening 242. The first snapping opening 242 is in communication with the first sliding slot 240. A cross-section size of the first snapping opening 242 is smaller than that of the first sliding slot 240. A tail end of the third upright rod 25 is provided with a first stopping portion 250. A cross-section size of the first stopping portion 250 is larger than that of the third upright rod 25. The first stopping portion 250 is sleeved in the first sliding slot 240. The third upright rod 25 is sleeved in the first sliding slot 240. The third upright rod 25 may be prevented from detaching from the second upright rod 24 by making the first stopping portion 250 abutting at a junction between the first sliding slot 240 and the first snapping opening 242.

In this embodiment, the third upright rod 25 is provided with a second sliding slot 252 and a second snapping opening 254. The second snapping opening 254 is in communication with the second sliding slot 252. A cross-section size of the second snapping opening 254 is smaller than that of the second sliding slot 252. The fourth upright rod 27 is provided with a second stopping portion 270. A cross-section size of the second stopping portion 270 is larger than that of the fourth upright rod 27. The second stopping portion 270 is sleeved in the second sliding slot 252. The fourth upright rod 27 is sleeved in the second snapping opening 254. The fourth upright rod 27 may be prevented from detaching from the third upright rod 25 by making the second stopping portion 270 abutting at a junction between the second sliding slot 252 and the second snapping opening 254.

The driving mechanism 26d includes a first threaded rotating member 260d, a second threaded rotating member 262d, a threaded fixing member 264d, a first helical gear 266d, a second helical gear 268d and a hand wheel 269d.

The first threaded rotating member 260d is mounted to the second upright rod 24. The first threaded rotating member 260d may rotate only about a central axis O5 relative to the second upright rod 24. The central axis O5 is basically parallel to the length direction of the second upright rod 24.

The second threaded rotating member 262d is provided with a first threaded structure (not shown in the figure) and a second threaded structure (not shown in the figure) spiraling about the central axis O5 and a spiraling direction of the first threaded structure is consistent with that of the second threaded structure. The second threaded rotating member 262d is mounted to the first threaded rotating member 260d through the first threaded structure. The second threaded rotating member 262d is mounted to the threaded fixing member 264d through the second threaded structure. The threaded fixing member 264d is fixedly mounted to the fourth upright rod 27.

The first threaded rotating member 260d rotates relative to the second upright rod 24 to drive the second threaded rotating member 262d to rotate relative to one of the first threaded rotating member 260d and the threaded fixing member 264d. That is, in a case where the first threaded rotating member 260d rotates relative to the second upright rod 24 and the second threaded rotating member 262d is static relative to the first threaded rotating member 260d, the threaded fixing member 264d moves relative to the third threaded rotating member 260d and the second threaded rotating member 262d. In another case where the first threaded rotating member 260d rotates relative to the second upright rod 24 and the second threaded rotating member 262d is static relative to the threaded fixing member 264d, the second threaded rotating member 262d and the threaded fixing member 264d both move relative to the first threaded rotating member 260d. In actual use, the above two cases may alternate when the first threaded rotating member 260d continuously rotates relative to the second upright rod 24. The first threaded rotating member 260d, the second threaded rotating member 262d and the threaded fixing member 264d jointly drive the fourth upright rod 27 to move relative to the second upright rod 24. On the one hand, during the movement of the fourth upright rod 27 toward the second upright rod 24, since the second threaded rotating member 262d may also move toward the second upright rod 24, the second threaded rotating member 262d being disposed in a rod member neither limits the stroke of the fourth upright rod 27 nor protrudes beyond the fourth upright rod 27, thereby making the stand assembly easier to carry. On the other hand, since the three are all connected by thread, the driving mechanism 26d may be self-locked after the fourth upright rod 27 moves relative to the second upright rod 24 to a specified position.

The first threaded rotating member 260d includes a first journal portion 2600d, a first screw portion 2602d, and a first limiting portion 2604d. The first journal portion 2600d is disposed at one end of the first screw portion 2602d, and the first limiting portion 2604d is disposed at the other end of the first screw portion 2602d. A cross-section size of the first journal portion 2600d is smaller than that of the first screw portion 2602d and the cross-section size of the first screw portion 2602d is smaller than that of the first limiting portion 2604d.

The second upright rod 24 is provided with a mounting separator plate 244, which is basically horizontal. The first journal portion 2600d is sleeved on the mounting separator plate 244. Since the first threaded rotating member 260d, the second threaded rotating member 262d and the threaded fixing member 264d are connected by thread, the first screw portion 2602d is held against the mounting separator plate 244, so that the first threaded rotating member 260d can rotate only about the central axis O5 relative to the second upright rod 24. In addition, the mounting separator plate 244 may limit the first threaded rotating member 260d. When the first threaded rotating member 260d rotates to hold the second threaded rotating member 262d against the mounting separator plate 244, the first threaded rotating member 260d continuously rotates while the second threaded rotating member 262d keeps static with the first threaded rotating member 260d. The threaded fixing member 264d is moved toward the second upright rod 24 until the threaded fixing member 264d is also held against the mounting separator plate 244. In this case, the first threaded rotating member 260d cannot continuously rotate.

In some other embodiments, the second threaded rotating member 262d is disposed inside the first threaded rotating member 260d, and the first threaded structure is disposed outside the second threaded rotating member 262d.

In this embodiment, the first threaded rotating member 260d is sleeved inside the second threaded rotating member 262d, and the first threaded structure is disposed inside the second threaded structure 262.

The second threaded rotating member 262d includes a second screw portion 2620d and a second limiting portion 2622d. The second limiting portion 2622d is disposed at one end of the second screw portion 2620d. A cross-section size of the second screw portion 2620d is smaller than that of the second limiting portion 2622d. The second screw portion 2620d is provided with a first screw hole 2624d and a first receiving slot 2626d. The first receiving slot 2626d is located above the first screw hole 2624d and the first screw hole 2624d is in communication with the first receiving slot 2626d. Moreover, a cross-section size of the first screw hole 2624d is smaller than that of the first receiving slot 2626d. The first threaded structure is disposed on a hole wall of the first screw hole 2624d.

The first screw portion 2602d passes through and is sleeved in the first screw hole 2624d. The first limiting portion 2604d is received in the first receiving slot 2626d. By disposing the first limiting portion 2604d at a tail end of the first screw portion 2602d, during the rotation of the first threaded rotating member 260d, when the second threaded rotating member 262d is movable until the first limiting portion 2604d is held against a junction between the first screw hole 2624d and the first receiving slot 2626d, the first threaded rotating member 260d continuously rotates while the second threaded rotating member 262d keeps static relative to the first threaded rotating member 260d. The threaded fixing member 264d moves away from the second upright rod 24.

In some other embodiments, the threaded fixing member 264d is sleeved inside the second threaded rotating member 262d, and the second threaded structure is disposed inside the second threaded rotating member 262d.

In this embodiment, the second threaded rotating member 262d is sleeved inside the threaded fixing member 264d, and the second threaded structure is disposed outside the second threaded rotating member 262d.

The threaded fixing member 264d is provided with a second screw hole 2640d and a second receiving hole 2642d. The second receiving hole 2642d is located above the second screw hole 2640d, and the second screw hole 2640d is in communication with the second receiving hole 2642d. A cross-section size of the second screw hole 2640d is smaller than that of the second receiving hole 2642d. The second threaded structure is disposed on a hole wall of the second screw hole 2640d.

The second screw portion 2620d passes through and is sleeved inside the second screw hole 2640d. The second limiting portion 2622d is received in the second receiving slot 2642d. By disposing the second limiting portion 2622d at the tail end of the second screw portion 2620d, during the rotation of the first threaded rotating member 260d, when the second threaded rotating member 262d is movable until the second limiting portion 2622d is held against a junction between the second screw hole 2640d and the second receiving slot 2642d, the first threaded rotating member 260d continuously rotates while the second threaded rotating member 262d keeps static with the threaded fixing member 264d. The second threaded rotating member 262d and the threaded fixing member 264d move together away from the second upright rod 24.

One end of the first journal portion 2600d is connected to the first screw portion 2602d. The first helical gear 266d is fixedly mounted to the other end of the first journal portion 2600d. A rotation axis of the first helical gear 266d coincides with the central axis O5. The first helical gear 266d and the first screw portion 2602d may rotate together.

The second helical gear 268d is mounted to the second upright rod 24. The second helical gear 268d may rotate about its rotation axis relative to the second upright rod 24. A rotation axis of the second helical gear 268d is perpendicular to the central axis O5.

The hand wheel 269d is fixedly mounted to the second helical gear 268d. The hand wheel 269d and the second helical gear 268d may rotate together. The first threaded rotating member 260d may be driven through the hand wheel 269d to rotate.

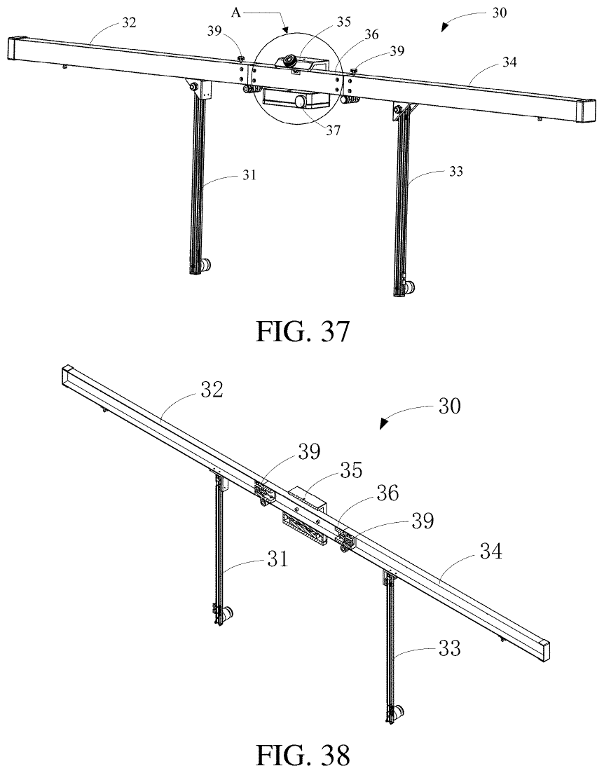

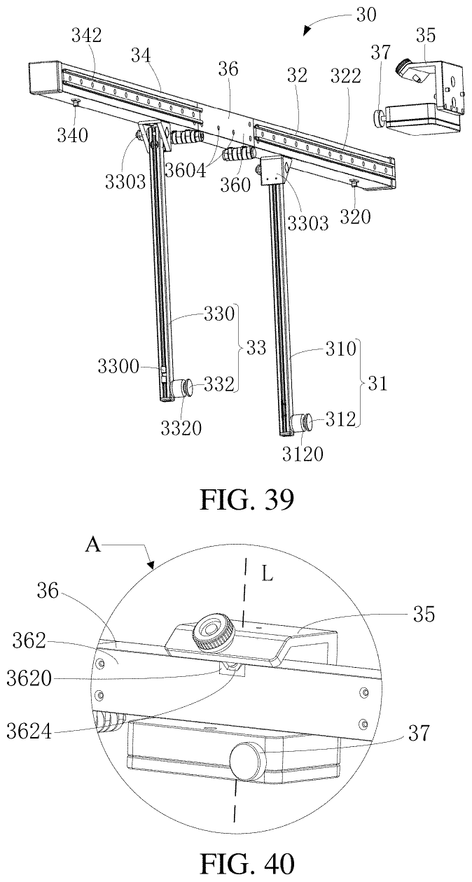

Referring to FIG. 37, FIG. 38 and FIG. 39, the beam assembly 30 includes a first supporting rod 31, the left beam portion 32, a second supporting rod 33, the right beam portion 34, a mounting base 35, the connecting portion 36, an adjusting mechanism 37 and a joint mechanism 39. The first supporting rod 31 and the second supporting rod 33 have a function of lifting a target to prevent it from falling, especially when the target is large in area and heavy in weight.

One end of the first supporting rod 31 may be pivotably connected to the left beam portion 32 through a hinged mechanism, a hinge mechanism or the like. The first supporting rod 31 may rotate relative to the left beam portion 32 to unfold to be perpendicular to the left beam portion 32, or may be snapped to the left beam portion 32 and parallel to the left beam portion 32.

The first supporting rod 31 includes a first supporting rod body 310 and a first supporting member 312. One end of the first supporting rod body 310 is hinged to the left beam portion 32, and the other end of the first supporting rod body 310 is mounted to the first supporting member 312. The first supporting member 312 is substantially cylindrical, and is perpendicular to the first supporting rod body 310. An outer wall of the first supporting member 312 is provided with an annular first positioning mechanism 3120. The first positioning mechanism 3120 may be a positioning structure such as a slot or a bump. A side wall of the first supporting rod body 310 is provided with a first slot (not shown in the figure).

Similarly, one end of the second supporting rod 33 may be hinged to the right beam portion 34 through a hinged mechanism, a hinge mechanism or the like. The second supporting rod 33 may rotate relative to the right beam portion 34 to unfold to be perpendicular to the right beam portion 34, or may be snapped to the right beam portion 34 and parallel to the right beam portion 34. The second supporting rod 33 includes a second supporting rod body 330 and a second supporting member 332. One end of the second supporting rod body 330 is hinged to the right beam portion 34, and the other end of the second supporting rod body 330 is mounted to the second supporting member 332. The second supporting member 332 is substantially cylindrical, and is perpendicular to the second supporting rod body 330. An outer wall of the second supporting member 332 is provided with an annular second positioning mechanism 3320. The second positioning mechanism 3320 may be a positioning structure such as a slot or a bump. The first positioning mechanism 3120 and the second positioning mechanism 3320 are located in the same plane. A side wall of the second supporting rod body 330 is provided with a second slot 3300. The first supporting member 312 and the second supporting member 332 extend in the same direction. When the first supporting rod 31 unfolds to be perpendicular to the left beam portion 32, and the second supporting rod 33 unfolds to be perpendicular to the right beam portion 34, the first slot and the second slot 3300 are disposed away from each other. The first supporting member 312 and the second supporting member 332 may be configured to jointly support a calibration element, for example, a large target plate (generally a large pattern plate).

The left beam portion 32 is provided with a first fixture block 320 and a first guide rail 322. The first fixture block 320 and the first supporting rod 31 are both connected to the same side of the left beam portion 32. When the first supporting rod 31 rotates to be parallel to the left beam portion 32, the first fixture block 320 is stuck into the first slot to clamp the first supporting rod 31 to the left beam portion 32. The first guide rail 322 is disposed on the other side of the left beam portion 32. The first guide rail 322 is disposed in parallel with the left beam portion 32. The first guide rail 322 is configured to mount a holder to mount calibration elements, for example, mount a calibration target, a reflector, and a laser. The holder may slide along the first guide rail 322.

Similarly, the right beam portion 34 is provided with a second fixture block 340 and a second guide rail 342. The second fixture block 340 and the second supporting rod 33 are both connected to the same side of the right beam portion 34. When the second supporting rod 33 rotates to be parallel to the right beam portion 34, the second fixture block 340 is stuck into the second slot 3300 to clamp the second supporting rod 33 to the right beam portion 34. The second guide rail 342 is disposed on the other side of the right beam portion 34. The second guide rail 342 is disposed in parallel with the right beam portion 34. The second guide rail 342 is configured to mount a holder to mount calibration elements, for example, mount a reflector and the like. The holder may slide along the second guide rail 342. The first guide rail 322 and the second guide rail 342 are symmetrically disposed relative to the connecting portion 36, and the left beam portion 32 and the right beam portion 34 are also symmetrically disposed relative to the connecting portion 36. When the base 10 is placed on a horizontal plane, the first guide rail 322, the second guide rail 342, the left beam portion 32, and the right beam portion 34 are all horizontally disposed. The first positioning mechanism 3120 and the second positioning mechanism 3320 are located on the same vertical plane to jointly clamp a bottom end of the target plate.

It may be understood that in some other embodiments, positions of the first fixture block 320 and the first slot are interchangeable. That is, the first fixture block 320 is mounted to the first supporting rod body 310, and the first slot is disposed on the left beam portion 32. Similarly, positions of the second fixture block 340 and the second slot 3300 are also interchangeable. That is, the second fixture block 340 is mounted to the second supporting rod body 330, and the second slot 3300 is disposed on the right beam portion 34. Optionally, the first slot and the second slot 3300 are concavely disposed on the corresponding beam portions.

It may be understood that in some other embodiments, the first guide rail 322 and the second guide rail 342 may be disposed on other surfaces of the beam, for example, a top surface. In some other embodiments, the first guide rail 322 and the second guide rail 342 are not needed. The calibration element may be directly hung on the beam by using a hook or the like. The first guide rail 322 and the second guide rail 342 may also be in other forms and are not limited to those as shown. For example, they may be one or more recess lines disposed on the top surface of the beam. Moreover, the recess lines can be formed using outer walls of the beam itself without the need to mount additional guide rails.

It may be understood that the number of the supporting rod is not limited by the above embodiment. For example, there may be only one mount which is disposed in a substantially central position of the connecting portion 36. In this case, a target substantially in the middle of the beam assembly 30 may also be well lifted. When a target for calibration is at another position, the supporting rod may also be disposed in a corresponding position for lifting. The number of the supporting rods may also be greater than two. In addition, the supporting rod may also be disposed on a mount guide rail (not shown in the figure). the supporting rod guide rail is disposed on a side surface or a bottom surface of the beam assembly 30. In this way, the supporting rod may move along the assembled beam assembly 30 to lift the target that may be at different positions at a suitable position.

It may be understood that when a guide rail is used to make the supporting rod movable, the supporting rod may also be clamped to the beam assembly 30 by using a fixture block or a slot. A support 3303 (see FIG. 39) for positioning may also be retained on the guide rail.

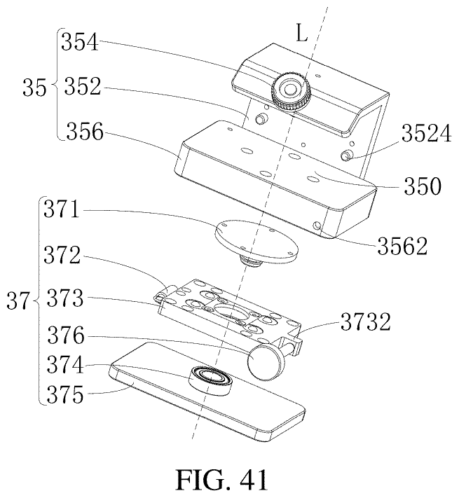

The connecting portion 36 of the beam is sleeved inside the mounting base 35, a first surface 360 of the connecting portion 36 is concavely provided with a limiting hole 3604. The number of the limiting hole 3604 is preferably two. The two limiting holes 3604 are disposed in a length direction of the connecting portion 36. Correspondingly, a limiting mechanism adapted to the limiting hole 3604, for example, a limiting post 3524 (see FIG. 41), is disposed at a corresponding position of the mounting base 35. In addition, the connecting portion 36 and the mounting base 35 may also be provided with limiting structures in other forms. For example, a limiting open slot 3564 is disposed on the mounting base 35, and a limiting mechanism (not shown in the figure) adapted to the connecting portion 36 is disposed at a corresponding position of the connecting portion 36, to more conveniently and accurately place the connecting portion 36 of the beam at a preset position of the mounting base 35.

Referring to FIG. 40, the connecting portion 36 is provided with a fixing slot 3620. The fixing slot 3620 is provided with a fixing surface 3624. The fixing slot 3620 is used in conjunction with a fixing rod 354 in FIG. 18 to fix the beam assembly to the mounting base 35. Optionally, the fixing slot 3620 is disposed so that the fixing surface 3624 is at an angle with a bottom surface of the mounting base 35. Advantages of such setting are illustrated with reference to the fixing rod 354 in FIG. 17. For example, the fixing slot 3620 may be disposed between a second surface 362 and the top surface of the beam. The second surface 362 is disposed in parallel with the first surface 360. The fixing surface 3624 is at an angle with the first surface 360 and the second surface 362. For example, the fixing surface 3624 is at 45 degrees with the first surface 360 and the second surface 362.

In this embodiment, the left beam portion 32, the right beam portion 34 and the connecting portion 36 are all square tubes, which may reduce the weight of the calibration bracket 100 and make the connecting portion 36 easy to be firmly sleeved inside the adjusting mechanism 38. It may be understood that in some other embodiments, the left beam portion 32, the right beam portion 34 and the connecting portion 36 may also be pipes in other shapes, profiled materials, rods or the like. For example, they may be polygonal or circular pipes or rods. When the beam is a pipe in another shape, the fixing slot 3620 may be disposed at a position that enables the fixing surface 3624 and the bottom surface of the mounting base 35 to form an angle.

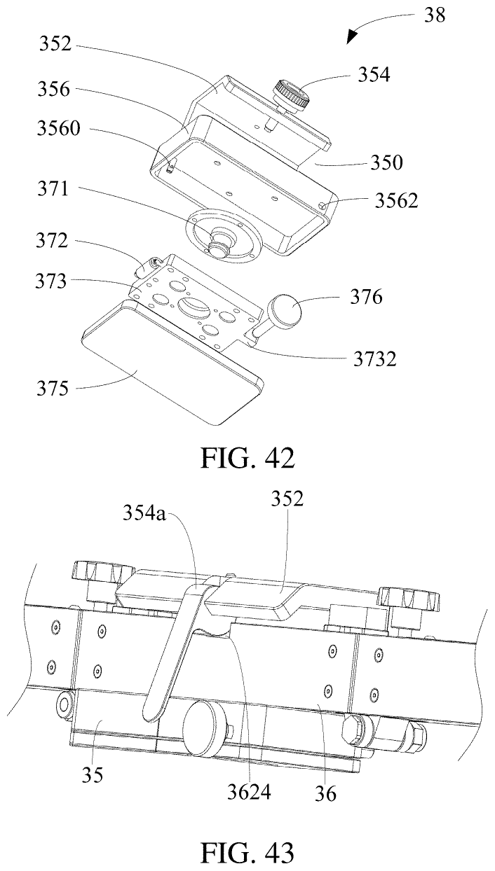

Referring to FIG. 41 and FIG. 42, the mounting base 35 is configured to sleeve the connecting portion 36. The mounting base 35 includes a retainer 352, a fixing rod 354 and a mounting shell 356.

Optionally, the mounting base 35 may be disposed on the adjusting mechanism 37. In this case, the mounting base 35 may rotate, under the adjustment of the adjusting mechanism 37, about an adjustment rotation axis L relative to the stand assembly 20 to adjust horizontal angles of the mounting base 35 and the beam assembly 30. Preferably, the adjusting mechanism 37 is disposed in an upper and lower relation with the mounting base to facilitate removal and mounting of the beam from an upper part while adjustment of the horizontal angle is achieved. The adjustment rotation axis L is disposed in parallel with the fixed upright rod 22 and the movable upright rod 24. That is, when the calibration bracket 100 is placed on a horizontal plane, the adjustment rotation axis L is vertically disposed. The mounting base 35 is provided with a notch 350, which is configured to facilitate placing of the connecting portion 36 in the mounting base 35 or removal of the connecting portion 36 from the mounting base 35.

The retainer 352 is roughly hook-like to facilitate retaining of the connecting portion 36. One end of the retainer 352 is fixedly connected to the mounting shell 356, for example, is mounted to an upper surface or a side surface of the mounting shell 356. The other end surrounds and holds the connecting portion 36 of the beam assembly 20, leaving the notch 350. For example, the retainer 352 may be in the shape shown in FIG. 18, and may also be certainly in another shape, for example, a ring hook, another polygonal hook, or a hook that combines a ring with a polygon, provided that the connecting portion 36 can be stably held. The “roughly hook-like” herein means that the retainer 352 can extend a certain length from a certain angle, so as to support and hold the connecting portion 36.

The retainer 352 and the mounting shell 356 form, in an enclosing manner, a mounting channel, which is used to receive the connecting portion 36. The mounting channel is in communication with the notch 350. An inner surface of the retainer 352 is provided with a limiting post 3524. Two limiting posts 3524 are located in the mounting channel and are used for insertion into two limit holes 3604 (see FIG. 37) to facilitate the positioning of the connecting portion 36 in the mounting channel. The function of the limiting hole 3604 is to further reduce any horizontal displacement of the beam assembly 20 relative to the mounting base 35 during calibration. The limiting post 3524 may also be disposed on the upper surface of the mounting shell 356 or disposed on both the upper surface of the mounting shell 356 and the inner surface of the retainer 352. The “limiting post” herein includes circular, square and elongated limiting posts. The “limiting hole” includes circular, square and elongated limiting holes. When the limiting post and the limiting hole are substantially dotted, there are preferably at least two limiting posts 3524 in a length direction of the connecting portion 36 to ensure that the connecting portion 36 does not shift in its length direction. When the limiting post and the limiting hole are substantially elongated, only one pair of limiting post and limiting hole can be used. It may be understood that in some other embodiments, positions of the limiting hole 3604 and the limiting post 3524 are interchangeable. That is, the limiting hole 3604 is provided with the retainer 352 and is in communication with the mounting channel and the limiting post 3524 is disposed on the first surface 360 (see FIG. 39).

Optionally, the fixing rod 354 is disposed on the retainer 352, includes a knob and at least one screw, and is in thread fit with the retainer 352. When the connecting portion 36 is sleeved on the mounting base 35, a central axis of the fixing rod 354 is perpendicular to the fixed surface 3624 at the connecting portion 36 of the beam. The fixing rod 354 is rotated so that the fixing rod 354 can abut against the fixing surface 3624 to fix the connecting portion 36 of the beam assembly 30 to the mounting base 35. Alternatively, the fixing rod 354 is rotated so that the fixing rod 354 can detach from the fixing surface 3624 and the connecting portion 36 can be removed from the mounting base 35 through the notch 350.

Optionally, the fixed surface 3624 is at an angle with the bottom surface (that is, the horizontal plane) of the mounting base 35 and the fixing rod 354 is at an angle with the bottom surface of the mounting base 35. The angle is greater than 0 degrees and less than 90 degrees. Optionally, the angle is roughly 45 degrees. In such a setting manner, a force for compressing the connecting portion 36 toward the bottom surface and a side surface of the mounting base can be applied to the connecting portion 36 by using only one fixing rod 354. The side surface is a side surface opposite to an extension direction of the fixing rod 354. Accordingly, the fixing base can fix the connecting portion 36 with high stability and the beam assembly can be easily disassembled and assembled.

It may be understand that the mounting base 35 may be otherwise constructed. For example, a notch may not be retained and after the connecting portion 36 is placed in the mounting base 35, the notch is blocked using a baffle. The connecting portion 36 may also be mounted in other manners. For example, the mounting base 35 may be a complete ring structure with no notch for placing the beam. In this case, the beam can be first assembled and then inserted into the mounting base 35 and then the beam can be screwed and fixed by using the fixing rod 354.

It may be understood that the bottom surface or the side surface of the mounting base 35 to which the connecting portion 36 is compressed may be circular or in other irregular shapes. In this case, the connecting portion 36 may also be compressed on the surfaces by using the fixing rod 354. In this case, the fixing rod may be in line contact rather than in surface contact with the surfaces, which may not affect the compression effect.

Optionally, when the mounting base 35 includes a notch 350, a surface of the mounting base 35 away from the notch 350 may be further used to mount a calibration element, for example, a multi-line laser 200 (see FIG. 1 and FIG. 5) or the like. The multi-line laser 200 and the recess 122 on the base 12 are located on the same side of the mounting base 35 away from the surface of the notch 350.

The mounting shell 356 is roughly a cube with an opening on one side. The adjusting mechanism 37 is disposed in the opening of the mounting shell 356. The mounting shell 356 is provided with a threaded hole 3562. A mounting post 3560 is disposed in the mounting shell 356. The adjusting mechanism 37 includes a supporting shaft 371, a first elastic member 372, a rotating member 373, a bearing block 374, a base 375 and an adjusting rod 376. The adjusting mechanism 37 is configured to adjust a horizontal angle (that is, a yaw angle) of the beam assembly 20.

The supporting shaft 371 is received in the mounting shell 356 and is fixedly mounted to an inner wall of the mounting shell 356. A central axis of the supporting shaft 371 coincides with the adjustment rotation axis L.

One end of the first elastic member 372 is fixed to the mounting post 3560 and the other end of the first elastic member 372 is fixed to the rotating member 373. In this embodiment, the first elastic member 372 is a tension spring.

The rotating member 373 is roughly a cube with a projection 3732 at one end. The projection 3732 and the first elastic member 372 are located on two opposite sides of the rotating member 373 respectively. The rotating member 373 is sleeved on the bearing block 374.

The bearing block 374 is fixedly mounted to a surface of the base 375. A central axis of the bearing block 374 coincides with the adjustment rotation axis L. The rotating member 373 is fixedly mounted to the base 375 and is sleeved on the bearing block 374. One end of the supporting shaft 371 is inserted into the bearing block 374, so that the supporting shaft 371 and the mounting shell 356 may rotate together about the adjustment rotation axis L relative to the rotating member 373, the bearing block 374, and the base 375.

The base 375 is configured to be mounted to the movable upright rod 24. The movable upright rod 24 may drive the base 375 to ascend or descend. In this embodiment, the base 375 is a cube and the base 375 covers the opening of the mounting shell 356. The supporting shaft 371, the first elastic member 372 and the rotating member 373 are all received in a cavity enclosed by the mounting shell 356 and the base 375.

The “cube” described in this specification includes a sheet.

The adjusting rod 376 is mounted in the threaded hole 3562. The adjusting rod 376 is rotated so that the adjusting rod 376 abuts against the projection 3732 to drive the mounting base 35 to rotate about the adjustment rotation axis L relative to the rotating member 373 and the base 375, so as to adjust horizontal angles of the mounting base 35 and the connecting portion 36. The first elastic member 372 is stretched. The adjusting rod 376 is rotated in an opposite rotation direction. The mounting base 35 is pulled through the first elastic member 372 to rotate about the adjustment rotation axis L relative to the rotating member 373 and the base 375 for resetting.

It may be understood that in some other embodiments, the base 375 may be omitted. The rotating member 373 and the bearing block 374 may be directly fixedly mounted to the top surface of the movable upright rod 24.

It may be understood that the adjusting mechanism 37 may be selectively used. When the adjusting mechanism 37 is canceled, the mounting shell 356 of the mounting base 35 may be canceled. The retainer 352 is mounted onto the top surface of the movable upright rod 24 or other additional mounting surfaces. It should be understood that the retainer 352 may extend to form a bottom surface and surround a lower surface of the connecting portion 36 of the beam assembly 30. That is, the retainer 352 may have a bottom surface. The bottom surface is mounted on the mounting shell 356.

It may be understood that other fixing mechanisms may also be adopted to simultaneously compress the connecting portion 36 onto the bottom surface and a side surface of the mounting base 35. For example, in some embodiments, a cam handle 354a as shown in FIG. 43 may be used. The cam handle 354a is mounted to the retainer 352, and the cam handle 354a may rotate relative to the retainer 352 to make the cam handle 354a abut against the fixing surface 3624, so that the cam handle 354a compresses the connecting portion 36 onto the bottom surface and a side surface of the mounting base 35, or to make the cam handle 354a detach from the fixing surface 3624, so that the connecting portion 36 can be removed from the mounting base 35.

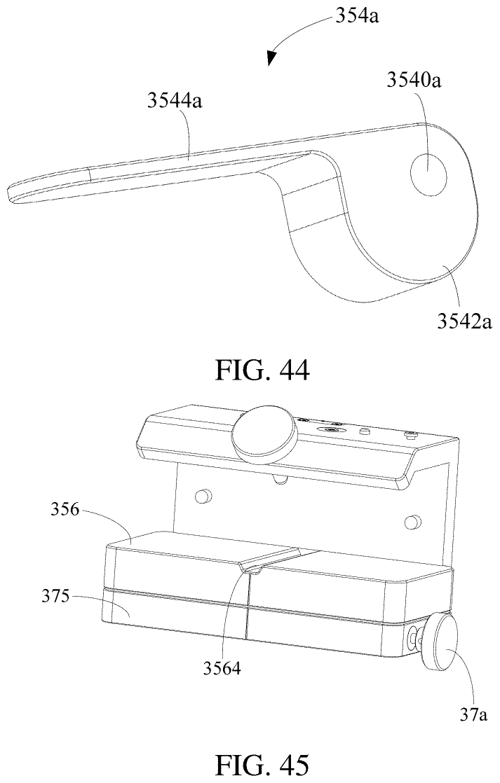

Referring to FIG. 44, the cam handle 354a includes a cam portion 3542a and a handle portion 3544a. The handle portion 3544a is connected to one end of the cam portion 3542a. The cam portion 3542a is provided with a shaft hole 3540a. A rotating shaft passes through the shaft hole 3540a and two ends of the rotating shaft are fixed to the retainer 352, so that the cam handle 354a can rotate about the rotating shaft. The cam portion 3542a is a disk cam, which is a disk component rotating about the rotating shaft and having a changing diameter, and may rotate in a first rotation direction about the rotating shaft to abut against the fixing surface 3624 or may rotate in a second rotation direction about the rotating shaft to detach from the fixing surface 3624. The first rotation direction is opposite to the second rotation direction.

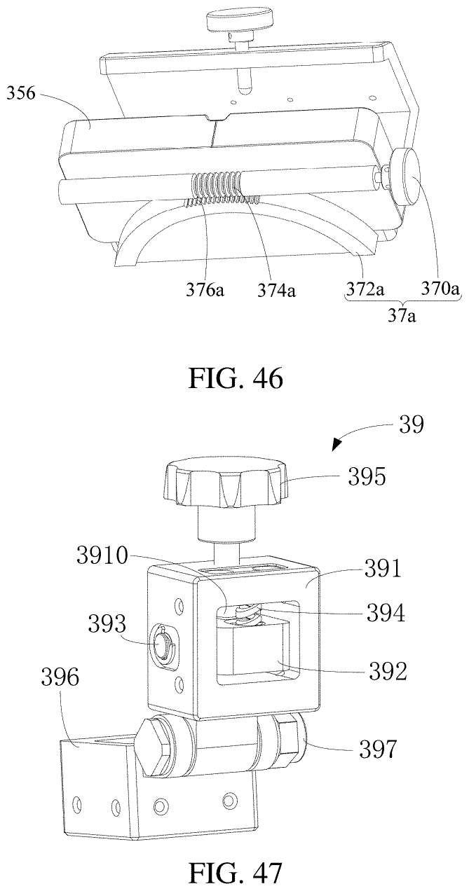

Referring to FIG. 45 and FIG. 46 together, in some embodiments, the adjusting mechanism 37a includes an adjusting worm 370a and an adjusting worm wheel 372a. The adjusting worm 370a passes through the base 375. The adjusting worm 370a is mounted to the base 375 and may rotate about its central axis relative to the base 375. The adjusting worm 370a includes a worm thread 374a. The adjusting worm wheel 372a is fixed to the mounting shell 356 and is located in the cavity enclosed by the mounting shell 356 and the base 375. The adjusting worm wheel 372a includes a worm wheel tooth 376a. The worm wheel tooth 376a is engaged with the worm thread 374a. When the fixed upright rod 22 and the movable upright rod 24 are both vertically disposed, the adjusting worm 370a is horizontally disposed, and a rotation centerline of the adjusting worm wheel 372a is vertically disposed.

When the adjusting worm 370a is rotated, the worm thread 374a drives the worm wheel tooth 376a to rotate, so that the adjusting worm wheel 372a rotates around its rotation centerline to drive the mounting shell 356 of the mounting base 35 to rotate, so as to adjust the horizontal angle of the beam assembly 30.

It may be understood that in some other embodiments, positions of the adjusting worm 370a and the adjusting worm wheel 372a are interchangeable. That is, the adjusting worm wheel 372a may be fixed to the base 375 and the adjusting worm 370a passes through the mounting shell 356.

Referring to FIG. 38 again, the number of the joint mechanisms 39 is two. One of the joint mechanisms 39 is connected between the left beam portion 32 and the connecting portion 36, and the other of the joint mechanisms 39 is connected between the right beam portion 34 and the connecting portion 36. In some embodiments, the joint mechanism 39 is fixed within wall tubes of the left beam portion 32, the right beam portion 34 and the connecting portion 36. In some embodiments, the joint mechanism 39 is fixed outside the wall tubes of the left beam portion 32, the right beam portion 34 and the connecting portion 36, which are connected to cross sections of the wall tubes of the left beam portion 32, the right beam portion 34 and the connecting portion 36 by, for example, clamping, screw, bonding or the like.

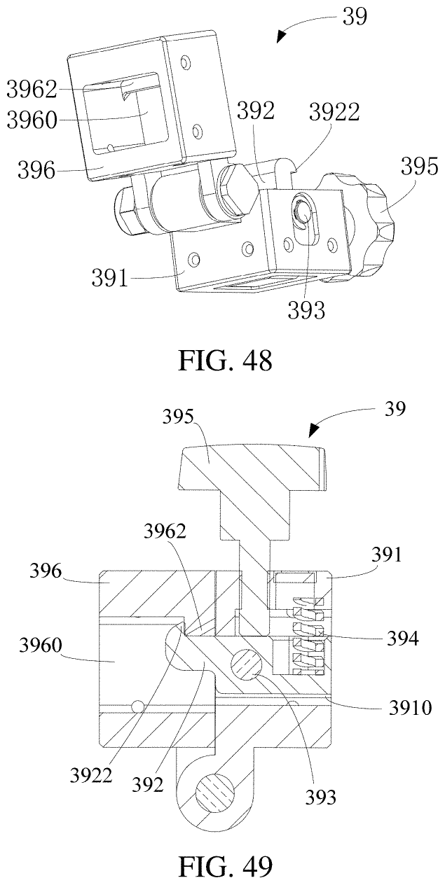

Referring to FIG. 47, FIG. 48 and FIG. 49, a first implementation of construction of the joint mechanism 39 is shown. The joint mechanism 39 includes a first fixing member 391, a second fixing member 396, a first rotating shaft 397, a snap-fitting member 392, a second rotating shaft 393, a second elastic member 394 and a tightening mechanism 395.

The first fixing member 391 and the second fixing member 396 are connected together by hinging through the first rotating shaft 397. The first fixing member 391 is substantially a cube, with one end hinged to one end of the second fixing member 396. The first fixing member 391 is provided with a first through hole 3910.

The snap-fitting member 392 is received in the first through hole 3910. The second rotating shaft 393 passes through the middle of the snap-fitting member 392. Two ends of the second rotating shaft 393 are mounted to a side wall of the first fixing member 391 respectively. The snap-fitting member 392 may rotate about the second rotating shaft 393. A hook portion 3922 extends from one end of the snap-fitting member 392. One end of the second elastic member 394 is held against the other end of the snap-fitting member 392, and the other end of the second elastic member 394 is held against an inner wall of the first fixing member 391. The second elastic member 394 is a compression spring and is configured to restore elastic deformation to drive the snap-fitting member 392 to rotate about the second rotating shaft 393.

The tightening mechanism 395 includes a knob and at least one screw. One end of the tightening mechanism 395 passes through the first fixing member 391 from the outside of the first fixing member 391 and is held against the snap-fitting member 392. The tightening mechanism 395 and the second elastic member 394 are located on the same side of a central axis of the second rotating shaft 393. The hook portion 3922 is located on the other side of the central axis of the second rotating shaft 393.

The second fixing member 396 is also substantially a cube which is provided with a second through hole 3960. An inner wall of the second through hole 3960 is provided with a snapping bulge 3962. The first fixing member 391 is fixed inside the connecting portion 36, and the second fixing member 396 is fixed inside the left beam portion 32 or the right beam portion 34, so that the left beam portion 32 or the right beam portion 34 can be snapped with the connecting portion 36.

When the first fixing member 391 and the second fixing member 396 are closed, the first fixing member 391 is in contact with the second fixing member 396, and the first through hole 3910 is in communication with the second through hole 3960. Under the push of the second elastic member 394, the hook portion 3922 is fastened to the snapping bulge 3962. The tightening mechanism 395 is rotated so that the tightening mechanism 395 compresses the snap-fitting member 392, the hook portion 3922 is further locked to the snapping bulge 3962, and the left beam portion 32 or the right beam portion 34 is stably maintained at an unfolded state relative to the connecting portion 36.

The tightening mechanism 395 is rotated to detach from the snap-fitting member 392, so that the first fixing member 391 rotates relative to the second fixing member 396 to make the hook portion 3922 detach from the snapping bulge 3962, and the first fixing member 391 detach from the second fixing member 396, so that the left beam portion 32 or the right beam portion 34 can rotate relative to the connecting portion 36 to make the beam assembly 30 folded.

In this embodiment, by means of the push of the second elastic member 394, the hook portion 3922 can be easily fastened to the snapping bulge 3962, so that the hook portion 3922 is pre-snapped with the snapping bulge 3962. Then the tightening mechanism 395 compresses the snap-fitting member 392, so that the hook portion 3922 is further locked to the snapping bulge 3962.

It may be understood that the tightening mechanism 395 may abut against other parts of the snap-fitting member 392 to make the hook portion 3922 further locked to the snapping bulge 3962, provided that a lever with the second shaft 393 as a fulcrum is impossible to rotate. For example, referring to FIG. 26, the tightening mechanism 395 may abut against the hook portion 3922 from a lower part of the hook portion 3922. In this case, the hook portion 3922 can be appropriately lengthened so that a lower part of the second fixing member 396 can be provided with a tightening mechanism 395 capable of abutting against the hook portion 3922.

It may be understood that in some other embodiments, positions of the first fixing member 391 and the second fixing member 396 are interchangeable. That is, the first fixing member 391 is fixed inside the left beam portion 32 or the right beam portion 34, and the second fixing member 396 is fixed inside the connecting portion 36.

It may be understood that the first fixing member 391 and the second fixing member 396 may also be integrally formed with an inner wall of the left beam portion 32, the right beam portion 34 or the connecting portion 36. That is, the first fixing member 391 and the second fixing member 396 may be a part of the inner wall of the left beam portion 32, the right beam portion 34 or the connecting portion 36. The first fixing member 391 and the second fixing member 396, the first fixing member 391 and the second fixing member 396 may not be connected through the first rotating shaft. The two are not connected, but outer walls of the left beam portion 32 or the right beam portion 34 and the connecting portion 36 are connected through an additional rotating shaft, which can also achieve a pivotable connection between the left beam portion 32 or the right beam portion 34 and the connecting portion 36.

It may be understood that a relative position between the second elastic member 394 and the second rotating shaft 393, and between the tightening mechanism 395 and the second rotating shaft 393 may vary, that is, the second elastic member 394 may be closer to the second rotating shaft 393 than the tightening mechanism 395, provided that the snap-fitting member 392 can lock the snapping bulge 3962.

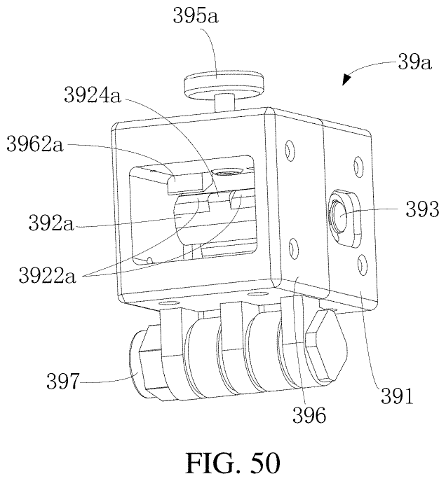

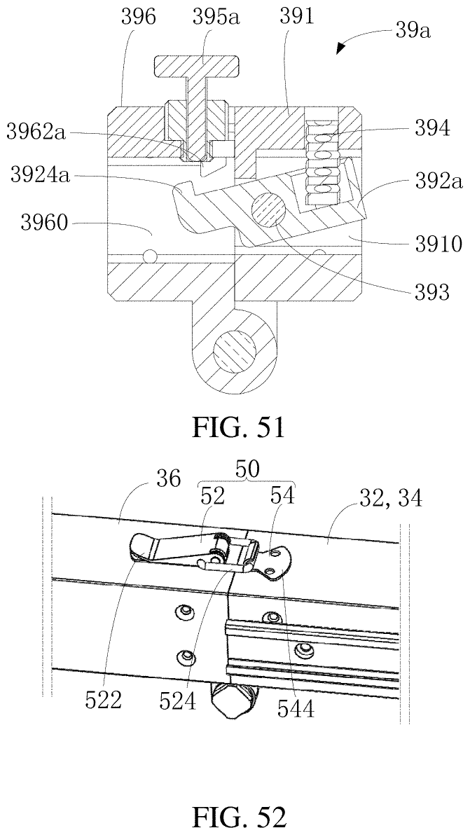

Referring to FIG. 50 and FIG. 51 together, a second implementation of construction of the joint mechanism 39a is shown. The joint mechanism 39a provided in the second implementation is basically the same as the joint mechanism 39 in the above embodiment. The difference lies in that one end of the snap-fitting member 392a is provided with hook portions 3922a and a bump 3924a. Two hook portions 3922a are located on two opposite sides of the bump 3924a. An inner wall of the second through hole 3960 is provided with snapping bulges 3962a. The number of the snapping bulges 3962a is two. The position of each of the snapping bulges 3962a corresponds to the position of a corresponding one of the hook portions 3922a. The knob 395 is replaced with a button 395a. The button 395a is mounted to the second fixing member 396. The second elastic member 394 is a compression spring, which is pressed between the first fixing member 391 and the snap-fitting member 392a.

When the first fixing member 391 and the second fixing member 396 are closed, the first fixing member 391 is in contact with the second fixing member 396, and the first through hole 3910 is in communication with the second through hole 3960. The second elastic member 394 abuts against the snap-fitting member 392a, so that the two hook portions 3922a are fastened to the two snapping bulges 3962a respectively. The first fixing member 391 and the second fixing member 396 are fastened to each other so that the left beam portion 32 or the right beam portion 34 is folded relative to the connecting portion 36.

The button 395a is pressed so that when the button 395a pushes the bump 3924a to push the snap-fitting member 392a to rotate about the second rotating shaft 393, the hook portion 3922a detaches from the snapping bulge 3962a, and the second elastic member 394 is further compressed. In this case, the first fixing member 391 may rotate relative to the second fixing member 396, so that the first fixing member 391 detaches from the second fixing member 396, and the left beam portion 32 or the right beam portion 34 may rotate relative to the connecting portion 36 to make the beam assembly 30 folded. The button 395a is lifted so that the button 395a is away from the snap-fitting member 392a. The second elastic member 394 restores elastic deformation to push the snap-fitting member 392a to rotate about the second rotating shaft 393, to fasten the hook portion 3922a to the snapping bulge 3962a.

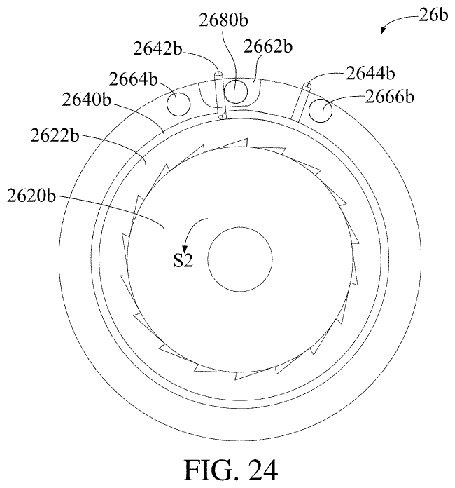

It may be understood that when the components such as the snap-fitting member and the snapping bulge in FIG. 45 to FIG. 49 are made of rigid materials with a little elasticity, a spring is not needed to provide an elastic restoring force. By adjusting the structural design, the joint structure as shown in FIG. 24 to FIG. 28 can be in a similar manner as follows: engagement between the first fixing member and the second fixing member is achieved by slight deformation of the snap-fitting member and the snapping bulge, the engagement achieved with the rigidity of the materials of the snap-fitting member and the snapping bulge may not get loose, and the loosening between the first fixing member and the second fixing member is achieved through the fact that the snap-fitting member and the snapping bulge may still deform under a large external force. In addition, the structures such as the tightening mechanism and the button may also be designed similarly.

Referring to FIG. 52, to enhance the engagement between the left beam portion 32 and the connecting portion 36 and between the right beam portion 34 and the connecting portion 36 respectively to enable the left beam portion 32 and the right beam portion 34 to mount a heavier calibration element, the beam of the calibration bracket 100 may be further provided with locking mechanisms 50, for example, buckling structures 50. One of the buckling structures 50 is connected between the left beam portion 32 and the connecting portion 36, and another of the buckling structures 50 is connected between the right beam portion 34 and the connecting portion 36.

Each of the buckling structures 50 includes a third buckle 52 and a fourth buckle 54. The connecting portion 36 is provided with the third buckle 52. One end of the third buckle 52 is hinged to the connecting portion 36. One end of the connecting portion 36 hinged to the third buckle 52 is provided with a pulling portion 522. The other end of the third buckle 52 is provided with a hook rod 524. The left beam portion 32 or the right beam portion 34 is provided with the fourth buckle 54. The fourth buckle 54 is provided with a buckling portion 544. A hinge point between the left beam portion 32 or the right beam portion 34 and the connecting portion 36 is located on one side of the connecting portion 36. The third buckle 52 and the fourth buckle 54 are located on the other side of the connecting portion 36. When the left beam portion 32 and the right beam portion 34 unfold relative to the connecting portion 36, the left beam portion 32 and the right beam portion 34 contact with the connecting portion 36 respectively, and the hook rod 524 is fastened to the buckling portion 544. When the pulling portion 522 is pulled, the hook rod 524 detaches from the buckling portion 544, and the third buckle 52 and the fourth buckle 54 may detach from each other, so that the left beam portion 32 or the right beam portion 34 may fold relative to the connecting portion 36.

It may be understood that in some other embodiments, positions of the third buckle 52 and the fourth buckle 54 are interchangeable. That is, the third buckle 52 is disposed on the left beam portion 32 or the right beam portion 34, and the fourth buckle 54 is disposed on the connecting portion 36. In some embodiments, the third buckle 52 and the fourth buckle 54 may be used in conjunction with a joint mechanism 39. In this case, the joint mechanism 39 is disposed in the inner walls of the left beam portion 32, the right beam portion 34, and the connecting portion 36. In some embodiments, the third buckle 52 and the fourth buckle 54 may be separately used. In this case, there is no joint mechanism 39 in the inner walls of the left beam portion 32, the right beam portion 34, and the connecting portion 36, and a hinge is added at a position where the left beam portion 32, the right beam portion 34, and the connecting portion 36 need to connect to each other.

It may be understood that the use of the locking mechanism such as the buckling member 50 in conjunction with the joint mechanism 39 has an advantage that the buckling member 50 may provide temporary fastening between the beam components. Since the beam of the calibration bracket 100 is generally long, the left beam portion 32 and the right beam portion 34 are generally designed to be long. Therefore, they are heavy. If the left beam portion 32 or the right beam portion 34 needs to be lifted as the locking mechanism 50 between it and the connecting portion 36 is operated, it is very inconvenient for an operator. However, the existence of the buckling member 50 solves this problem, so that the operator does not need to lift the left beam portion 32 or the right beam portion 34 and then locks the components of the beam by operating the locking mechanism to enable the two ends of the beam to bear heavier calibration elements.

It may be understood that the embodiments provided in this specification are not a unique implementation to achieve temporary engagement. For example, when the snap-fitting member or the snapping bulge in the joint mechanism is made of rigid materials with certain elasticity, the temporary engagement can be achieved without the structures such as the spring and the rotating shaft described in the embodiments. In this case, a knob may be used to press against the snap-fitting member and the snapping bulge to prevent them from falling off, or a button may be used to achieve rapid detachment between the snap-fitting member and the snapping bulge.

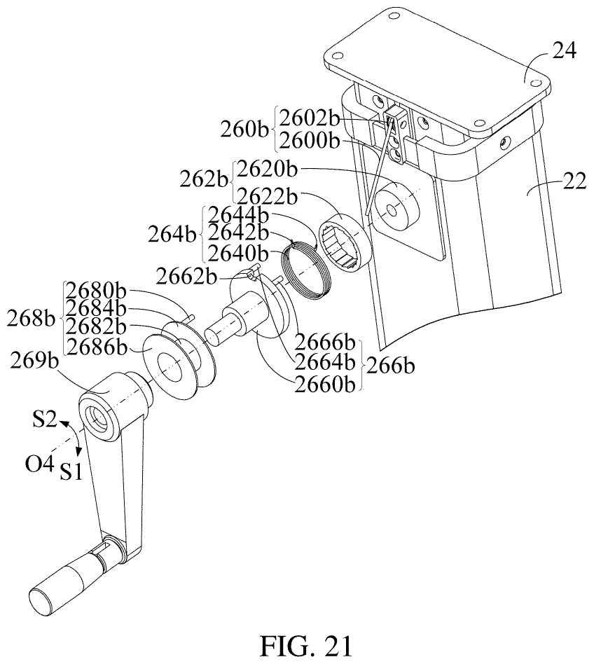

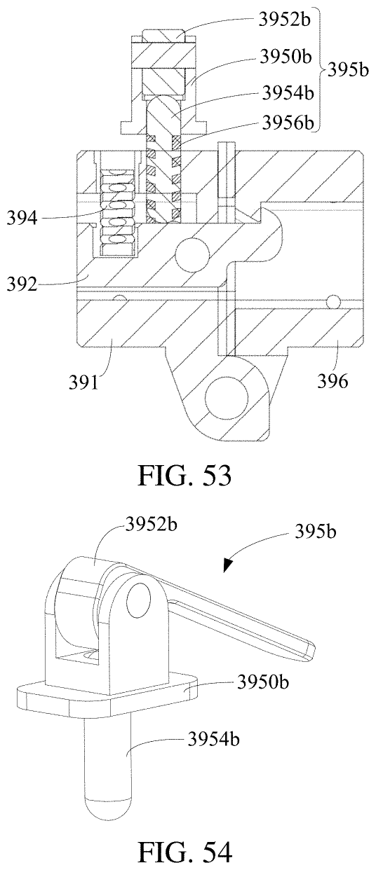

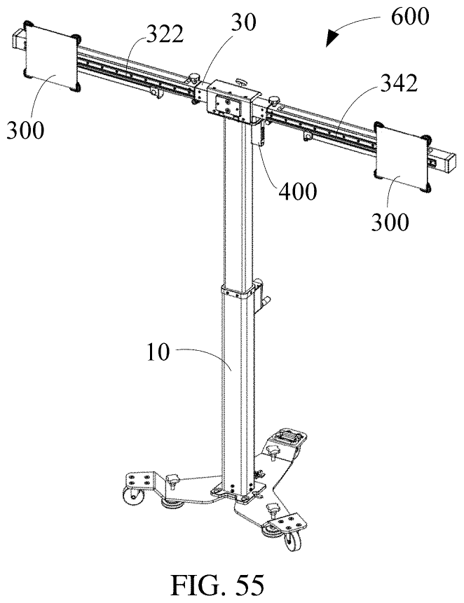

It may be understood that other locking mechanisms may also be used. For example, FIG. 53 and FIG. 54 show a locking mechanism 395b. The locking mechanism 395b includes a mounting support 3950b, a locking cam handle 3952b, a top post 3954b and a third elastic member 3956b. The mounting support 3950b is mounted to the first fixing member 391. The locking cam handle 3952b is mounted to the mounting support 3950b and the locking cam handle 3952b may rotate relative to the mounting support 3950b to drive the top post 3954b to abut against the snap-fitting member 392, so that the first fixing member 391 is fastened to the second fixing member 396. The structure of the locking cam handle 3952b is the same as that of the cam handle 354a shown in FIG. 20 and FIG. 21. The descriptions of the structure of the locking cam handle 3952b are omitted herein. The top post 3954b passes through the first fixing member 391, one end of which is used to abut the locking cam handle 3952b, and the other end is used to abut the snap-fitting member 392b. The third elastic member 3956b is a compression spring, which is sleeved on the top post 3954b. One end of the third elastic member 3956b is fixed to the top post 3954b and the other end abuts the snap-fitting member 392.

The locking cam handle 3952b is rotated to push the top post 3954b to abut against the snap-fitting member 392, so that the first fixing member 391 and the second fixing member 396 are fastened. In this case, the third elastic member 3956b is pressed. The locking cam handle 3952b is rotated in an opposite direction. The third elastic member 3956b pushes the top post 3954b to move upward to detach from the snap-fitting member 392. The first fixing member 391 and the second fixing member 396 may detach from each other.

It may be understood that in some embodiments, the button 395a in FIG. 48 and FIG. 49 may be replaced with the locking mechanism 395b.

In this embodiment, the beam assembly 30 is mounted to a top surface of the movable upright rod 24, so that the center of gravity of the beam assembly 30 is closer to the center of gravity of the stand assembly 20 compared with a calibration frame in the traditional technology. Stability of the calibration frame can be increased, and the base body 12 with a smaller area can be used. It may be understood that in some other embodiments, the beam assembly 30 may be mounted to different positions of the stand assembly 20 according to different requirements to make the beam assembly 30 located at a suitable height, which may be configured to mount lighter calibration elements such as radar absorption/reflection plates, and reflectors.

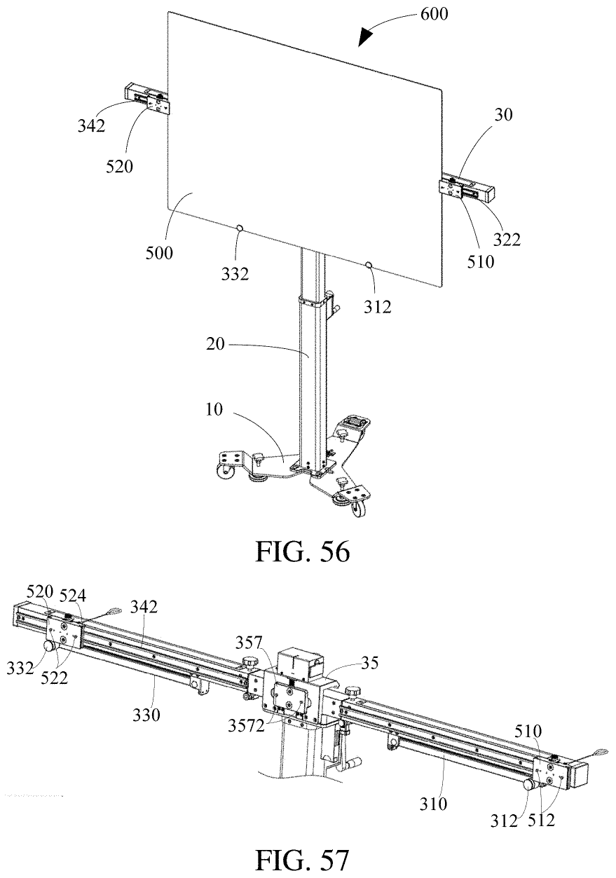

Referring to FIG. 55 and FIG. 56 together, another embodiment of the present invention further provides a calibration system 600, including a calibration element and the calibration bracket 100 provided in the above embodiment. The calibration element may be mounted to the calibration bracket 100. For example, the calibration element is a reflector 300 and a ranging apparatus 400 (see FIG. 55). The reflector 300 may be mounted to a first guide rail 322 or a second guide rail 342 through a slider or a fixed block. The slider or the fixed block is mounted to the first guide rail 322 or the second guide rail 342, and may slide with the reflector 300 along the first guide rail 322 or the second guide rail 342. The ranging apparatus 400 is fixedly mounted to the beam assembly 30. The reflector 300 may also be a target 300. Two targets are mounted onto the first guide rail 322 or the second guide rail 342 through the slider or the fixed block. The reflector or target 300 may also be directly mounted onto the beam assembly 30 in a manner such as hooking. In this case, the first guide rail 322 and the second guide rail 342 may be removed.

The ranging apparatus 400 is configured to measure a height of the beam assembly 30 above the ground, which is preferably displayed on an LCD screen of the ranging apparatus 400. In an embodiment, the ranging apparatus 400 is a laser rangefinder. The base 10 is provided with a through hole 120, which is used to make laser of the laser rangefinder 400 hit the ground, thereby measuring the height of the beam assembly 30 above the ground.

For another example, the calibration element is a pattern plate 500 (see FIG. 56), and the first supporting member 312 and the second supporting member 332 jointly lift the pattern plate 500 to prevent falling. In addition, the first guide rail 322 may be further provided with a first fixed block 510. The first fixed block 510 may slide along the first guide rail 322. The second guide rail 342 is provided with a second fixed block 520. The second fixed block 520 may slide along the second guide rail 342. The first fixed block 510 and the second fixed block 520 are located on two opposite sides of the pattern plate 500 respectively. The first fixed block 510 and the second fixed block 520 jointly clamp the pattern plate 500.

In an optional embodiment, the first fixed block 510 and the second fixed block 520 are sliders mounted with the reflector 300. An opposite side of the slider is provided with a slot to clamp the pattern plate 500 to form a fixed block. It may be understood that the first fixed block 510 and the second fixed block 520 may also be magnetic blocks, which adsorbs the pattern plate 500 from the back by magnetic adsorption to enhance firmness of the pattern plate 500 mounted on the beam assembly 30.

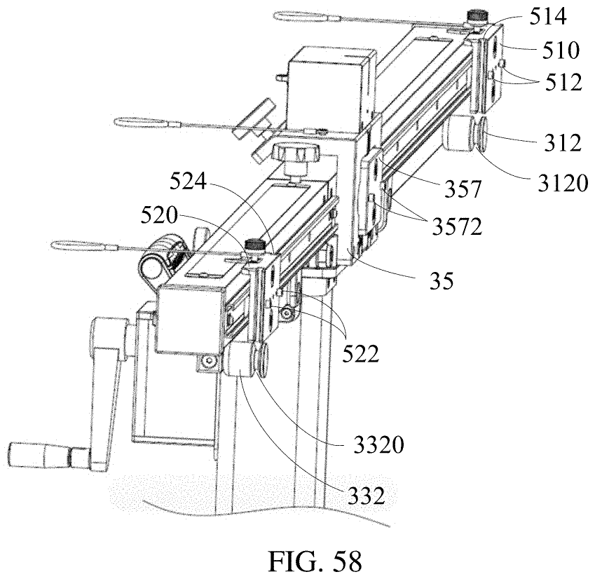

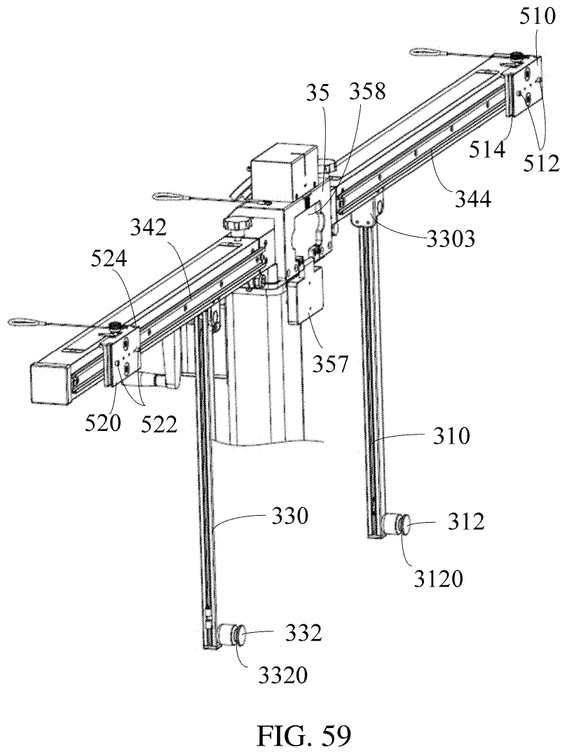

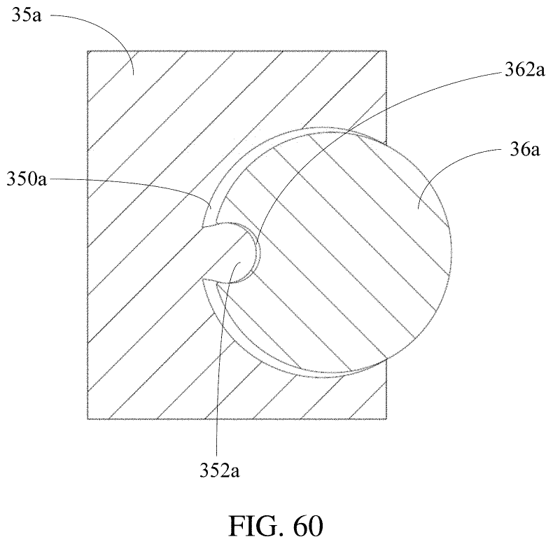

Referring to FIG. 57, FIG. 58 and FIG. 59 together, the mounting base 35 includes a backing plate 357. A bottom end of the backing plate 357 is connected to a mounting surface of the mounting base 35 through a hinge or the like. The backing plate 357 may rotate upward and downward relative to the mounting base 35. The backing plate 357 includes a mounting surface and a supporting surface disposed opposite to each other. The mounting surface of the backing plate 357 is provided with first position projections 3572. Two first position projections 3572 are disposed in a length direction of the beam.

The mounting surface of the mounting base 35 is provided with a receiving slot 358. The shape of the receiving slot 358 matches the shape of the backing plate 357 to tightly clamp the backing plate 357 in the receiving slot 358.

A mounting surface of the first fixed block 510 is provided with second positioning projections 512. Two second positioning projections 512 are disposed in the length direction of the beam. The two second positioning projections 512 are configured to accurately position the target when the target is mounted. Optionally, the first fixed block 510 is coated with or includes a magnetic material, or is provided with a magnetic element, or is a magnetic block, so as to achieve adsorptive mounting of the target. Optionally, the first fixed block 510 is provided with a third positioning mechanism 514. The third positioning mechanism 514 may be a positioning structure such as a slot or a bump.

Similarly, a mounting surface of the second fixed block 520 is provided with third positioning projections 522. Two third positioning projections 522 are disposed in the length direction of the beam. The two third positioning projections 522 are configured to accurately position the target when the target is mounted. Optionally, the second fixed block 520 is coated with or includes a magnetic material, or is provided with a magnetic element, so as to achieve adsorptive mounting of the target. Optionally, the second fixed block 520 is provided with a fourth positioning mechanism 524. The fourth positioning mechanism 524 may be a positioning structure such as a slot or a bump. The third positioning mechanism 514 and the fourth positioning mechanism 524 are disposed toward each other.

The backing plate 357 may rotate between a first position and a second position.

At the first position, the backing plate 357 is tightly clamped in the receiving slot 358. The mounting surface of the backing plate 357, the mounting surface of the mounting base 35, the mounting surface of the first fixed block 510 and the mounting surface of the second fixed block 520 face the same direction. The mounting surface of the backing plate 357 protrudes from the mounting surface of the mounting base 35 and the mounting surface of the backing plate 357, the mounting surface of the first fixed block 510 and the mounting surface of the second fixed block 520 are located in the same plane (see FIG. 56). When a vehicle-mounted element is calibrated, the backing plate 357, the first fixed block 510, and the second fixed block 520 may be configured to mount one calibration element respectively. In this case, their mounting surfaces are located in the same plane, which means that surfaces for calibration of the calibration elements (assuming that they are designed with the same thickness) mounted on them respectively are located in the same plane. Preferably, the mounting surface of the backing plate 357, the mounting surface of the first fixed block 510 and the mounting surface of the second fixed block 520 are provided with positioning structures, which are configured to accurately mount the calibration elements at predetermined positions of the mounting surfaces, for example, the first positioning projection 3572, the second positioning projection 512, and the third positioning projection 522. In this case, the backing plate 357, the first fixed block 510 and the second fixed block 520 may be separately configured to mount a small lighter calibration element, for example, a reflector, or a small pattern plate (see FIG. 53). Optionally, the back of the calibration element may be provided with a positioning structure adapted to the positioning structure on the above mounting surface, such as a limiting hole (not shown in the figure). The first positioning projection 3572, the second positioning projection 512, or the third positioning projection 522 may be inserted into the limiting hole to achieve positioning. Optionally, the first positioning projection 3572, the second positioning projection 512, or the third positioning projection 522 may be magnetic to enhance adsorption of the calibration element.

At the second position, the backing plate 357 rotates below the mounting base 35. The supporting surface of the backing plate 357 and the mounting surface of the mounting base face the same direction and flush with each other. In this case, the calibration bracket 100 may be configured to mount a large heavy calibration element with a large volume, for example, a large target plate (generally a large pattern plate). A bottom side of the large pattern plate is supported by the first positioning mechanism 3120, the second positioning mechanism 3320 and left and right sides of the large pattern plate are respectively stuck in the third positioning mechanism 514 and the fourth positioning mechanism 524 (see FIG. 54). Since the first fixed block 510 and the second fixed block 520 have a certain thickness, if the target is to be mounted by using the fixed positioning mechanism 3120 and the second positioning mechanism 3320 on their side surfaces, the target is definitely mounted on a plane slightly further back than the mounting surfaces of the first fixed block 510 and the second fixed block 520. The switching of the backing plate 357 between the first position and the second position is to adjust a distance difference between target mounting planes in the two mounting manners. The back surface of the pattern plate may not abut against the supporting surface of the mounting base 35. Practice has proved that the large pattern plate can be firmly mounted by the fixing of the first fixed block 510 and the second fixed block 520 and the supporting of the supporting rod only. Optionally, the back of the pattern plate may abut against the supporting surface of the mounting base 35, and the mounting surface of the mounting base 35 may be coated with a magnetic material or provided with a magnetic unit, or the mounting base 35 is made of a magnetic material and configured to adsorb the back surface of the large pattern plate. Optionally, the supporting surface of the backing plate 357 may also be coated with a magnetic material or provided with a magnetic unit, or the backing plate 357 is made of a magnetic material and configured to adsorb the back surface of the large pattern plate. Optionally, the supporting surface of the backing plate 357 and the mounting surface of the mounting base 35 may also have no mounting function. A large pattern plate with a large area can be sufficiently supported by the fastening of the third positioning mechanism 514 and the fourth positioning mechanism 524 and the supporting of the first supporting member 312 and the second supporting member 332 only.

It may be understood that in some other embodiments, the backing plate 357 may rotate in any direction, so that the backing plate 357 is stuck in the receiving slot 358 or detaches from the receiving slot 358 to rotate to the supporting surface of the backing plate 357 without affecting the target to be mounted between the third positioning mechanism 514 and the fourth positioning mechanism 524.

In some other embodiments, a large target can be mounted by magnetic adsorption of the mounting surfaces of the first fixed block 510 and the second fixed block 520. Similarly, in this case, a lower end of the large target is supported by the first supporting member 312 and the second supporting member 332, and is positioned by the first positioning mechanism 3120 and the second positioning mechanism 3320. Optionally, the backing plate 357 is at the first position, and adsorption force to the large target is enhanced by using magnetic adsorption of the backing plate 357. Optionally, the mounting surface of the mounting base 35 may be a whole without the recess 358 and the backing plate 357, and the mounting surface of the mounting base 35 can be made flush with the mounting surfaces of the first fixed block 510 and the second fixed block 520. When the large target is mounted by the magnetic adsorption of the mounting surfaces of the first fixed block 510 and the second fixed block 520, for different targets or target combinations used by different models of vehicles, all targets are mounted on the same plane, which saves an additional compensation step or bracket realignment step.

The large target plate may be positioned in the following method. In the calibration of most vehicle models, the large target plate is aligned with the central axis of the vehicle. Therefore, only how to position the large target plate at the central position of the calibration frame is described. Positioning requirements at other positions may be similarly designed. In an embodiment, a positioning structure, for example, a positioning projection 512 may be disposed on one or more mounting surfaces of one or more of the first fixed block 510, the second fixed block 520, the mounting base 35 and the backing plate 357 to position the large target plate. When the large target plate is positioned using the positioning projections 512 and 522 on the first fixed block 510 and the second fixed block 520, the first fixed block 510 and the second fixed block 520 may be placed at preset positions on the beam. The preset positions may be read from a scale on the beam. In another embodiment, positioning mechanisms (not shown in the figure) adapted to the first positioning mechanism 3120 and the second positioning mechanism 3320 may be disposed at the bottom of the large target plate. Since the first supporting rod 31 and the second supporting rod 32 are in fixed positions after being lifted down due to an influence of the support 3303, the positioning of the large target plate can also be achieved through the first positioning mechanism 3120 and the second positioning mechanism 3320.

In a case where the large target plate is clamped using clamping slots 514 and 524 of the first fixed block 510 and the second fixed block 520, the mounting plane of the large target plate is inconsistent with that of other small targets and there is a certain distance difference. The distance difference may be compensated with software. The calibration bracket 100 may also be pushed in the direction of the vehicle for a distance equal to the distance difference before the calibration of the large target plate, so that the mounting plate of the large target plate is in fact repositioned on the same plane as the mounting planes of other small target plates. The calibration bracket 100 may be positioned in any of the suitable manners known or designed in future.

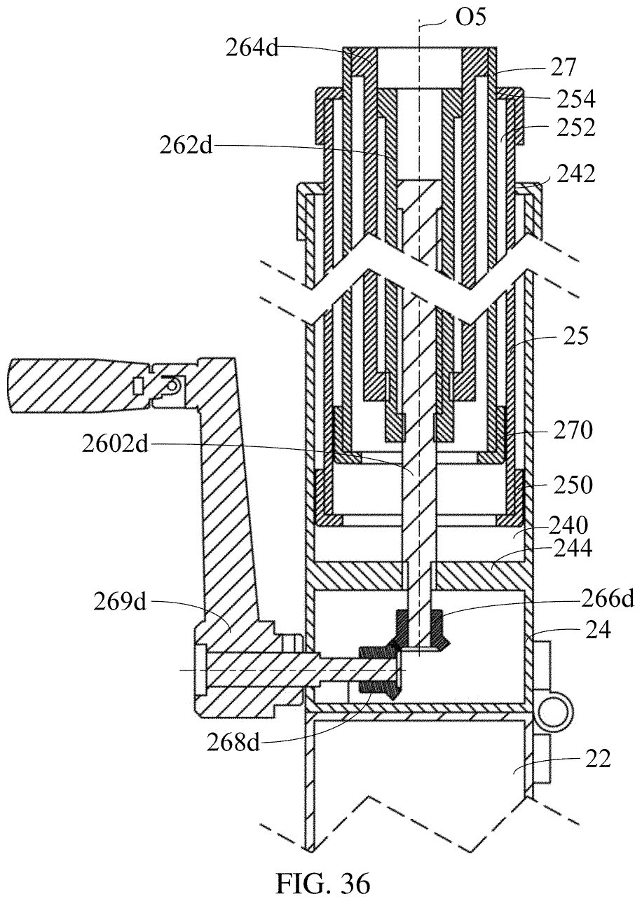

It may be understood that the first positioning mechanism 3120, the second positioning mechanism 3320, the third positioning mechanism 514, and the fourth positioning mechanism 524 may be positioning mechanisms arbitrarily constructed, such as slots, projections, concave points, convex rings, convex points or the like, but are not limited to the slots as shown in the drawings. As shown in FIG. 36, the positioning mechanisms 3120 and 3320 may further include bevel sections to more firmly support the target plate.

It may be understood that the number of the supporting rods included in the calibration bracket 100 is not necessarily two and may also be other numbers. When the supporting rod is disposed in the middle of the beam of the calibration bracket 100, there may be only one mount, and a lower end of the supporting member (corresponding to the supporting member 332 or 312 in FIG. 36) is additionally designed to make it lengthened in an extension direction of the beam, to better support the target.

It may be understood that when the target is mounted on the mounting surfaces of the first fixed block 510, the second fixed block 520, and the backing plate 357, other manners such as hooking in addition to magnetic adsorption may also be used.

Referring to FIG. 60, in some embodiments, the cross section of the beam may be in other shapes, such as a circle. A target mounting member 35a is provided with a receiving cavity 350a. The receiving cavity 350a is substantially cylindrical and is horizontally disposed. The target mounting member 35a includes a guide rod 352a. The guide rod 352a is located in the receiving cavity and is horizontally disposed. A beam 36a is substantially cylindrical, with a guide slot 362a on an outer wall. The guide slot 362a is disposed in a length direction of the beam 36a, and the shape of the guide slot 362a matches the shape of the guide rod 352a, so that the guide slot 362a can tightly clamp the guide rod 352a. The diameter of the beam 36a is slightly greater than the width of an opening of the receiving cavity 350a. A force applied to the beam 36a may push the beam 36a into the receiving slot 350a or take the beam 36a out of the receiving cavity 350a. The force applied to the beam 36a may also make the beam 36a slide in its length direction relative to the target mounting member 35a.

The diameter of the beam 36a is slightly greater than the width of the opening of the receiving cavity 350a. A force is applied to push the beam 36a into the receiving cavity 350a, and the beam 36a may be mounted in the receiving cavity 350a. The beam 36a can be more firmly mounted to the target mounting member 35a by fastening the guide slot 362a to the guide rod 352a. The guide slot 362a and the guide rod 352a are disposed in the length direction of the beam 36a, so that the beam 36a can be guided to move in its length direction relative to the target mounting member 35a to facilitate the adjustment of left and right positions of the beam 36a.

It may be understood that in some other embodiments, the cross section of the beam 36a and the cross section of the receiving cavity 350a may be disposed in other shapes as required, such as ellipses or trapezoids, provided that the cross section of the beam 36a matches the cross section of the receiving cavity 350a to enable the force applied to the beam 36a to push the beam 36a into the receiving slot 350a or to take the beam 36a out of the receiving cavity 350a.

To firmly mount the beam 36a to the mounting base 35, a contact surface between the mounting base 35 and the beam 36a varies according to a change in the cross section of the beam 36a, provided that the contact surface between the mounting base 35 and the beam 36a matches the cross section of the beam 36a to enable the beam 36a to be firmly mounted to the mounting base 35. For example, the cross section of the beam 36a is circular and the contact surface between the mounting base 35 and the beam 36a is substantially cylindrical. Certainly, the contact surface between the mounting base 35 and the beam 36a may not vary according to the change in the cross section of the beam 36a. A positioning or limiting structure may be disposed on the contact surface between the mounting base 35 and the beam 36a to prevent the beam 36a from rolling. For example, a limiting block is disposed on the contact surface between the mounting base 35 and the beam 36a, and an outer wall of the beam 36a is provided with a limiting slot.

In some embodiments, the first fixed block 510 and the second fixed block 520 shown in FIG. 57 to FIG. 59 may adopt the structure of the target mounting member 35a. Correspondingly, the beam shown in FIG. 57 to FIG. 59 adopts the structure of the beam 36a.

In the above embodiment, the upright rod of the calibration bracket may fold or expand. The base may be detachably connected to the upright rod. This may significantly reduce the size of the calibration bracket, making it very suitable for handling especially in vehicles. Moreover, this enables the calibration bracket to use a larger base, especially that with a larger transverse size. This is conductive to radar calibration. Since a radar calibration element is usually heavy and often needs to be placed on one side of the beam of the calibration bracket, a base with a large transverse size is required. The calibration bracket with such a base in the traditional technology is very unsuitable for handling. The technical solution in this embodiment solves this problem. The base detaches from the first upright rod and the first upright rod and the second upright rod may be nested or folded with each other, so that the entire calibration bracket can also be transported within the vehicles even if the transverse size of the base is large (for example, close to 1 meter).

Finally, it should be noted that the above embodiments are used only to describe the technical solution of the present invention and not to limit it. Under the thought of the present invention, the technical features in the above embodiments or different embodiments may also be combined, the steps may be implemented in any order and there are many other changes in different aspects of the present invention as described above, which are not provided in detail for the sake of simplicity. Although the present invention is described in detail with reference to the above embodiments, a person of ordinary skill in the art should understand that the technical solutions stated in the above embodiments may still be modified or some of the technical features may be equivalently replaced. The modifications or replacements do not make the essence of the corresponding technical solutions depart from the scope of the technical solutions of the embodiments of the present invention.

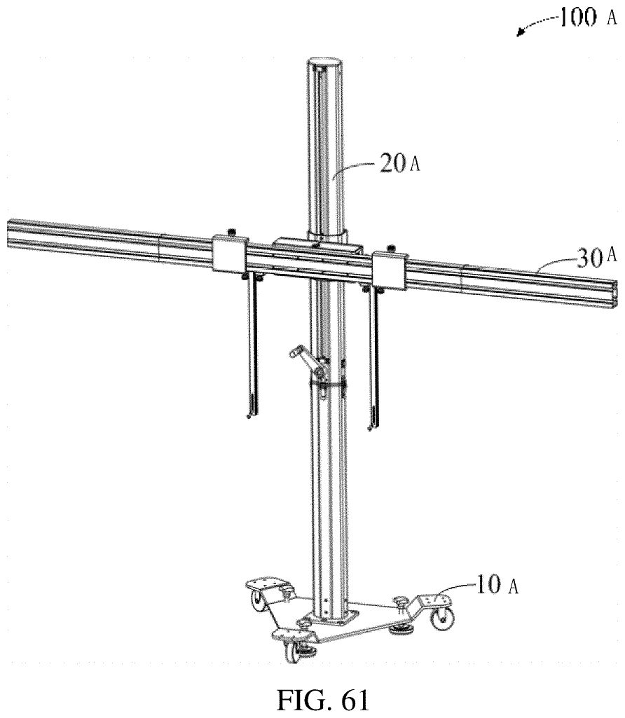

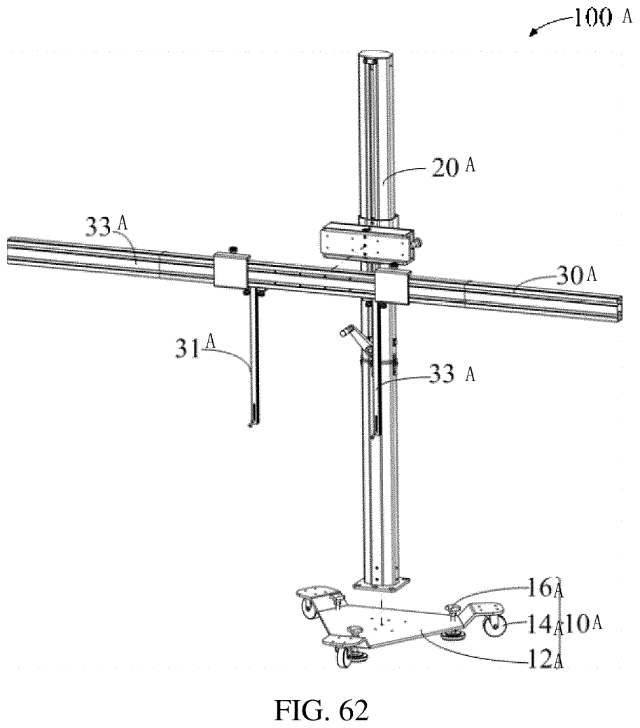

Referring to FIG. 61 and FIG. 62 together, yet another embodiment of the present invention provides a calibration bracket 100A. The calibration bracket 100A is configured to support a calibration element, which is configured to calibrate a device in a driver assistant system of a vehicle. The same or functionally similar structures in the above embodiments may be cross-referenced and the descriptions thereof are omitted in this embodiment. Different terms of the same structure may be understood as the same structure by a person skilled in the art in combination with the specification and the accompanying drawings.

The calibration bracket 100A includes a base 10A, a stand assembly 20A and a support assembly 30A. The stand assembly 20A is mounted to the base 10A and the support assembly 30A is mounted to the stand assembly 20A. It is understandable that the support assembly 30A may include the beam assembly 30 in the above embodiment or include other support structures for supporting a calibration element, for example, an unfoldable beam or non-beam structure. The non-beam structure is configured only to support the calibration element, which is not limited herein.

In the calibration bracket 100A of this embodiment, the base 10A is detachably connected to the stand assembly 20A and is specifically fixed by bolts, to dissemble the calibration bracket 100A for easy loading. Alternatively, the base and the stand assembly may be assembled in the disassembly manner as described in the above embodiment.

In the calibration bracket 100A of this embodiment, the stand assembly 20A is detachably connected to the support assembly 30A and is specifically fixed by bolts, to dissemble the calibration bracket 100A for easy loading.

The base 10A includes a base body 12A, rollers 14A and height adjusting members 16A. The base body 12A is in the shape of a triangular claw, including three claws which extend in three different directions respectively. The base body 12A may be made of a metal material.

The rollers 14A are mounted to a bottom surface of the base body 12A. The number of the rollers 14A may be three. Each of the rollers 14A is mounted to a tail end of a corresponding one of the claws and is configured to facilitate movement of the base body 12A. In this embodiment, the rollers 14A are universal moving rollers, so that the base body 12A can arbitrarily move forward, backward, leftward, or rightward.

The height adjusting members 16A are mounted to the base body 12A and are configured to adjust the height of the base body 12A. In this embodiment, the height adjusting members 16A are adjusting knobs, and the number of the height adjusting members 16A is three. A lower part of the knob includes at least one screw rod which is matches with a screw hole at the base body 12A to achieve height adjustment. Each of the height adjusting members 16A is mounted to a corresponding one of the claws and is close to a corresponding one of the rollers 14A. The three height adjusting members 16A are distributed in a regular triangle.

It may be understood that in some other embodiments, the shape of the base body 12A may change according to actual requirements, but is not limited to the triangular claw. For example, the base body 12A may be rectangular or circular. The number of the rollers 14A and the number of the height adjusting members 16A may be increased or decreased according to actual requirements respectively. For example, for the base body 12A in the shape of the triangular claw, there may be two height adjusting members 16A, which are fitted to a fixed-height leg to adjust the angle of the base body 12A.

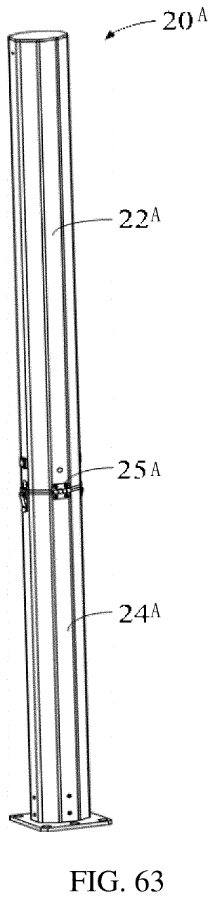

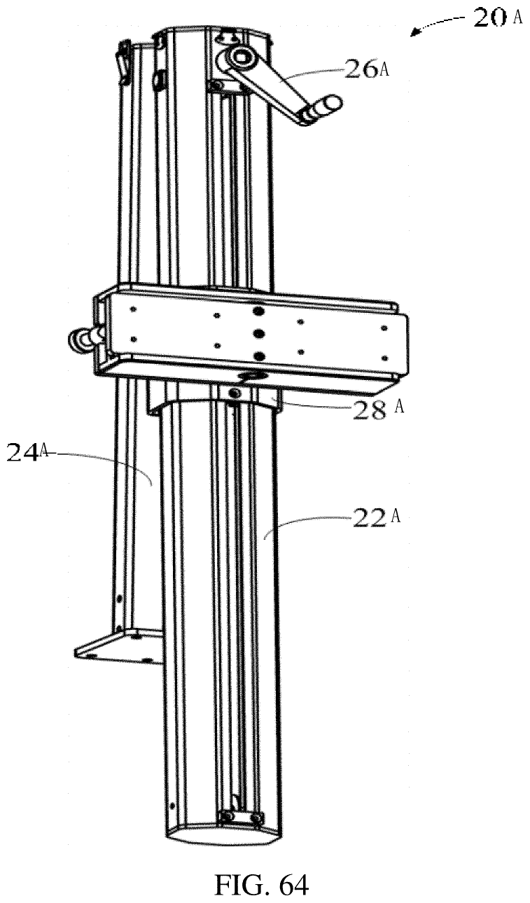

Referring to FIG. 63 and FIG. 64, the stand assembly 20A includes at least two rod bodies. Two adjacent ones of the at least two rod bodies are foldably connected. The support assembly is mounted on one of the at least two rod bodies. The support assembly 30A is configured to support the calibration element. Two rod bodies are foldably connected. As in FIG. 64, after the at least two rod bodies are folded, the volume of the stand assembly 20A can be reduced, thereby making the calibration bracket 100A easy to handle. The rod body in the embodiment of the present application may also be understood as the upright rod in the above embodiments.

In this embodiment, as in FIG. 63, two adjacent ones of the at least two rod bodies are connected by a hinge 25A, so that the two adjacent ones of the at least two rod bodies are foldable. The two adjacent ones of the at least two rod bodies may also be connected by a joint, a rotating shaft or the like according to an actual situation.

When the at least two rod bodies are in an unfolded state, the at least two rod bodies form a using state of the upright rod.

When the at least two rod bodies are in an unfolded state, the support assembly 30A is mounted to one of the at least two rod bodies farthest from the base or one of the rod bodies close to the base. After the at least two rod bodies are in a folded state, the support assembly can quickly reach a preset height or be near the preset height.

It should be noted that the two adjacent ones of the at least two rod bodies may be either arbitrary or specific. In addition, the two rod bodies being foldably connected includes a connection in the folded state and a connection in the unfolded state. The folded state includes multi-angle folding. For example, when the two rod bodies are in the unfolded state, an angle between the two rod bodies is 180 degrees. When the two rod bodies are in the folded state, an angle between them is 0 degrees or an acute angle (such as 30 degrees or 60 degrees). The rod body folding at an acute angle means that the rod body cannot continue to fold to achieve a smaller angle in the folded state.

In some other embodiments, the two adjacent ones of the at least two rod bodies are detachably connected and may be specifically mounted by a bolt and a folding mechanism such as a hinge or other hinged manners. Therefore, the number of the rod bodies may be increased or decreased according to actual requirements to achieve that the at least two rod bodies form an upright rod reaching a preset length, so as to flexibly control the height of the stand component 20A.

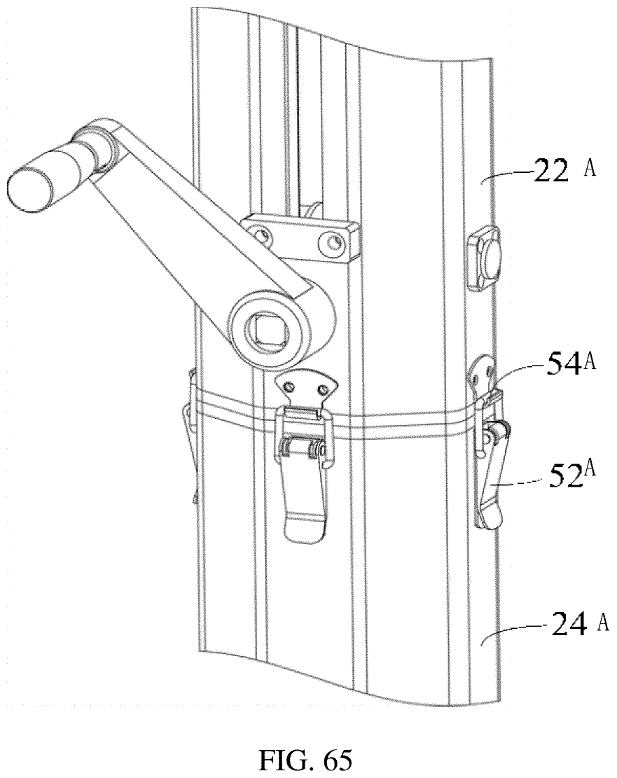

Referring to FIG. 65, in the calibration bracket 100A of this embodiment, the calibration bracket 100A further includes a connection fixing member 50A. The connection fixing member 50A includes a first buckle 52A and a second buckle 54A. The first buckle 52A is rotatably connected to one of the at least two rod bodies. The second buckle 54A is disposed on another of the at least two rod bodies adjacent to the one. The first buckle 52A and the second buckle 54A may be mutually buckled. The connection fixing member 50A is disposed, so that when the at least two rod bodies form an upright rod in an unfolded state, the first buckle 52A and the second buckle 54A are mutually buckled to make two adjacent ones of the at least two rod bodies keep fixed.

The at least two rod bodies include a first rod body 22A and a second rod body 24A. The first rod body 22A and the second rod body 24A are adjacent to each other. The support assembly 30A is mounted to the first rod body 22A.

In some other embodiments, one end of the first rod body 22A is sleeved in the second rod body 24A, the first rod body 22A is movable in the length direction of the first rod body 22A relative to the second rod body 24A, and the first rod body 22A may be fixed to a preset position.

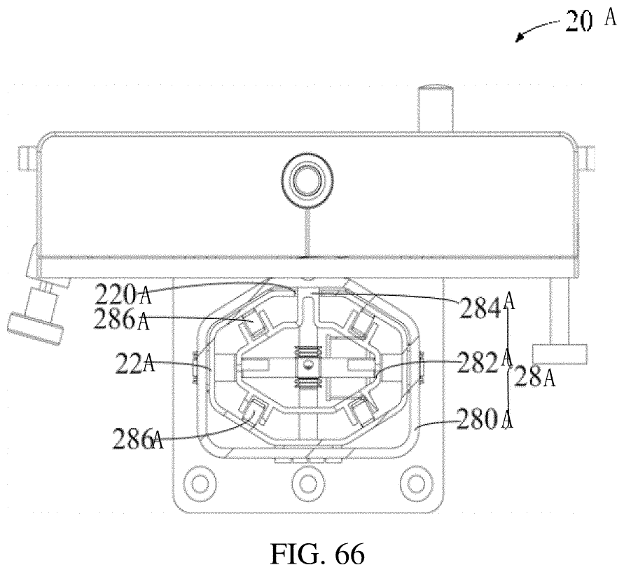

Referring to FIG. 66, the first rod body 22A is wholly a hollow pipe provided with an inner cavity. A length direction of the inner cavity is parallel to the length direction of the first rod body 22A. The inner cavity is used to accommodate the driving mechanism 26A and the sliding structure 28A, so that the volume of the stand assembly 20A can be reduced, thereby making the calibration bracket 100A easy to handle. A surface of the first rod body 22A is provided with an avoidance slot 240A. An opening of the avoidance slot 240A is disposed in the length direction of the first rod body. The avoidance slot has at least one end.

The stand assembly 20A may further include the sliding structure 28A. The support assembly 30A is connected to the first rod body 22A through the sliding structure 28A. The sliding structure 28A may move in the length direction of the first rod body 22A relative to the first rod body 22A.

The sliding structure 28A includes a first sliding member 280A, a second sliding member 282A and a limiting portion 284A. The second sliding member 282A is received in the inner cavity. The second sliding member 282A is movable in the length direction of the first rod body 280A relative to the first rod body 22A. The first sliding member 280A is disposed on an outer side of the first rod body 22A. The support assembly 30A is connected to the second sliding member 282A through the first sliding member 280A. The first sliding member 280A and the second sliding member 282A may move together in the length direction of the first rod body 22A relative to the first rod body 22A.

One side of the second sliding member 282A facing a cavity wall of the inner cavity is provided with a pulley 286A. The second sliding member 282A abuts against the cavity wall of the inner cavity through the pulley 286A and moves on the cavity wall of the inner cavity through the pulley 286A, which may reduce the friction between the second sliding member 282A and the cavity wall of the inner cavity.

The sliding structure 280A may be fixed to at least one position on the first rod body 22A.

Specifically, the first sliding member 280A and the second sliding member 282A are connected through the limiting portion 284A. The limiting portion 284A is located in the avoidance slot 220A. The first sliding member 280A, the second sliding member 282A and the limiting portion 284A may move together in the length direction of the first rod body 22A relative to the first rod body 22A. When the limiting portion 284A moves in the length direction of the first rod body 22 to the end of the avoidance slot 220A, that is, the limiting structure 280A is at a position of the first rod body 22A, the limiting portion 284A cannot continue to move to prevent the sliding structure 28A from exceeding the stroke, thereby avoiding damage to the driving mechanism 26A.

It may be understood that the avoidance slot 220A may have two ends according to an actual situation.

The support assembly 30A may be manually controlled to move in the length direction of the first rod body 22A relative to the first rod body 22A. For example, the support assembly 30A is lifted up to move in the length direction of the first rod body 22A and toward a first direction relative to the first rod body 22A. For another example, the support assembly 30A is lifted down to move, under its own gravity, in the length direction of the first rod body 22A and toward a second direction relative to the first rod body 22A. The first direction is opposite to the second direction.

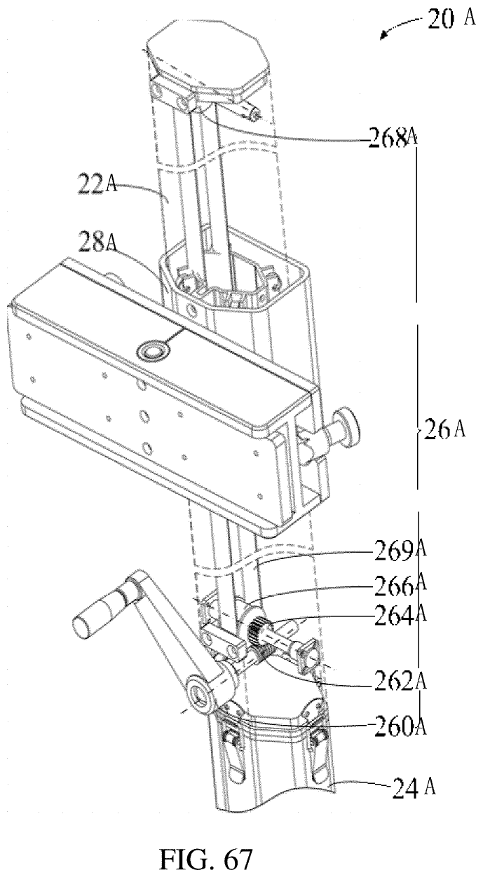

Referring to FIG. 67, the stand assembly 20A may further include a driving mechanism 26A. The driving mechanism 26A is configured to drive the support structure 30A to move in the length direction of the first rod body 22A relative to the first rod body 22A.

The driving mechanism 26A includes a handle 260A, a worm 262A, a worm wheel 264A, a driving wheel 266A, a driven wheel 268A and a synchronizing belt 269A. The driving wheel 266A, the driven wheel 268A and the synchronizing belt 269A are all located in the inner cavity. The driving wheel 266A is closer to a junction between the first rod body 22A and the second rod body 24A than the driven wheel 268A. The driving wheel 266A and the driven wheel 268A are both rotatably mounted to a cavity wall of the inner cavity. Moreover, a rotation axis of the driving wheel 266A is parallel to that of the driven wheel 268A. The synchronizing belt 269A is sleeved on the driving wheel 266A and the driven wheel 268A. The sliding structure 28A is fixed to the synchronizing belt 269A. The driving wheel 266A rotates to drive the synchronizing belt 269A to move in the length direction of the first rod body 22A relative to the first rod body 22A, to drive the sliding structure 28A to move together.

It may be understood that on the one hand, in this embodiment, the driving wheel 266A and the driven wheel 268A are both synchronizing wheels. According to an actual situation, the driving wheel 266A and the driven wheel 268A may also be chain wheels and the synchronizing belt 269A is replaced with a pitch chain. On the other hand, the driving wheel 266A, the driven wheel 268A and the synchronizing belt 269A may be replaced with a lead screw mechanism, a pinion and rack mechanism, or the like.

The handle 260A is located on an outer side of the first rod body 22A. The handle 260A is rotatably mounted to the first rod body 22A.

The worm 262A is located in the inner cavity. One end of the worm 262A is fixedly mounted to the handle 260A and a rotation axis of the worm 262A coincides with that of the handle 260A. The worm 262A and the handle 260A may rotate together.

The worm wheel 264A is located in the inner cavity. The worm wheel 264A is fixedly mounted to the driving wheel 266A. Moreover, the rotation axis of the worm wheel 264A coincides with that of the driving wheel 266A. The worm wheel 264A and the driving wheel 266A may rotate together. The rotation axis of the worm wheel 264A is orthogonal to that of the worm 262A. Moreover, the worm wheel 264A is engaged with the worm 262A. The worm wheel 264A and the worm 262A may rotate together. When the sliding structure 28A moves to a required position relative to the first rod body 26A, by means of self-locking functions of the worm 262A and the worm wheel 264A, that is, the worm 262A may drive the worm wheel 264A to rotate, while the worm wheel 264A cannot drive the worm 262A to rotate, and the sliding structure 28A can be fixed to the required position.

The driving mechanism 26A specifically works as follows:

When the support assembly 30A needs to be driven to ascend, the hand wheel 260A rotates toward a first rotation direction to drive the worm 262A to rotate toward the first rotation direction, drive the worm wheel 264A to rotate toward a third rotation direction, drive the driving wheel 266A to rotate toward the third rotation direction, and pull the support assembly 30A to ascend through the synchronizing belt 269A.

After the support assembly 30A ascends to a specified position, the support assembly 30A is fixed to the first upright rod 22A due to the self-locking of the worm wheel 264A and the worm 262A.

When the support assembly 30A needs to be driven to descend, the hand wheel 260A rotates toward a second rotation direction to drive the worm 262A to rotate toward the second rotation direction, drive the worm wheel 264A to rotate toward a fourth rotation direction, drive the driving wheel 266A to rotate toward the fourth rotation direction, and make the support assembly 30A descend through the synchronizing belt 269A under the driving of the weight of the support assembly 30A. The first rotation direction is opposite to the second rotation direction, and the third rotation direction is opposite to the fourth rotation direction.

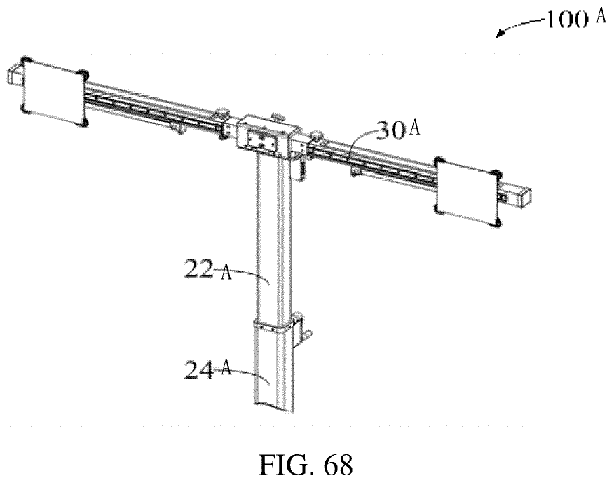

It may be understood that the driving mechanism 26A is not merely limited to being mounted in the first rod body 22A according to an actual situation. Referring to FIG. 68, the driving mechanism 26A may also be mounted in the second rod body 24A. The first rod body 22A is sleeved in the second rod body 24A to drive the first rod body 22A to move in a length direction of the first rod body 22A relative to the second rod body 24A. The first rod body may be fixed to a preset position. In addition, the support assembly 30A may be fixedly mounted to the first rod body 22A. In the driving mechanism 26A, the worm wheel 264A and the worm 262A may be omitted. That is, the driving wheel 266A is directly fixedly mounted to the handle 260A. Moreover, a rotation axis of the driving wheel 266A coincides with that of the handle 260A. The driving wheel 266A and the handle 260A may rotate together. In addition, the hand wheel 260A may be replaced with a motor, a pneumatic hydraulic transmission system, a pneumatic motor, or the like.

It is understandable that two manners of folded connection and nested connection may co-exist between the at least two rod bodies. As described in the above embodiments, the first upright rod is in a folded connection with the second upright rod, and the third upright rod is in a nested connection with the fourth upright rod. Further, the fourth right rod is in a nested connection with the third upright rod.

Alternatively, the first upright rod and the third upright rod are foldably connected to two sides of the second upright rod. Optionally, the sum of lengths of the first upright rod and the third upright rod is less than or equal to the length of the second upright rod. Folding angles between the first upright rod and the second upright rod and between the third upright rod and the second upright rod are 0 degrees respectively. That is, when in a state of being folded with the second upright rod, the first upright rod and the third upright rod are parallel to the second upright rod respectively, and the first upright rod and the third upright rod do not abut against each other in the folded state, which further reduces a storage volume of the upright rods in an unused state and reduces transportation costs. Further, the first upright rod may be connected to the base, and the fourth upright rod is adapted to be nested with the third upright rod, thereby increasing a used length of the stand assembly. That is, the support assembly may move in the length direction of the stand assembly within a larger range. The support assembly 30A is mainly configured to mount a calibration element, for example, a multiline laser 200A, a calibration target, and a radar reflection or absorption apparatus, to calibrate a vehicle-mounted driver assistant system.

Referring to FIG. 62 again, the support assembly 30A includes a beam 34A, a first supporting rod 31A and a second supporting rod 33A. The beam 34A is mounted to the stand assembly 20A. The first supporting rod 31A and the second supporting rod 33A are both mounted to the beam 34A. The first supporting rod 31A and the second supporting rod 33A are jointly configured to mount the calibration element. ,

The first supporting rod 31 and the second supporting rod 33 have a function of lifting a target to prevent it from falling, especially when the target is large in area and heavy in weight. One end of the first supporting rod 31A may be pivotably connected to the beam 34A through a hinged mechanism, a hinge mechanism, or the like. The first supporting rod 31A may rotate relative to the beam 34A to unfold to be perpendicular to the beam 34A, or may be snapped to the beam 34A and parallel to the beam 34A.

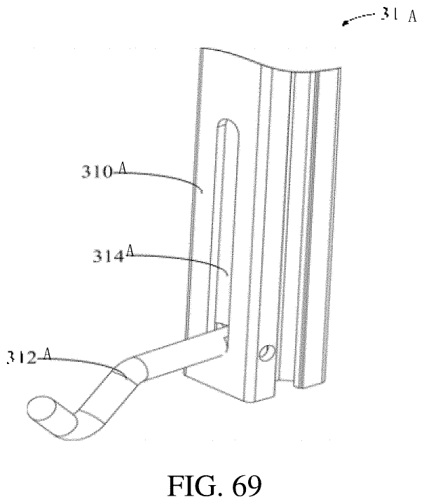

Referring to FIG. 69, the first supporting rod 31A includes a first supporting rod body 310A and a first supporting member 312A. One end of the first supporting rod body 310A is hinged to the beam 34A and the other end of the first supporting rod body 310A is mounted to the first supporting member 312A. A side wall of the first supporting rod body 310A is provided with a first slot 314A. The first supporting member 312A may be received in the first slot 314A.

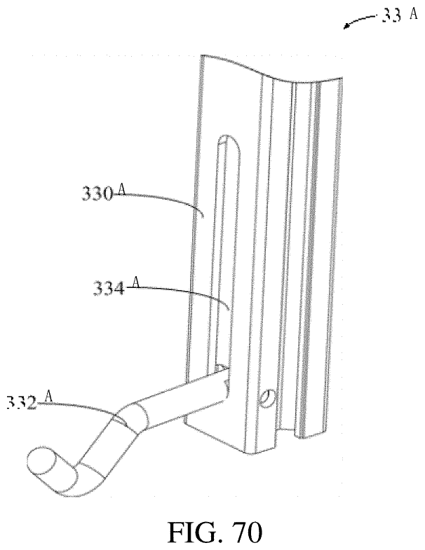

Similarly, referring to FIG. 70, one end of the second supporting rod 33A is hinged to the beam 34A through a hinged mechanism, a hinge mechanism, or the like. The second supporting rod 33A may rotate relative to the beam 34A to unfold to be perpendicular to the beam 34A, or may be snapped to the beam 34A and parallel to the beam 34A. The second supporting rod 33A includes a second supporting rod body 330A and a second supporting member 332A. One end of the second supporting rod body 330A is hinged to the beam 34A and the other end of the second supporting rod body 330A is mounted to the second supporting member 332A. A side wall of the second supporting member body 330A is provided with a second slot 334A. The second supporting member 332A may be received in the second slot 334A. The first supporting member 312A and the second supporting member 332A may be used to jointly support a calibration element, such as a pattern plate.

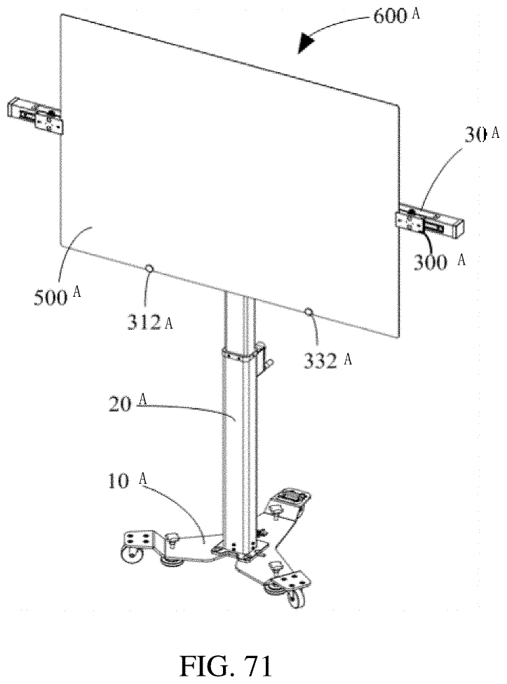

Referring to FIG. 71, another embodiment of the present invention further provides a calibration system 600A, including a calibration element and the calibration bracket 100A provided in the above embodiment. The calibration element is adapted to be mounted to the calibration bracket 100A. For example, the calibration element is a reflector 300A. The reflector 300A is adapted to be mounted to a beam through a slider. The beam is provided with a guide rail. The reflector may move in a length direction of the beam. The reflector 300A may also be a target. Two targets are mounted to the beam through the slider. The reflector or target 300A may also be bracket-mounted onto the support assembly 30A in a manner such as hooking.

For example, the calibration element is a pattern plate. The first supporting member 312A and the second supporting member 332A jointly lift the pattern plate to prevent falling.

Compared with the prior art, in the calibration system 600A and the calibration bracket 100A provided in the embodiments of the present invention, two adjacent ones of at least two rod bodies are foldably connected so that the stand assembly 20A can be folded to make the calibration bracket 100A easy to carry.

It is understandable that, for an easy-to-carry base in the above embodiments, the stand assembly may be fixedly connected to the base or foldably connected to the base.

Finally, it should be noted that the above embodiments are used only to describe the technical solution of the present invention and not to limit it. Under the thought of the present invention, the technical features in the above embodiments or different embodiments may also be combined, the steps may be implemented in any order and there are many other changes in different aspects of the present invention as described above, which are not provided in detail for the sake of simplicity. Although the present invention is described in detail with reference to the above embodiments, a person of ordinary skill in the art should understand that the technical solutions stated in the above embodiments may still be modified or some of the technical features may be equivalently replaced. The modifications or replacements do not make the essence of the corresponding technical solutions depart from the scope of the technical solutions of the embodiments of the present invention.

What is claimed is:

1. A calibration bracket, comprising:
a base;
a stand assembly, comprising a first upright rod and a second upright rod, one end of the first upright rod being detachably mounted on the base, the second upright rod being connected to the first upright rod and the first upright rod being nested or folded with the second upright rod to reduce the length of the stand assembly; and
a beam assembly, supported by the stand assembly.

2. The calibration bracket according to claim 1, comprising a base fixing member, the base fixing member being mounted on one of the base and the first upright rod and fastened to the other so that the first upright rod is fixed to the base, and the base fixing member also detaching from the other so that the first upright rod is removed from the base.

3. The calibration bracket according to claim 2, wherein one of the first upright rod and the base is provided with a first limiting structure and the other is provided with a second limiting structure, the first limiting structure being fitted to the second limiting structure to limit movement of the first upright rod relative to the base.

4. The calibration bracket according to claim 3, wherein the first limiting structure is a limiting slot and the second limiting structure is a limiting rod clamped to the limiting slot and abutting against at least a part of an edge of the limiting slot.

5. The calibration bracket according to claim 4, wherein the limiting slot is a through hole in which a large hole site is in radial communication with a small hole site and the limiting rod passes through the large hole site and then is clamped to the small hole site.

6. The calibration bracket according to claim 3, wherein the base fixing member comprises a pull handle and a buckle;
the pull handle is pivotally connected to the base and is rotatable about a pivot point;
one end of the buckle is connected to the pull handle and is rotatable with the pull handle; and
the other end of the buckle is fastened to or detaches from the first upright rod by rotating the pull handle.

7. The calibration bracket according to claim 6, wherein the first upright rod is provided with a barb portion and the buckle is fastened to the barb portion, so that the base is fixedly connected to the first upright rod.

8. The calibration bracket according to claim 1, wherein the second upright rod is disposed inside or sleeved outside the first upright rod, and the second upright rod is movable in a length direction of the first upright rod relative to the first upright rod; and
the beam assembly is supported by the second upright rod.

9. The calibration bracket according to claim 8, wherein cross sections of the first upright rod and the second upright rod are non-circular.

10. The calibration bracket according to claim 8, wherein one of the first upright rod and the second upright rod comprises a guide rail, and the other is guided by the guide rail to be movable only in the length direction of the first upright rod.

11. The calibration bracket according to claim 8, wherein the stand assembly comprises a driving mechanism which is mounted to the first upright rod, and configured to drive the second upright rod to move in the length direction of the first upright rod relative to the first upright rod.

12. The calibration bracket according to claim 1, wherein one end of the first upright rod away from the base is pivotally connected to one end of the second upright rod, so that the second upright rod is foldable relative to the first upright rod.

13. The calibration bracket according to claim 12, wherein one end of the first upright rod away from the base is provided with a first buckle, and one end of the second upright rod is provided with a second buckle, the first buckle and the second buckle being mutually buckled to fasten the second upright rod to the first upright rod.

14. The calibration bracket according to claim 1, wherein the stand assembly comprises a third upright rod, the third upright rod being connected to the second upright rod, and the third upright rod being adapted to be nested or folded with the second upright rod to reduce the length of the stand assembly.

15. The calibration bracket according to claim 1, wherein the beam assembly comprises a beam detachably mounted to the stand assembly.

16. The calibration bracket according to claim 15, wherein the beam assembly comprises a mounting base, the mounting base being supported by the stand assembly, and the beam being detachably mounted in the mounting base and being supported by the stand assembly through the mounting base.

17. The calibration bracket according to claim 16, wherein the mounting base is disposed on a top surface of the stand assembly.

18. The calibration bracket according to claim 16, wherein the mounting base forms, in an enclosing manner, a mounting channel which is not closed and has a notch, and the beam is mounted in the mounting channel, the notch being used to facilitate mounting of the beam in the mounting channel through the notch and to facilitate removal of the beam from the mounting channel through the notch.

19. The calibration bracket according to claim 16, wherein the mounting base comprises a first limiting structure, the connecting portion comprises a second limiting structure adapted to the first limiting structure; and
the first limiting structure is fitted to the second limiting structure to limit the beam into the mounting base.

20. The calibration bracket according to claim 16, wherein the mounting base is provided with a fixing mechanism which presses the beam on the mounting base so that the beam is pressed on a bottom surface and a side surface of the mounting base.
